(19) United States
(12) Patent Application Publication
(10) Pub. No.: US 2010/0223237 A1
(43) Pub. Date: Sep. 2, 2010

(54) LOSSLESS DATA COMPRESSION AND REAL-TIME DECOMPRESSION

(75) Inventors: Prabhat Mishra, Gainesville, FL (US); Seok-Won Seong, Stanford, CA (US); Kanad Basu, Gainesville, FL (US); Weixun Wang, Gainesville, FL (US); Xiaoke Qin, Gainesville, FL (US); Chetan Murthy, Gainesville, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: University of Florida Research Foundation, Inc., Gainesville, FL (US)

(21) Appl. No.: 12/682,808

(22) PCT Filed: Nov. 5, 2008
(86) PCT No.: PCT/US08/82475

§ 371 Date: Apr. 13, 2010

Related U.S. Application Data
(60) Provisional application No. 60/985,488, filed on Nov. 5, 2007.

(51) Int. Cl. G06F 17/30

(52) U.S. Cl. 707/693; 707/E17.002; 707/E17.005

(57) ABSTRACT

A method, information processing system, and computer program storage product store data in an information processing system. Uncompressed data is received and the uncompressed data is divided into a series of vectors. A sequence of profitable bitmask patterns is identified for the vectors that maximizes compression efficiency while minimizes decompression penalty. Matching patterns are created using multiple bit masks based on a set of maximum values of the frequency distribution of the vectors. A dictionary is built based upon the set of maximum values in the frequency distribution and a bit mask savings which is a number of bits reduced using each of the multiple bit masks. Each of the vectors is compressed using the dictionary and the matching patterns with having high bit mask savings. The compressed vectors are stored into memory. Also, an efficient placement is developed to enable parallel decompression of the compressed codes.

### CROSS REFERENCE TO RELATED APPLICATION

This application is based upon and claims priority from prior U.S. Provisional Patent Application No. 60/985,488, filed on Nov. 5, 2007 the entire disclosure of which is herein incorporated by reference.

### FIELD OF THE INVENTION

The present invention relates generally to a wide variety of code and data compression and more specifically a method and system for code, data, test as well as bitstream compression for real-time systems.

### BACKGROUND OF THE INVENTION

Embedded systems are constrained by their available memory. Code compression techniques address this issue by reducing the code size of application programs. However, many coding techniques that can generate substantial reductions in code size usually affect the overall system performance. Overcoming this problem is a major challenge.

### SUMMARY OF THE INVENTION

In one embodiment, a method for storing data in an information processing system is disclosed. The method includes receiving uncompressed data and dividing the uncompressed data into a series of vectors. A sequence of profitable bitmask patterns is identified for the vectors that maximizes compression efficiency while minimizes decompression penalty. Matching patterns are created using multiple bit masks based on a set of maximum values of the frequency distribution of the vectors. A dictionary is built based upon the set of maximum values in the frequency distribution and a bit mask savings which is a number of bits reduced using each of the multiple bit masks. Each of the vectors is compressed using the dictionary and the matching patterns with having high bit mask savings. The compressed vectors are stored into memory.

In another embodiment, an information processing system for storing data is disclosed. The information processing system comprises a memory and a processor. A code compression engine is adapted to receive uncompressed data and divide the uncompressed data into a series of vectors. The code compression engine also identifies a sequence of profitable bitmask patterns for the vectors that maximizes compression efficiency while minimizes decompression penalty. Matching patterns are created using a plurality of bit masks based on a set of maximum values of a frequency distribution of the vectors. A dictionary selection engine is adapted to build a dictionary based upon the set of maximum values in the frequency distribution and a bit mask savings which is a number of bits reduced using each of the plurality of bit masks. The code compression engine is further adapted to compress each of the vectors using the dictionary and the matching patterns with having high bit mask savings. The vectors which have been compressed are stored into memory.

In yet another embodiment, a computer program storage product for storing data in an information processing system is disclosed. The computer program storage product includes instructions for receiving uncompressed data and dividing the uncompressed data into a series of vectors. A sequence of profitable bitmask patterns is identified for the vectors that maximizes compression efficiency while minimizes decompression penalty. Matching patterns are created using multiple bit masks based on a set of maximum values of the frequency distribution of the vectors. A dictionary is built based upon the set of maximum values in the frequency distribution and a bit mask savings which is a number of bits reduced using each of the multiple bit masks. Each of the vectors is compressed using the dictionary and the matching patterns with having high bit mask savings. The compressed vectors are stored into memory.

The foregoing and other features and advantages of the present invention will be apparent from the following more particular description of the preferred embodiments of the invention, as illustrated in the accompanying drawings.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating one example of an operating environment according to one embodiment of the present invention;

FIG. 2 shows one example of dictionary-based code compression;

FIG. 3 shows one example of an encoding scheme for incorporating mismatches;

FIG. 4 shows one example of an improved dictionary-based code compression;

FIG. 5 shows one example of bit-mask based code compression according to one embodiment of the present invention;

FIG. 6 shows one example of an encoding format for the bit-mask based code compression according to one embodiment of the present invention;

FIG. 7 shows an example of a compressed word according to one embodiment of the present invention;

FIG. 8 shows three customized encoding formats according to one embodiment of the present invention;

FIG. 9 shows one example of pseudo-code for bit-mask based code compression according to one embodiment of the present invention;

FIG. 10 shows one example of compression using frequency-based dictionary selection;

FIG. 11 shows one example of compression using a different dictionary selection;

FIG. 12 shows one example of pseudo-code for bit-saving-based dictionary selection according to one embodiment of the present invention;

FIG. 13 shows one example the bit-saving dictionary selection of FIG. 12 according to one embodiment of the present selection;

FIG. 14 shows one example of pseudo-code for the bit-mask code compression of FIG. 9 integrated with the saving-based dictionary selection technique of FIG. 14 according to one embodiment of the present selection;

FIG. 15 shows two examples of decompression engine placement in an embedded system.

FIG. 16 shows high level schematic of a decompression engine according to one embodiment of the present selection;

FIG. 17 is an operational flow diagram illustrating a general process for performing the bit-mask based code compression technique according to one embodiment of the present invention;

FIG. 18 is an operational flow diagram illustrating one process for selecting a dictionary based on bit-saving according to one embodiment of the present invention;

FIG. 19 is an operational flow diagram illustrating one process of the code compression technique of FIG. 17 implementing the bit-saving based dictionary selection process of FIG. 18 according to one embodiment of the present invention;

FIG. 20 is a block diagram of a more detailed view of the information processing system in FIG. 1 according to embodiment of the present invention;

FIG. 21 is a graph illustrating the performance of each encoding format of FIG. 8 using adpcm_en benchmark for three target architectures according to embodiment of the present invention;

FIG. 22 is a graph that shows the efficiency of the code compression technique FIG. 9 for all benchmarks compiled for SPARC using dictionary sizes of 4K and 8K entries according to one embodiment of the present invention;

FIG. 23 is a plot showing compression ratios of three TI benchmarks according to one embodiment of the present invention;

FIG. 24 is a graph showing a comparison of compression ratios achieved by various dictionary selection methods;

FIG. 25 is a graph showing a comparison of compression ratios between the bitmask-based code compression of the various embodiments of the present invention and the application-specific code compression framework;

FIG. 26 shows an example of a dictionary based test data compression;

FIG. 27 shows an example of bitmasked-based code compression according to one embodiment of the present invention;

FIG. 28 is a graph illustrating a dictionary selection algorithm according to one embodiment of the present invention;

FIG. 29 illustrates intuitive placement for parallel decompression according to one embodiment of the present invention;

FIG. 30 is a block diagram illustrating one example of a data compression technique according to one embodiment of the present invention;

FIG. 31 is a block diagram illustrating one example of a decompression technique for parallel decompression according to one embodiment of the present invention;

FIG. 32 illustrates a code compression technique using modified Huffman coding according to one embodiment of the present invention;

FIG. 33 is a block diagram illustrating a storage block structure according to one embodiment of the present invention;

FIG. 34 illustrates pseudo code for a two bitstream placement algorithm according to one embodiment of the present invention;

FIG. 35 illustrates bitstream placement using two bitstreams according to one embodiment of the present invention;

FIG. 36 is a graph illustrating decode bandwidth of different techniques;

FIG. 37 is a graph illustrating compression ratio for different benchmarks;

FIG. 38 is a graph illustrating compression ratio on different architectures;

FIG. 39 illustrates pseudo code for a dictionary based parameter selection algorithm according to one embodiment of the present invention;

FIG. 40 shows compressed words arranged in a byte boundary according to one embodiment of the present invention;

FIG. 41 illustrates pseudo code for a decode aware parameter selection algorithm according to one embodiment of the present invention;

FIG. 42 is a graph shows the effect of word length, dictionary size and number of bitmasks on compression ratio;

FIG. 43 illustrates pseudo code for an optimal dictionary selection algorithm according to one embodiment of the present invention;

FIG. 44 is a block diagram illustrating an example of dictionary selection according to one embodiment of the present invention;

FIG. 45 is block diagram illustrating an example of run length encoding with bitmask based compression according to one embodiment of the present invention;

FIG. 46 illustrates a sample output of an bitstream compression algorithm according to one embodiment of the present invention;

FIG. 47 illustrates the placement of the output of FIG. 46 in an 8 bit0width memory using a naive placement method according to one embodiment of the present invention;

FIG. 48 illustrates pseudo code for a decode aware bitmask selection algorithm according to one embodiment of the present invention;

FIGS. 49-50 illustrate a bitstream merge procedure using the output of FIG. 46 as input according to one embodiment of the present invention;

FIG. 51 illustrates pseudo code for an encoded bits placement algorithm according to one embodiment of the present invention;

FIG. 52 is a block diagram illustrating a decompression engine according to one embodiment of the present invention;

FIG. 53 is a graph comparing compression ratio with the bitmasked based code compression technique;

FIG. 54 is a graph comparing compression ratio with LZSS-8 on Dirk et al. benchmarks;

FIG. 55 is a graph comparing compression ratio with LZSS-8 on Pan et al. benchmarks;

FIG. 56 is a graph comparing compression ratio with a difference vector compression technique on Pan et al. benchmarks;

FIG. 57 is a graph comparing decompression time for FFT benchmark;

FIG. 58 illustrates pseudo code for a multi-dictionary compression algorithm according to one embodiment of the present invention;

FIG. 59 illustrates pseudo code for a bitmask aware don't care resolution algorithm according to one embodiment of the present invention;

FIG. 60 illustrates input words and their frequencies for an example of a don't care resolution of NISC according to one embodiment of the present invention;

FIG. 61 is a graph that is constructed by an original don't resolution algorithm for the input words of FIG. 60;

FIG. 62 is a graph created using a bitmask aware graph creation algorithm for the input words of FIG. 60 according to one embodiment of the present invention;

FIG. 63 illustrates pseudo code for an algorithm that removes unchanging and less frequently changing bits according to one embodiment of the present invention;

FIG. 64 illustrates removal of constant and less frequent bits according to one embodiment of the present invention;

FIG. 65 illustrates a Run Length Encoding bitmask in use according to one embodiment of the present invention;

FIG. 66 illustrates the flow of control words, compression, and decompressed bits according to one embodiment of the present invention;

FIG. 67 is a block diagram illustrating another decompression engine according to one embodiment of the present invention;

FIG. 68 illustrates a branch lookup table for compressed control words according to one embodiment of the present invention;

FIG. 69 is a graph comparing the compression ratio of different programs;

FIG. 70 illustrates a n−1 encoding of an n-bit bitmask and in particular an equivalence of 2-bit bitmask to 1-bit bitmask according to one embodiment of the present invention;

FIG. 71 illustrates a n−1 encoding of an n-bit bitmask and in particular an equivalence of 3-bit bitmask to 2-bit bitmask according to one embodiment of the present invention; and

FIG. 72 is a graph comparing compression ration with and without using a n−1 bit encoding scheme.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

### Example of an Operating Environment

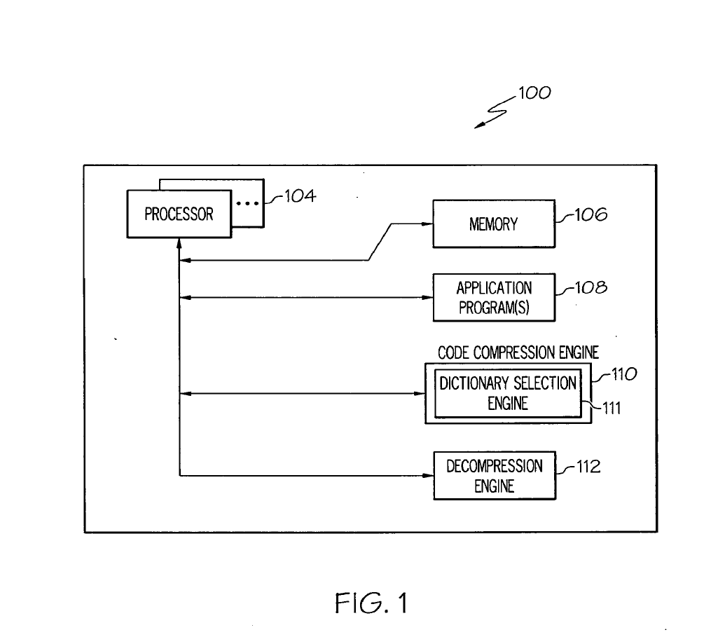

FIG. 1 is a block diagram illustrating an exemplary operating environment according to one embodiment of the present invention. In one embodiment, the operating environment 100 of FIG. 1 is used for code-compression techniques using bitmasks. It should be noted that various embodiments of the present invention can reside at a single processing node as shown in FIG. 1, scaled across multiple processing nodes such as in a distributed processing system, and can be implemented as hardware and/or software.

In particular, FIG. 1 shows an embedded information processing system 102 comprising a processor 104, a memory 106, application programs 108, a code compression engine 110, a dictionary selection engine 111 that can reside within the code compression engine and/or outside of the code compression engine, and a decompression engine 112. It should be noted that the various embodiments of the present invention are not limited to embedded systems. It should also be noted that the code compression engine 110 and the dictionary selection engine 111 can be implemented in the memory 106, as software in another system component, or as hardware. The code compression engine 110, in one embodiment, compresses the application programs 108 which are then stored in a compressed format in the memory 106. The dictionary selection engine 111 selects an optimal dictionary for the code compression process. The decompression hardware 112 is used by the system 102 to decompress the compressed information in the memory 106.

The code compression engine 110 of the various embodiments of the present invention improves compression ratio by aggressively creating more matching sequences using bitmask patterns. This significantly improves the compression efficiency without introducing any decompression penalties. Stated differently, the code compression engine 110 incorporates maximum bit changes using mask patterns without adding significant cost (extra bits) such that code ratio is improved. The code compression engine 110 is discussed in greater detail below.

It should be noted that although the following discussion is with respect to compressing applications, the various embodiments of the present invention are not limited to such an embodiment. For example, the bit-mask based compression (“BCC”) technique, decompression technique, and dictionary selection technique of the various embodiments of the present invention discussed below are also applicable to circuit testing. For example, higher circuit densities in System-on-Chip (SOC) designs have led to enhancement in the test data volume. Larger test data size demands not only greater memory requirements, but also an increase in the testing time. The BCC, decompression, and dictionary selection techniques discussed below helps overcome this problem by reducing the test data volume without affecting the overall system performance.

The BCC, decompression, and dictionary selection techniques are also applicable to parallel decompression. For example, the various embodiments of the present invention can be used for a novel bitstream placement method. Code can be placed to enable parallel decompression without sacrificing the compression efficiency. For example, the various embodiments of the present invention can be used to split a single bitstream (instruction binary) fetched from memory into multiple bitstreams, which are then fed into different decoders. As a result, multiple slow-decoders can work simultaneously to produce the effect of high decode bandwidth.

The BCC, decompression, and dictionary selection techniques are further applicable to FPGA bitstreams. For example, FPGAs are widely used in reconfigurable computing and are configured using bitstreams that are often loaded from memory. Configuration data is starting to require megabytes of data if not more. Slower and limited configuration memory restricts the number of IP core bitstreams that can be stored. The various embodiments of the present invention can be used as a bitstream compression technique that optimally combines bitmask and run length encoding and performs smart rearrangement of compressed bits.

The various embodiments of the present invention are also applicable to control compression. For example, the BCC, decompression, and dictionary selection techniques can be used to reduce bloated control words splitting them into multiple slices and compressing them separately. Also, a dictionary can be produced, which has larger bitmask coverage with minimal and restricted dictionary size. Another application of the various embodiments is with respect to seismic compression. For example, the BCC, decompression, and dictionary selection techniques can be used to perform partitioned bitmask-based compression on seismic data in order to produce a significant compression without losing any accuracy. An additional application of the various embodiments of the present invention is with respect to n-bit bitmasks. The BCC, decompression, and dictionary selection techniques can be used to perform optimal encoding of a n-bit mask pattern using only n−1 bits, which can record n differences between matched words and a dictionary entry. The optimization saves encoding space and alleviates decoder to assemble bitmask.

### General Overview of Code Compression

Memory is one of the key driving factors in embedded system design, since a larger memory indicates an increased chip area, more power dissipation, and higher cost. As a result, memory imposes constraints on the size of the application programs. Code compression techniques address the problem by reducing the program size. Traditional code compression and decompression flow is as follows: the compression is performed off-line (prior to execution) and the compressed program is loaded into the memory. The decompression is performed during the program execution (online). Compression ratio (“CR”), which is widely accepted as a primary metric for measuring the efficiency of code compression, is defined as:

$$C R = \frac{CompressedProgramSize}{OriginalProgramSize}$$

One type of compression technique is a dictionary-based code compression technique. Dictionary-based code compression techniques are popular because they provide both good compression ratio and a fast decompression mechanism. The basic idea behind dictionary-based code compression technique is to take advantage of commonly occurring instruction sequences by using a dictionary. Recently proposed techniques by J. Prakash, C. Sandeep, P. Shankar and Y. Srikant, “A simple and fast scheme for code compression for VLIW processors,” in Proceedings of Data Compression Conference (DCC), 2003, p. 444, and M. Ros and P. Sutton, “A hamming distance based VLIW/EPIC code compression technique,” in Proceedings of Compliers, Architectures, Synthesis for Embedded Systems (CASES), 2004, pp. 132-139, which are hereby incorporated by reference in their entireties, improve the dictionary-based compression by considering mismatches. These improved dictionary-based code compression techniques create instruction matches by remembering a few bit positions. The efficiency of these techniques is limited by the number of bit changes used during compression. One can see that if more bit changes are allowed, more matching sequences are generated. However, the cost of storing the information for more bit positions offsets the advantage of generating more repeating instruction sequences.

Studies such as M. Ros and P. Sutton, “A hamming distance based VLIW/EPIC code compression technique,” in Proceedings of Compliers, Architectures, Synthesis for Embedded Systems (CASES). 2004, pp. 132-139, which is hereby incorporated by reference in its entirety, have shown that considering more than three bit changes when 32-bit vectors are used for compression is not profitable. There are various complex compression algorithms that can generate major reduction in code size. However, such a compression scheme requires a complex decompression mechanism, and thereby, reduces overall system performance. Developing an efficient code compression technique that can generate substantial code size reduction without introducing any decompression penalty (and thereby reducing performance) is a major challenge. Therefore, the various embodiments of the present invention provide an efficient code compression technique to improve the compression ratio further by aggressively creating more matching sequences using bitmask patterns.

The following is a discussion on conventional compression techniques for embedded systems. The first code compression technique for embedded processors was proposed by Wolfe and Chanin, A. Wolfe and A. Chanin, “Executing compressed programs on an embedded RISC architecture,” in Proceedings of International Symposium on Microarchitecture (MICRO), 1992, pp. 81-91, which is hereby incorporated by reference in its entirety. Wolfe and Chanin's technique uses Huffman coding and the compressed program is stored in the main memory. The decompression unit is placed between a main memory and an instruction cache. Wolf and Chanin used a Line Address Table (“LAT”) to map original code addresses to compressed block addresses.

Lekatsas and Wolf, H. Lekatsas and W. Wolf, “SAMC: A code compression algorithm for embedded processors,” IEEE Transactions on Computer-Aided Design of Integrated Circuits and Systems, vol. 18, no. 12, pp. 1689-1701, December 1999, which is hereby incorporated by reference in its entirety, proposed a statistical method for code compression using arithmetic coding and Markov model. Lekatsas et al., H. Lekatsas and J. Henkel and V. Jakkula, “Design of an one-cycle decompression hardware for performance increase in embedded systems,” in Proceedings of Design Automation Conference, 2002, pp. 34-39, which is hereby incorporated by reference in its entirety, proposed a dictionary-based decompression prototype that is capable of decoding one instruction per cycle. The idea of using a dictionary to store the frequently occurring instruction sequences has been explored by various researchers such as C. Lefurgy, P. Bird, I. Chen and T. Mudge, “Improving code density using compression techniques,” in Proceedings of International Symposium on Microarchitecture (MICRO), 1997, pp. 194-203, and S. Liao, S. Devadas and K. Keutzer, “Code density optimization for embedded DSP processors using data compression techniques,” in Proceedings of Advanced Research in VLSI, 1995, pp. 393-399, which are hereby incorporated by reference in their entireties. Standard dictionary-based code compression techniques are discussed in greater detail below.

The techniques discussed so far target RISC processors. There has been a significant amount of research in the area of code compression for VLIW and EPIC processors. For example, the technique proposed by Ishiura and Yamaguchi, N. Ishiura and M. Yamaguchi, “Instruction code compression for application specific VLIW processors based of automatic field partitioning,” in Proceedings of Synthesis and System Integration of Mixed Technologies (SASIMI), 1997, pp. 105-109, which is hereby incorporated by reference in its entirety, splits a VLIW instruction into multiple fields and each field is compressed using a dictionary based scheme. Nam et al., S. Nam, I. Park and C. Kyung, “Improving dictionary-based code compression in VLIW techniques,” IEICE Trans. Fundamentals, vol. E82-A, no. 11, pp. 2318-2324, November 1999, which is hereby incorporated by reference in its entirety, also uses dictionary based scheme to compress fixed format VLIW instructions.

Various researchers such as S. Larin and T. Conte, “Compiler-driven cached code compression for application specific VLIW processors based of automatic field partitioning,” in Proceedings of International Symposium on Microarchitecture (MICRO), 1999, pp. 82-91, and Y. Xie, W. Wolf and H. Lekatsas, “Code compression for VLIW processors using variable-to-fixed coding,” in Proceedings of International Symposium on System Synthesis (ISSS), 2002, pp. 138-143, which are hereby incorporated by reference in their entireties, have developed code compression techniques for VLIW architectures with flexible instruction format. Larin and Conte, S. Larin and T. Conte, “Compiler-driven cached code compression for application specific VLIW processors based of automatic field partitioning,” in Proceedings of International Symposium on Microarchitecture (MICRO), 1999, pp. 82-91, which is hereby incorporated by reference in its entirety, applied Huffman coding for code compression. Xie et al., Y. Xie, W. Wolf and H. Lekatsas, “Code compression for VLIW processors using variable-to-fixed coding,” in Proceedings of International Symposium on System Synthesis (ISSS), 2002, pp. 138-143, which is hereby incorporated by reference in its entirety, used Tunstall coding to perform variable-to-fixed compression. Lin et al., C. Lin, Y. Xie and W. Wolf, “LZW-based code compression for VLIW embedded systems,” in Proceedings of Design Automation and Test in Europe (DATE), 2004, pp. 76-81, which is hereby incorporated by reference in its entirety, proposed a LZW-based code compression for VLIW processors using a variable-sized-block method. Ros and Sutton, M. Ros and P. Sutton, “A post-compilation register re-assignment technique for improving hamming distance code compression, in Proceedings of Compilers, Architectures, Synthesis for Embedded Systems (CASES), 2005, pp. 97-104, which is hereby incorporated by reference in its entirety, have used a post-compilation register reassignment technique to generate compression friendly code. Das et al., D. Das and R. Kumar and P. P. Chakrabarti, “Dictionary based code compression for variable length instruction encodings,” in Proceedings of VLSI Design, 2005, pp. 545-550, which is hereby incorporated by reference in its entirety, applied code compression on variable length instruction set processors.

### Dictionary-Based Code Compression

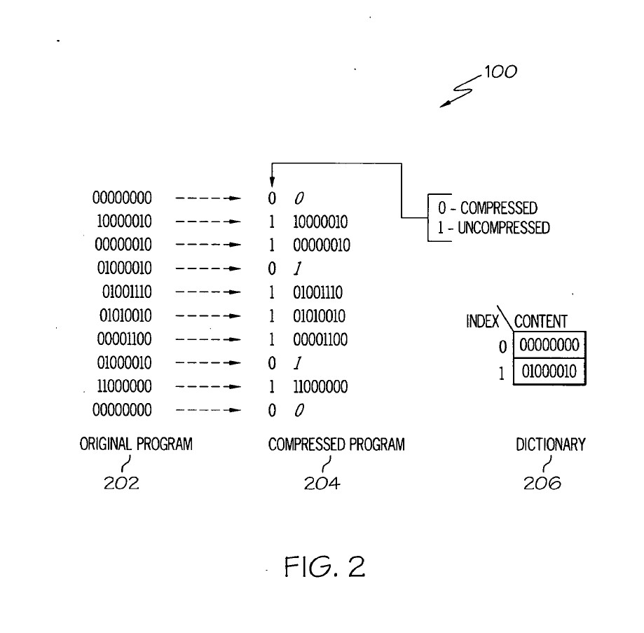

Dictionary-based code compression techniques provide compression efficiency as well as a fast decompression mechanism. Dictionary-based code compression techniques take advantage of commonly occurring instruction sequences by using a dictionary. The repeating occurrences are replaced with a codeword that points to the index of the dictionary that contains the pattern. The compressed program consists of both codewords and uncompressed instructions. FIG. 2 shows an example of dictionary based code compression using a simple program binary. In particular, FIG. 2 show an original program 202, the compressed program 204 (wherein 0 indicates compressed and a 1 indicates uncompressed), and a dictionary 206 indicating an index and corresponding content.

The binary 202 consists of ten 8-bit patterns i.e., total 80 bits. The dictionary 206 has two 8-bit entries. The compressed program 204 requires 62 bits and the dictionary 206 requires 16 bits. In this case, the CR is 97.5% (using Equation 1 above). This example shows a variable length encoding. As a result, there are several factors that may need to be included in the computation of the compression ratio, such as byte alignments for branch targets and the address mapping table.

### Improved Dictionary-Based Code Compression

Recently proposed techniques such as J. Prakash, C. Sandeep, P. Shankar and Y. Srikant, “A simple and fast scheme for code compression for VLIW processors,” in Proceedings of Data Compression Conference (DCC), 2003, p. 444, and M. Ros and P. Sutton, “A hamming distance based VLIW/EPIC code compression technique,” in Proceedings of Compliers, Architectures, Synthesis for Embedded Systems (CASES), 2004, pp. 132-139, which are hereby incorporated by reference in their entireties, improve the standard dictionary-based compression technique by considering mismatches. The standard dictionary-based compression technique identifies the instruction sequences that are different in a few bit positions (hamming distance) and stores that information in the compressed program and updates the dictionary (if necessary). The compression ratio will depend on how many bit changes are considered during compression.

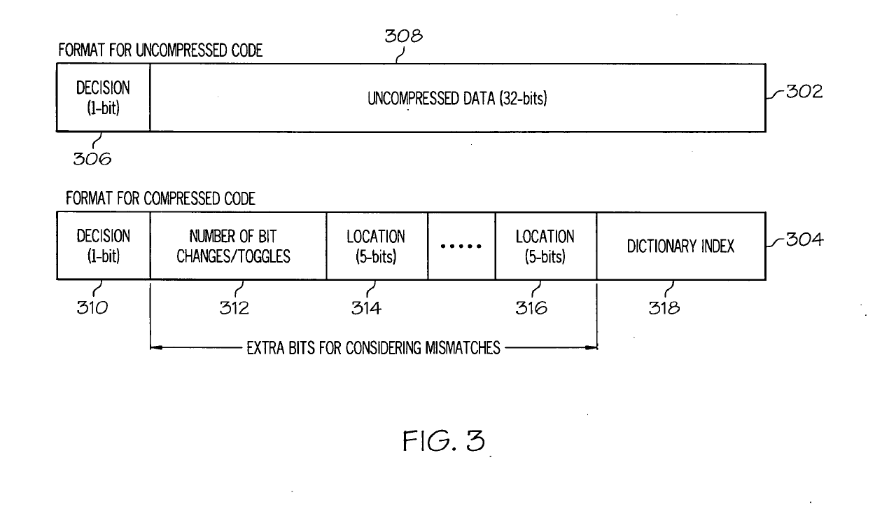

FIG. 3 shows the encoding format used by these techniques for a 32-bit program code. In particular, FIG. 3 shows an encoding format 302 for uncompressed code and an encoding format 304 for compressed code. The uncompressed code format 302 comprises a decision bit 306 and uncompressed data 308. The compressed code format 304 includes a decision bit 310, bits 312 indicating the number of bit changes/toggles, location bits 314, 316, and a dictionary index 318. One can see that if more bit changes are allowed, more matching sequences are be generated. However, the size of the compressed program increases depending on the number of bit positions. The Section below entitled “Cost-Benefit Analysis for Considering Mismatches” describes this topic in detail. Prakash et al., J. Prakash, C. Sandeep, P. Shankar and Y. Srikant, “A simple and fast scheme for code compression for VLIW processors,” in Proceedings of Data Compression Conference (DCC), 2003, p. 444, which is hereby incorporated by reference in its entirety, considered only one-bit change for 16-bit patterns (vectors). Ros et al., M. Ros and P. Sutton, “A hamming distance based VLIW/EPIC code compression technique,” in Proceedings of Compliers, Architectures, Synthesis for Embedded Systems (CASES), 2004, pp. 132-139, which is hereby incorporated by reference in its entirety, considered a general scheme of up to 7 bit changes for 32-bit patterns and concluded that a 3-bit change provides the best compression ratio.

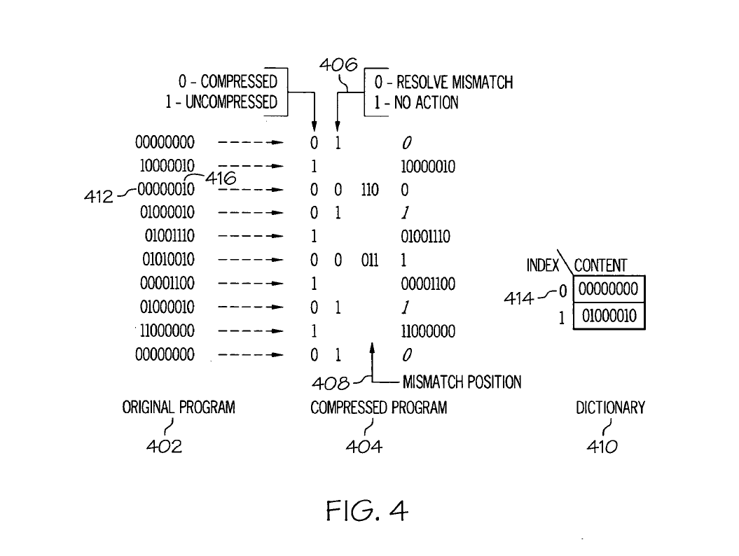

FIG. 4 shows the improved dictionary-based scheme using the same example (shown in FIG. 2). This example only considers a 1-bit change. In particular, FIG. 4 shows an original program 402, the compressed program 404 (wherein 0 indicates compressed and a 1 indicates uncompressed), a resolve mismatch indicator 406, a mismatch position indicator 408, and a dictionary 410 indicating an index and corresponding content. The resolve mismatch indicator 406 is an extra field that indicates whether mismatches are considered or not. In case a mismatch is considered, the mismatch position field 408 indicates the bit position that is different from an entry in the dictionary. For example, the third pattern 412 (from top) in the original program 402 is different from the first dictionary entry 414 (index 0) on sixth bit position 416 (from left). The CR for this example is 95%.

### Cost-Benefit Analysis for Considering Mismatches

One can see that additional repeating patterns can be created if changes in more bit positions are considered. For example, if 2-bit changes are considered in FIG. 4, all mismatched patterns can be compressed. However, increasing more repeating patterns by considering multiple mismatches does not always improve the compression ratio. This is due to the fact that the compressed program has to store multiple bit positions. For example, if 2-bit changes are considered for the example in FIG. 4, the compression ratio is worse (102.5%).

A detailed study was performed on how to match more bit positions without adding significant information in the compressed code. The various embodiments of the present invention considered 32-bit code vectors for compression. Clearly, the hamming distance between any two 32-bit vectors is between 0 and 32. The compression adds an extra 5 bits to remember each bit position in a 32-bit pattern. Moreover, extra bits are necessary to decide how many bit changes are there in the compressed code. For example, if the code allows up to 32 bit changes, it requires an extra 5 bits to indicate the number of changes. As a result, this process requires a total of 165 extra bits (32×5+5) when all 32 bits are different. Clearly, it is not profitable to compress a 32-bit vector using 165 extra bits along with a codeword (index information) and other details.

The use of bit-masks for creating repeating patterns was also explored. For example, a 32-bit mask pattern is sufficient to match any two 32-bit vectors. Of course, it is not profitable to store extra 32 bits to compress a 32-bit vector but definitely better than 165 extra bits. Mask patterns of different sizes (1-bit to 32-bit) were also considered. When a mask pattern is smaller than 32 bits, information related to the starting bit position is stored where the mask needs to be applied. For example, if a 8-bit mask pattern is used, and want to consider all 32-bit mismatches, it requires four 8-bit masks, and extra two bits (to identify one of the 4 bytes) for each mask pattern to indicate where it will be applied. In this particular case, an extra 42 bits is required.

In general a dictionary contains 256 or more entries. As a result, a code pattern has had fewer than 32 bit changes. If a code pattern is different from a dictionary entry in 8 bit positions, it requires only one 8-bit mask and its position i.e., it requires 13 (8+5) extra bits. This can be improved further if bit changes only in byte boundaries are considered. This leads to a tradeoff—requires fewer bits (8+2) but may miss few mismatches that spread across two bytes. One embodiment of the present invention uses the latter approach that uses fewer bits to store a mask position.

TABLE I
COST OF VARIOUS MATCHING SCHEMES

| | Size of the Mask Pattern | | | | | |
|---|---|---|---|---|---|---|
| Bit Changes | 1-bit | 2-bit | 4-bit | 8-bit | 16-bit | 32-bit |
| 32 bits | 165 | 100 | 59 | 42 | 35 | 32 |
| 16 bits | 84 | 51 | 30 | 21 | 17 | |
| 8 bits | 43 | 26 | 15 | 10 | | |
| 4 bits | 22 | 13 | 7 | | | |
| 2 bits | 11 | 6 | | | | |
| 1 bit | 5 | | | | | |

An entry is left blank when that combination is not possible.

Table I above shows the summary of the study. Each row represents the number of changes allowed. Each column represents the size of the mask pattern. A one-bit mask is essentially same as remembering the bit position. Each entry in the table (r, c) indicates how many extra bits are necessary to compress a 32-bit vector when r number of bit changes are allowed and c is the size of the mask pattern. For example, an 15 extra bits is required to allow 8-bit (row with value 8) changes using 4-bit (column with value 4) mask patterns.

### Bitmask-Based Code Compression

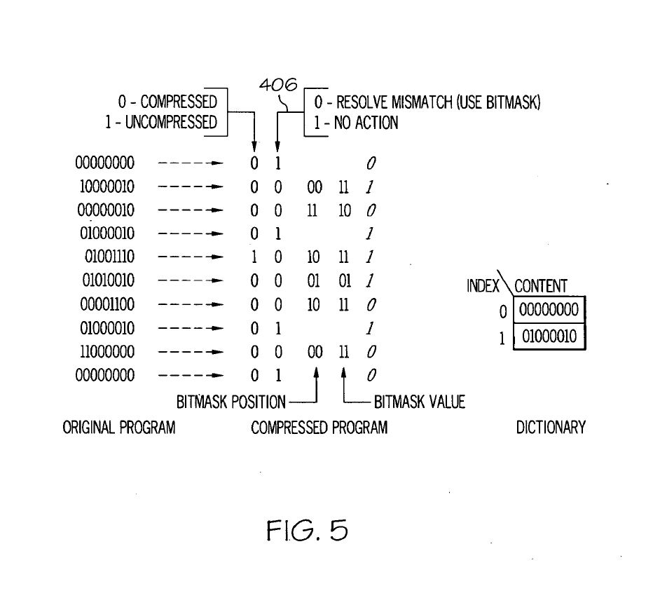

The BCC technique performed by the code compression engine 110 of the various embodiments of the present invention significantly improves compression ratio. For example, consider the same example shown in FIG. 4. A 2-bit mask (only on quarter byte boundaries) is sufficient to create 100% matching patterns and thereby improves the compression ratio (87.5%) as shown in FIG. 5. For example, FIG. 5 shows that when a program is compressed an indicator such as 0 is used to indicate a compressed stated. When the program is not used an indicator such as 1 is used to indicate an uncompressed state. For example, the binary 00000000 in FIG. 5 is compressed as indicated by the 0 indicator and the binary 01001110 remains uncompressed as indicated by the 1 indicator. Another set of indicators are used to indicate whether mismatches are considered. For example, with respect to the binary 00000000 mismatches are not considered as indicated by the 0 indicator because the binary matches an entry in the dictionary. With respect to the binary 01001110 mismatches are considered as indicated by the 1 indicator because the binary does not match an entry in the dictionary. When a mismatch occurs a bitmask is used. For example, with respect to the 01001110 a bit mask position of 10 is used with a bitmask value of 11. This allows the binary 01001110 to be compressed using the dictionary entry of 01000010. It should be noted that the present invention significantly improves the compression ratio. Experiments using real applications demonstrate that the compression ratio using the BCC approach varies between 50-65%. The various embodiments of the present invention incorporate maximum bit changes using mask patterns without adding significant cost (extra bits) such that the compression ratio is improved over the conventional code compression techniques discussed above. The various embodiments of the present invention also ensure that the decompression efficiency is not degraded. In one embodiment, a 32-bit program code (vector) is considered and mask patterns are used.

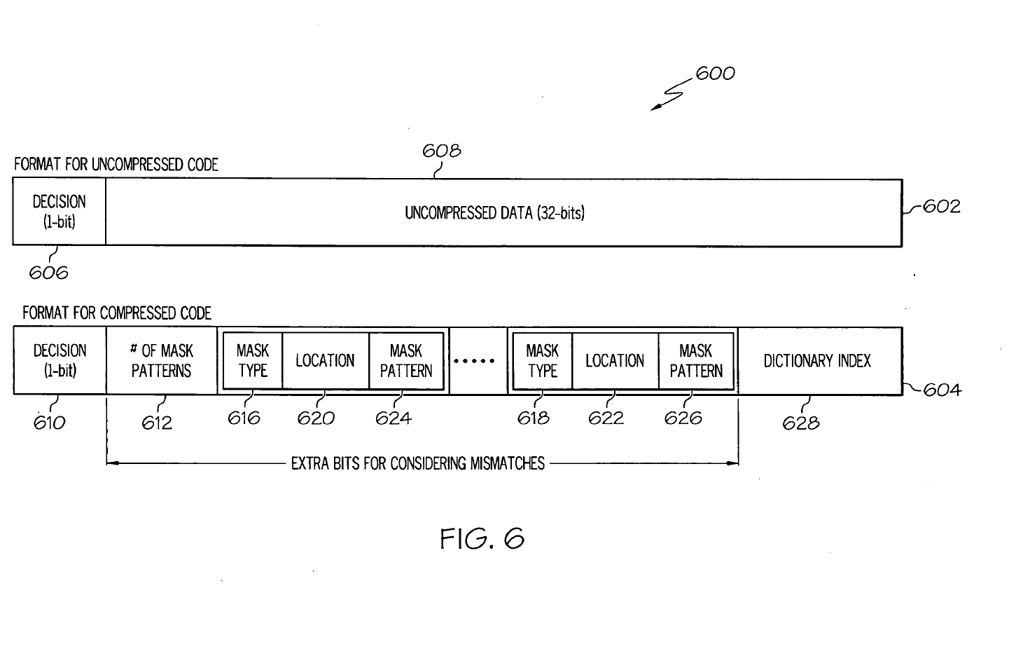

FIG. 6 shows the generic encoding scheme 600 used by the code-compression engine 110 to perform the compression technique of the various embodiments of the present invention. In particular, FIG. 6 shows a format 602 for uncompressed code and a format 604 for compressed code. The uncompressed code format 602 includes a decision bit 606, which in this example is 1-bit; and uncompressed data 608, which in this example is 32-bits. The compressed code format 604 includes a decision bit 610, which in this example is 1-bit; a bit set 612 that indicates the number of mask patterns; a bit set 616, 618 that indicates mask type; a bit set 620, 622 that indicates location; a bit set 624, 626 that indicates the mask pattern, and a dictionary index 628. The bit set 612, 614 that indicates the number of mask patterns; the bit set 616, 618 that indicates mask type; the bit set 620, 622 that indicates location; and the bit set 624, 626 that indicates the mask pattern are extra bits that are used for considering mismatches.

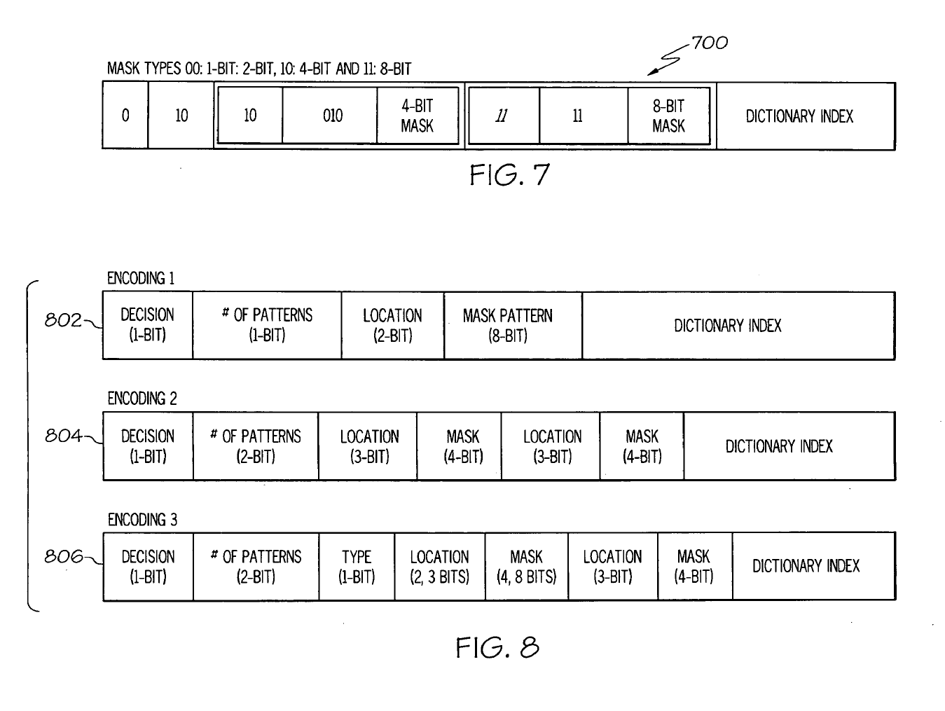

The 32-bit format shown in FIG. 6 is different than that 32-bit format shown in FIG. 3 in that the format of FIG. 3 records individual bit changes, which limits the number of matches. With the format of FIG. 6, however, a compressed code can store information regarding multiple mask patterns. For each pattern, the generic encoding stores the mask type 616, 618, (requires two bits to distinguish between 1-bit. 2-bit, 4-bit, or 8-bit), the location 620, 622 where mask needs to be applied, and the mask pattern. The number of bits needed to indicate a location depends on the mask type. A mask of size s can be applied on (32÷s) number of places. For example, an 8-bit mask can be applied only on four places (byte boundaries). Similarly, a 4-bit mask can be applied on eight places (byte and half-byte boundaries). Consider a scenario where a 32-bit word is compressed using one 4-bit mask at second half-byte boundary, and one 8-bit mask at fourth byte boundary, the compressed code 700 is shown in FIG. 7.

The generic encoding scheme of FIG. 6 can be further optimized. For code compression, using up to two bitmasks is sufficient to achieve a good compression ratio. FIG. 8 shows three examples of customized encoding formats using 4-bit and 8-bit masks. The first encoding 802 (Encoding 1) uses an 8-bit mask, the second encoding 804 (Encoding 2) uses up to two 4-bit masks, and the third encoding 806 (Encoding 3) uses up to two masks where first mask can be 4-bit or 8-bit, whereas the second mask is always 4-bit.

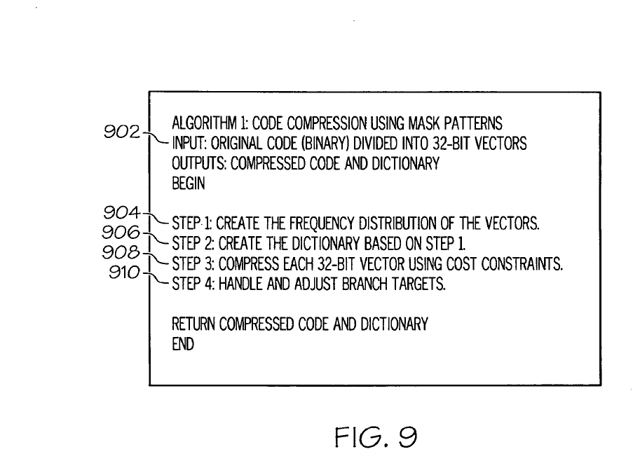

The following is a detailed discussion on the how the code compression engine 110 compress code into the format shown in FIG. 6. FIG. 9 shows four high level steps that the compression engine 110 takes when performing code compression using mask patterns. The code compression engine 110, at line 902, accepts the original code (binary) and divides the code into 32-bit vectors. The code compression engine 110, at line 904, creates the frequency distribution of the vectors. The code compression engine 110 considers two types of information to compute the frequency: repeating sequences and possible repeating sequences by bitmasks. First, the code compression engine 110 finds the repeating 32-bit sequences and the number of repetition determines the frequency. This frequency computation provides an initial idea of the dictionary size. Next, the code compression engine 110 upgrades or downgrades all the high frequency vectors based on how many new repeating sequences they can create from mismatches using bitmasks with cost constraints. Table I above provides the cost for the choices. For example, it is costly to use two 4-bit masks (cost: 15 bits) if an 8-bit mask (cost: 10 bits) can create the match.

The code compression engine 110, at line 906, chooses the smallest possible dictionary size without significantly affecting the compression ratio. Considering larger dictionary sizes is useful when the current dictionary size cannot accommodate all the vectors with frequency value above certain threshold. (e.g., above 3 is profitable). However, there are certain disadvantages of increasing the dictionary size. The cost of using a larger dictionary is more since the dictionary index becomes bigger. The cost increase is balanced only if most of the dictionary is full with high frequency vectors. Most importantly, a bigger dictionary increases an access time and thereby reduces decompression efficiency.

The code compression engine 110, at line 908, converts each 32-bit vector into compressed code (when possible) using the format shown in FIG. 6. The compressed code, along with any uncompressed codes, is composed serially to generate the final compressed program code. The code compression engine 110, in one embodiment, produces variable length compressed code, which can cause finding a branch target during decompression to be difficult. Therefore, to overcome the branch instruction problem, the code compression engine 110, at line 910, step adjusts branch targets. Wolfe and Chanin, A. Wolfe and A. Chanin, “Executing compressed programs on an embedded RISC architecture,” in Proceedings of International Symposium on Microarchitecture (MICRO), 1992, pp. 81-91, which is hereby incorporated by reference in its entirety, proposed the LAT, however, it requires an extra space and degrades overall performance. Lefurgy, C. Lefurgy, P. Bird, I. Chen and T. Mudge, “Improving code density using compression techniques,” in Proceedings of International Symposium on Microarchitecture (MICRO), 1997, pp. 194-203, which is hereby incorporated by reference in its entirety, proposed a technique which patches the original branch target addresses to the new offsets in the compressed program. This approach does not require an additional space for the LAT nor affect the performance of the program but it may not work on indirect branches.

The code compression engine 110 handles branch targets as follows: 1) patch all the possible branch targets into new offsets in the compressed program, and pad extra bits at the end of the code preceding branch targets to align on a byte boundary; and 2) create a minimal mapping table to store the new addresses for ones that could not be patched. This approach significantly reduces the size of the mapping table required, allowing very fast retrieval of a new target address. The code compression technique of the code compression engine 110 is very useful since more than 75% control flow instructions are conditional branches (compare and branch, See J. Hennessy and D. Patterson, Computer Architecture: A Quantitative Approach. Morgan Kaufmann Publishers, 2003, which is hereby incorporated by reference in its entirety) and they are patchable. The compression technique of the various embodiments of the present invention leaves only 25% for a small mapping table. Experiments show that more than 95% of the branches taken during execution do not require the mapping table. Therefore, the effect of branching is minimal in executing the compressed code of the various embodiments of the present invention. To avoid this problem the code compression engine 110 perform two tasks: i) add extra bits % (at the end of the code that precedes branch target) to align the branch targets on a byte boundary, and ii) maintain a Line Address Table (For a more detailed discussion on LATs see A. Wolfe and A. Chanin, “Executing compressed programs on an embedded RISC architecture,” in Proceedings of International Symposium on Microarchitecture (MICRO), 1992, pp. 81-91, which is hereby incorporated by reference in its entirety) that includes the mapping between branch target addresses in the original code and compressed code.

One of the major challenges in bitmask-based code compression is how to determine (a set of) optimal mask patterns that maximizes the matching sequences while minimizing the cost of bitmasks. A 2-bit mask can handle up to 4 types of mismatches while a 4-bit mask can handle up to 16 types of mismatches. Clearly, applying a larger bitmask generate more matching patterns; however, doing so may not result in better compression. The reason is simple. A longer bit-mask pattern is associated with a higher cost. Similarly, applying more bitmasks is not always beneficial. For example, applying a 4-bit mask requires 3 bits to indicate its position (8 possible locations in a 32-bit vector) and 4 bits to indicate the pattern (total 7 bits) while an 8-bit mask requires 2 bits for the position and 8 bits for the pattern (total 10 bits). Therefore, it would be more costly to use two 4-bit masks if one 8-bit mask can capture the mismatches.

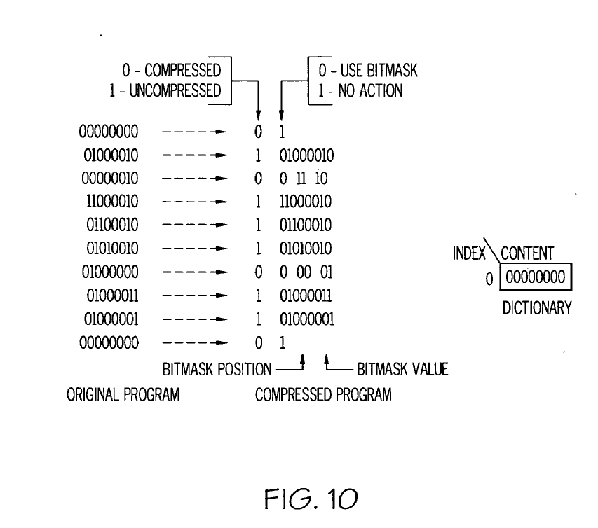

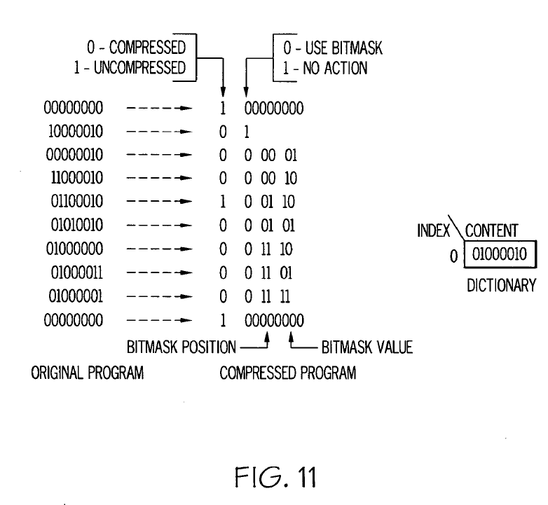

Another major challenge in bitmask-based compression is how to perform dictionary selection where existing, as well as bitmask-matched repetitions, need to be considered. In the traditional dictionary-based compression approach, the dictionary entry selection process is simplified since it is evident that the frequency-based selection will give the best compression ratio. However, when compressing using bitmasks, the problem is complex and the frequency-based selection does not always yield the best compression ratio. FIGS. 10 and 11 demonstrate this fact. For example, when only one dictionary entry is allowed, the pure frequency-based selection, as shown in FIG. 10, selects “0000000”, yielding the compression ratio of 97.5% (Compressed Program 1). However, if “01000010” was chosen, as shown in FIG. 11, the compression ratio of 87.5% (Compressed Program 2) can be achieved for the same input program. Clearly, there is a need for efficient mask selection and dictionary selection techniques to improve the efficiency of bitmask-based code compression.

The following discussion addresses how the bitmask-based code compression of the various embodiments of the present invention overcomes the challenges discussed above by using application-specific bitmask selection and a bitmask-aware dictionary selection technique. As discussed above, mask selection is a major challenge. Therefore, the code compression engine 110 utilizes a procedure to find a set of bitmask patterns that deliver the best compression ratio for a given application(s). Therefore, it is important to determine i) how many bitmask patterns are needed and ii) which bitmask patterns are profitable. However, before discussing how these are determined, a few terms related to bitmask patterns are defined.

Table II below shows the mask patterns that can generate matching patterns at an acceptable cost. A “fixed” bitmask pattern implies that the pattern can be applied only on fixed locations (starting positions). For example, an 8-bit fixed mask (referred as 80 is applicable on 4 fixed locations (byte boundaries) on a 32-bit vector. A “sliding” mask pattern can be applied anywhere. For example, an 8-bit sliding mask (referred as 8s) can be applied in any location on a 32-bit vector. There is no difference between fixed and sliding for a 1-bit mask. In one embodiment, a 1-bit sliding mask (referred as 1s) is used for uniformity.

TABLE II
VARIOUS BIT-MASK PATTERNS

| Bit-Mask | Fixed | Sliding |
|---|---|---|
| 1 bit | | X |
| 2 bits | X | X |
| 3 bits | | X |
| 4 bits | X | X |
| 5 bits | | X |
| 6 bits | | X |
| 7 bits | | X |
| 8 bits | X | X |

The number of bits needed to indicate a location depends on the mask size and the type of the mask. A fixed mask of size x can be applied on (32÷x) number of places. An 8-bit fixed mask can be applied only on four places (byte boundaries), therefore requiring 2 bits. Similarly, a 4-bit fixed mask can be applied on eight places (byte and half-byte boundaries) and requires 3 bits for its position. A sliding pattern requires 5 bits to locate the position regardless of its size. For instance, a 4-bit sliding mask requires 5 bits for location and 4 bits for the mask itself.

If two distinct bit-mask patterns, 2-bit fixed (2) and 4-bit sliding (4s), are chosen six combinations: (2f), (4f), (2f, 2f), (2f, 4f), (4f, 2f), (4f, 4f) can be generated. Similarly, three distinct mask patterns can create up to 39 combinations. Therefore, a determination as to the number of bitmask patterns needed yields that up to two mask patterns are profitable. The reason is can easily be seen based on the cost consideration. For example, the smallest cost to store the three bit-mask information (position and pattern) is 15 bits (if three 1-bit sliding patterns are used). In addition, 1-5 bits are needed to indicate the mask combination and 8-14 bits for a codeword (dictionary index). Therefore, approximately 29 bits (on average) are required to encode a 32-bit vector. In other words, only 3 bits are saved to match 3 bit differences (on a 32-bit vector). Clearly, it is not very profitable to use three or more bitmask patterns.

Moving on to determining which bitmasks are profitable, applying a larger bitmask can generate more matching patterns, as discussed above. However, it may not improve the compression ratio. Similarly, using a sliding mask where a fixed one is sufficient is wasteful since a fixed mask require fewer number of bits (compared to its sliding counterpart) to store the position information. For example, if a 4-bit sliding mask (cost of 9 bits) is used where a 4-bit fixed (cost of 7 bits) is sufficient, two additional bits are wasted.

The combinations of up to two bit-masks have been studied using several applications compiled on a wide variety of architectures. An observation was made that the mask patterns that are factors of 32 (e.g., masks 1, 2, 4 and 8 from Table II above produce a better compression ratio compared to non-factors (e.g., masks 3, 5, 6, and 7). This is due to the fact that, in one embodiment, the program of 32-bit vectors is accepted by the code compression engine 110. Therefore non-factor sized bit-masks were only usable as a sliding pattern. While sliding patterns are more flexible, they are more costly than fixed patterns. The above observations allowed the 11 mask patterns in Table II to be reduced down to 7 profitable mask patterns shown in Table III below.

TABLE III
PROFITABLE BIT-MASK PATTERNS

| Bit-Mask | Fixed | Sliding |
|---|---|---|
| 1 bit | | X |
| 2 bits | X | X |
| 4 bits | X | X |
| 8 bits | X | X |

The result of compression ratios using various mask combinations were analyzed and several useful observations were made that helped further reduce the bit-mask pattern table. It was found that 8f and 8s are not helpful and 4s does not perform better than 4f. It was also observed that using two bitmasks provide a better compression ratio than using one bitmask alone. The final set of profitable bitmask patterns are shown in Table IV. An integrated compression technique of one embodiment of the present invention discussed below uses the bitmask patterns from Table IV.

TABLE IV
FINAL BIT-MASK PATTERNS

| Bit-Mask | Fixed | Sliding |
|---|---|---|
| 1 bit | | X |
| 2 bits | X | X |
| 4 bits | X | |

Dictionary selection is another major challenge in code compression. The optimal dictionary selection is an NP hard problem, L. Li and K. Chakrabarty and N. Touba, “Test data compression using dictionaries with selective entries and fixed-length indices,” ACM Transactions on Design Automation of Electronic Systems (TODAES), vol. 8(4), pp. 470-490, October 2003, which is hereby incorporated by reference in its entirety. Therefore, the dictionary selection techniques in literature try to develop various heuristics based on application characteristics. Dictionary can be generated either dynamically during compression or statically prior to compression. While a dynamic approach such as LZW, C. Lin, Y. Xie and W. Wolf, “LZW-based code compression for VLIW embedded systems,” in Proceedings of Design Automation and Test in Europe (DATE), 2004, pp. 76-81, which is hereby incorporated by reference in its entirety, accelerates the compression time, seldom it matches the compression ratio of static approaches. Moreover, it may introduce an extra penalty during decompression and thereby reduces the overall performance. In the static approach, the dictionary can be selected based on the distribution of the vectors' frequency or spanning, M. Ros and P. Sutton, “A hamming distance based VLIW/EPIC code compression technique,” in Proceedings of Compliers, Architectures, Synthesis for Embedded Systems (CASES), 2004, pp. 132-139, which is hereby incorporated by reference in its entirety

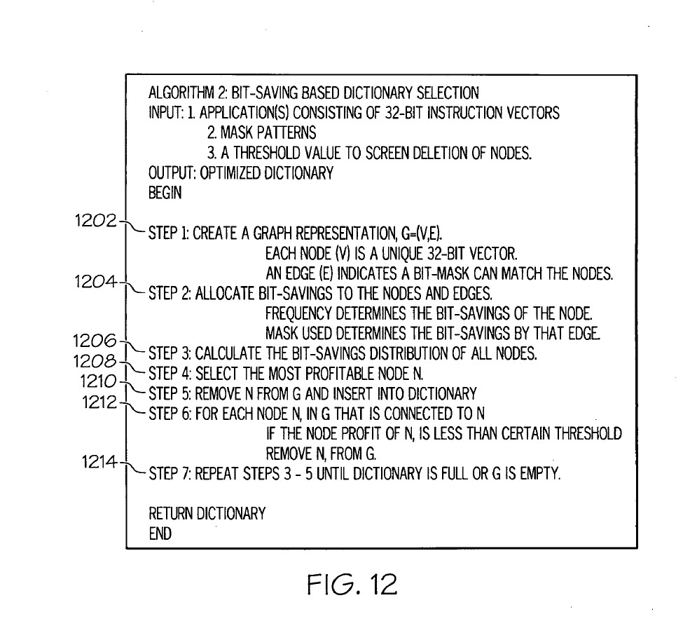

Frequency-based and spanning-based methods cannot efficiently exploit the advantages of bitmask-based compression. Moreover, due to lack of a comprehensive cost metric, it is not always possible to obtain the optimal dictionary by combining frequency and spanning-based methods in an ad-hoc manner. Therefore, the various embodiments of the present provide a novel dictionary selection technique that considers bit savings as a metric to select a dictionary entry. FIG. 12 shows the bit-saving based dictionary selection technique according to one embodiment of the present invention. In particular, the dictionary selection engine 111 takes an application(s) comprising of 32-bit vectors as input and produces the dictionary as output that delivers a good compression ratio.

The dictionary selection engine 111, at line 1202, first creates a graph where the nodes are the unique 32-bit vectors. An edge is created between two nodes if they can be matched using a bit-mask pattern(s). It is possible to have multiple edges between two nodes since they can be matched by various mask patterns. However, only one edge between two nodes corresponding to the most profitable mask (maximum savings) is considered in this example. The dictionary selection engine 111, at line 1204, allocates bit savings to the nodes and edges. In one embodiment, frequency determines the bit savings of the node and mask is used to determine the bit savings by that edge. Once the bit-savings are assigned to all nodes and edges, the dictionary selection engine 111, at line 1206, computes the overall savings for each node. The overall savings is obtained by adding the savings in each edge (bitmask savings) connected to that node along with the node savings (based on the frequency value).

The dictionary selection engine 111, at line 1208, selects the node with the maximum overall savings as an entry for the dictionary, dictionary selection engine 111, at line 1210, deletes the selected node, as well as the nodes that are connected to the selected node, from the graph. However, it should be noted that in some embodiments it is not always profitable to delete all the connected nodes. Therefore, at line 1212 a particular threshold is set to screen the deletion of nodes. Typically, a node with a frequency value less than 10 is a good candidate for deletion when the dictionary is not too small. This varies from application to application but based on experiments a threshold value between 5 and 15 is most useful, at least in this embodiment. The dictionary selection engine 111, at line 1214, terminates the selection process when either the dictionary is full or the graph is empty.

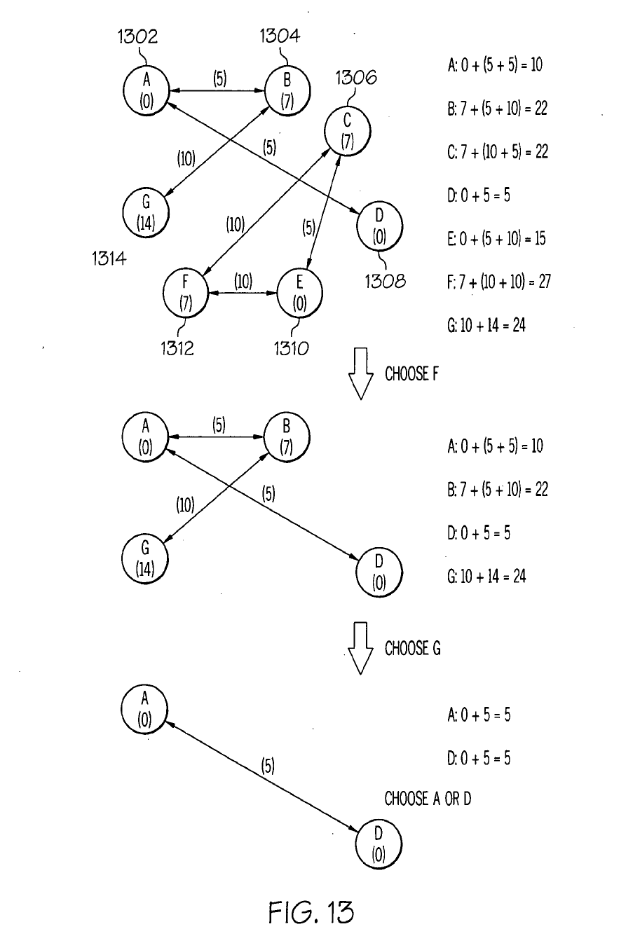

FIG. 13 illustrates the dictionary select technique discussed above. The vertex “A” 1302 has the total saving of 10 (5+5), “B” 1304 and “C” 1306 have 22, “D” 1408 has 5, “E” 1310 has 15, “F” 1312 has 27, and “G” 1314 has 24. Therefore, the dictionary selection engine 111 selects “F” 1312 is as the best candidate and gets inserted into the dictionary. Once “F” 1312 is inserted into the dictionary, “F” 1312 gets removed from the graph. “C” 1306 and “E” 1310 are also removed since they can be matched with “F” in the dictionary and bitmask(s). Note that if the frequency value of the node “C” was larger than the threshold value, “C” would not be removed in this iteration. The dictionary selection engine 111 repeats this process by recalculating the savings of the vertex in the new graph and terminates when the dictionary becomes full or the graph is empty. Experimental results show that the bit-saving based dictionary selection method outperforms both frequency and spanning based approaches.

### Integrated Code Compression Algorithm

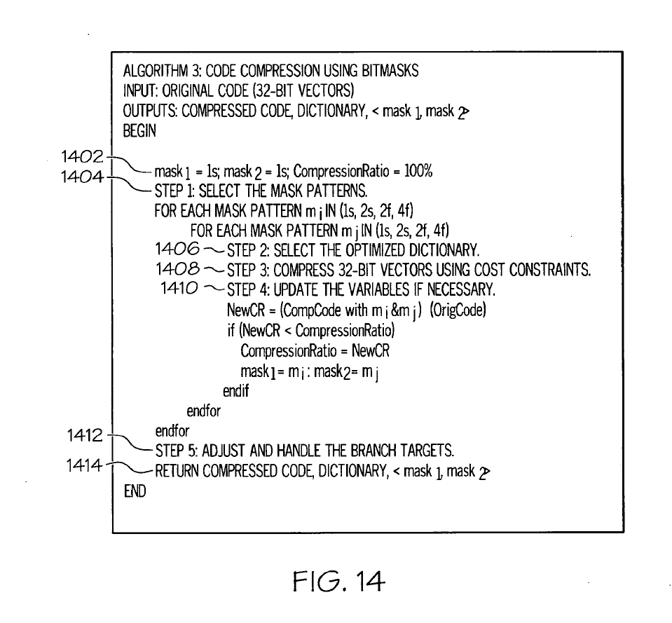

The following is a more detailed discussion on the code compression process of the various embodiment of the present invention integrated with the mask selection and dictionary selection methods discussed above. The goal is to maximize the compression efficiency using the bitmask-based code compression. FIG. 14 shows the code compression technique of FIG. 9 being integrated with the mask and dictionary selection methods discussed above. The code compression engine 110, at line 1402, initializes three variables: mask₁, mask₂, and CompressionRatio. The profitable mask patterns are stored in mask₁, and mask₂ and CompressionRatio stores the best compression ratio at each iteration. The code compression engine 110, at line 1404, selects a pair of mask patterns from the reduced set of (1s, 2s, 2f, 4f) from Table IV above. The code compression engine 110, at line 1406, selects the optimized dictionary using the process discussed above with respect to FIG. 13. The code compression engine 110, at line 1408, converts each 32-bit vector into compressed code (when possible). If the new compression ratio is better than the current one, the code compression engine 110, at line 1410, updates the variables. The code compression engine 110, at line 1412, resolves the branch instruction problem by adjusting branch targets. The code compression engine 110, at line 1414, outputs the compressed code, optimized dictionary and two profitable mask patterns.

It is important to note that this process can be used as a one-pass or two-pass code compression technique. In a two-pass code compression approach, the first pass can use synthetic benchmarks (equivalent to the real applications in terms of various characteristics but much smaller) to determine the most profitable two mask patterns. During second pass the first step (two for loops) can be ignored and the actual code compression can be performed using real applications.

### Decompression Engine

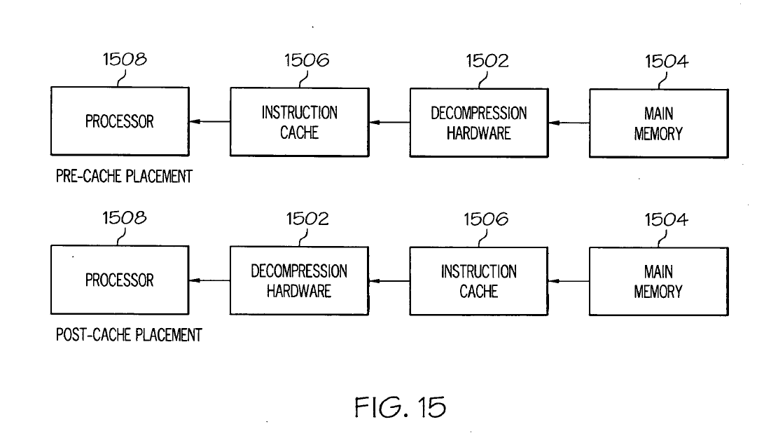

Embedded systems with caches can employ a decompression scheme in different ways as shown in FIG. 15. For example, the decompression hardware 1502 can be used between the main memory 1504 and the instruction cache (pre-cache) 1506. As a result, the main memory 1504 contains the compressed program whereas the instruction cache 1506 has the original program. Alternatively, the decompression engine 1502 can be used between the instruction cache 1506 and the processor (post-cache) 1508.

The post-cache design has an advantage since the cache retains data still in a compressed form, increasing cache hits and reducing bus bandwidth, therefore achieving potential performance gain. Lekatsas et al., H. Lekatsas and J. Henkel and V. Jakkula, “Design of an one-cycle decompression hardware for performance increase in embedded systems,” in Proceedings of Design Automation Conference, 2002, pp. 34-39, which is hereby incorporated by reference in its entirety, reported a performance increase of 25% on average by using a dictionary-based code compression and post-cache decompression engine. Decompression (decoding) time is critical for the post-cache approach. The decompression unit needs to be able to provide an instruction at the rate of the processor to avoid any stalling. The decompression engine 112 of the various embodiments of the present invention is a dictionary-based decompression engine that handles bitmasks and uses post-cache placement of the decompression hardware. The decompression engine 112 facilitates simple and fast decompression and does not require modification to the existing processor core.

The decompression engine 112, in one embodiment, is based on the one-cycle decompression engine proposed by Lekatsas et el., H. Lekatsas and J. Henkel and V. Jakkula, “Design of an one-cycle decompression hardware for performance increase in embedded systems,” in Proceedings of Design Automation Conference, 2002, pp. 34-39, which is hereby incorporated by reference in its entirety. In one embodiment, the decompression engine 112 is implemented using VHDL and synthesized using Synopsys Design Compiler, Synopsys. ([http://www.synopsys.com]), which is hereby incorporated by reference in its entirety. This implementation is based on various generic parameters, including dictionary size (index size), number and types of bitmasks etc. Therefore, the same implementation of the decompression engine 112 can be used for different applications/architectures by instantiating the engine 112 with an appropriate set of parameters.

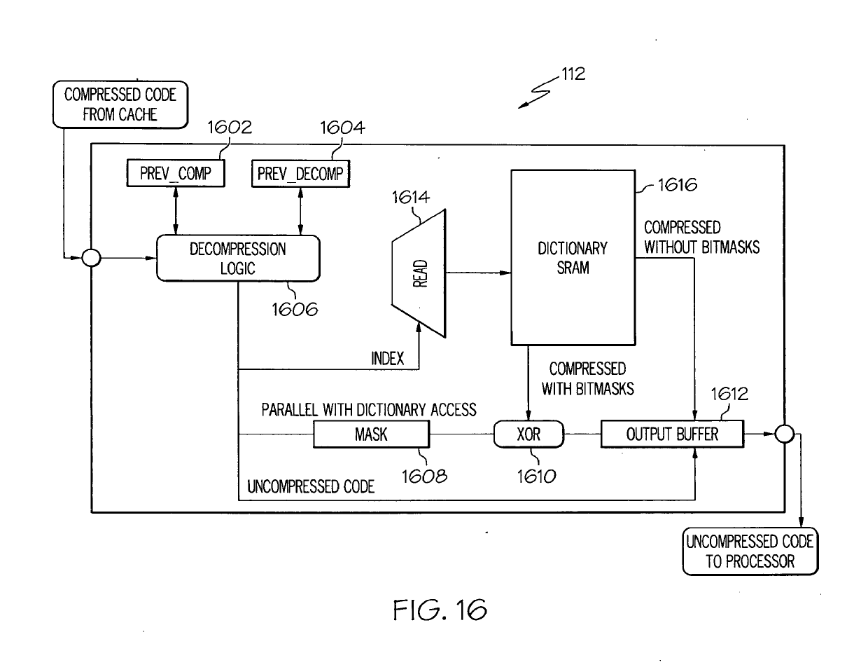

FIG. 16 shows one example of the bitmask-based decompression engine (“DCE”) 112. To expedite the decoding process, the DCE 112 is customized for efficiency, depending on the choice of bit-masks used. Using two 4-bit masks (Encoding 2 discussed above), the compression algorithm generates 4 different types of encodings: i) uncompressed instruction, ii) compressed without bitmasks, iii) compressed with one 4-bit mask, and iv) compressed with two 4-bit masks. In the same manner, using one bitmask creates only 3 different types of encodings. Decoding of uncompressed or compressed code without bitmasks remains virtually identical to the previous approach.

FIG. 16 shows that the DCE 112 includes prev_comp and prev_decomp registers 1602, 1604, a decompression logic module 1606, a masking module 1608, an XOR module 1610, an output buffer 1612, a Read module 1614, and a dictionary (SRAM) 1616. The prev_comp 1602 holds remaining compressed data from the previous cycle, since not all of 32 bits belong to the currently-decoded instructions. The prev_decomp 1604 holds uncompressed data from the previous cycle. This is needed, for instance, when the DCE 112 decompresses more than 32 bits in a cycle (two or more original instructions were compressed in a 32-bit code). The stored (uncompressed data) is sent to the CPU in the next cycle.

The DCE 112 provides two additional operations: generating an instruction-length (32-bit) mask via the mask module 1108 and XORing the mask and the dictionary entry via the XOR module 1610. The creation of an instruction-length mask is straightforward as done by applying the bitmask on the specified position in the encoding. For example, a 4-bit mask can be applied only on half-byte boundaries (8 locations). If two bitmasks were used, the two intermediate instruction length masks need to be ORed to generate one single mask. The advantage of the bitmask-based DCE 112 is that generating an instruction length mask can be done in parallel with accessing the dictionary, therefore generating a 32-bit mask does not add any additional penalty to the existing DCE.

The only additional time incurred by the bitmask-based DCE 112, as compared to the previous one-cycle design, is in the last stage where the dictionary entry and the generated 32-bit mask are XORed. The commercially manufactured XOR logic gates have been surveyed and found that many of the manufactures produce XOR gates with the propagation delay ranging from 0.09 ns-0.5 ns, numerous under 0.25 ns. The critical path of decompression data stream in Lekatsas and Wolf, H. Lekatsas and W. Wolf, “SAMC: A code compression algorithm for embedded processors,” IEEE Transactions on Computer-Aided Design of Integrated Circuits and Systems, vol. 18, no. 12, pp. 1689-1701, December 1999, which is hereby incorporated by reference in its entirety, was 5.99 ns (with the clock cycle of 8.5 ns). Additional 0.25 ns to 5.99 ns satisfies the 8.5 ns clock cycle constraint.

In addition, the bitmask-based DCE 112 can decode more than one instruction in one cycle (even up to three instructions with hardware support). In dictionary-based code compression, approximately 50% of instructions match with each other (without using bitmasks or hamming distance), M. Ros and P. Sutton, “A post-compilation register re-assignment technique for improving hamming distance code compression, in Proceedings of Compilers, Architectures, Synthesis for Embedded Systems (CASES), 2005, pp. 97-104, which is hereby incorporated by reference in its entirety. The various embodiments of the present invention captures an additional 15-25% using one bitmask, and up to 15-25% more using two bitmasks. Therefore only about 5-10% of the original program remains uncompressed.

If the codeword (with the dictionary index) is 10 bits, the encoding of instructions compressed only using the dictionary will be 12 bits or less. An instruction compressed with one 4-bit mask has the cost of additional 7 bits (total 18-19 bits). Therefore a 32-bit stream with any combination with a 12-bit code contains more than one instruction and can be decoded simultaneously. The best case is when a 32-bit stream contains two 12 bit encodings and prev_comp 1102 holds remaining 4 bits, the DCE engine has three instructions in hand that can be decoded concurrently.

The decompression unit, as well as the dictionary (SRAM) 1616, consumes memory space. However, the computation of the compression ratio includes the space required for the dictionary 1616. Therefore, when 40% code compression (60% compression ratio) is reported, it already accounted for the area occupied by the dictionary 1616. However, the decompression unit area is not accounted in the calculation. Although the size of the decompression unit (excluding dictionary size) can vary based on number of bitmasks, etc., but it ranges from 5-10K gates. However, the savings due to code compression is significantly higher than the area overhead of the decompression hardware. For example, an MPEGII encoder has initial size of 110 Kbytes which can be reduced to 60 Kbytes. Therefore, a 64 Kbyte memory is sufficient instead of a 128 Kbyte memory.

In terms of power requirement, the bitmask-based DCE 112, in one embodiment, requires on an average 2 mW. A typical SOC requires several hundred mW power. As shown by Lekatsas et al., H. Lekatsas and W. Wolf, “SAMC: A code compression algorithm for embedded processors,” IEEE Transactions on Computer-Aided Design of Integrated Circuits and Systems, vol. 18, no. 12, pp. 1689-1701, December 1999, which is hereby incorporated by reference in its entirety, that 50% code compression can lead to 22-80% energy reduction due to performance improvement and memory size reduction. Therefore, the power overhead of the decompression hardware is negligible.

### Operational Flow for Code Compression Process

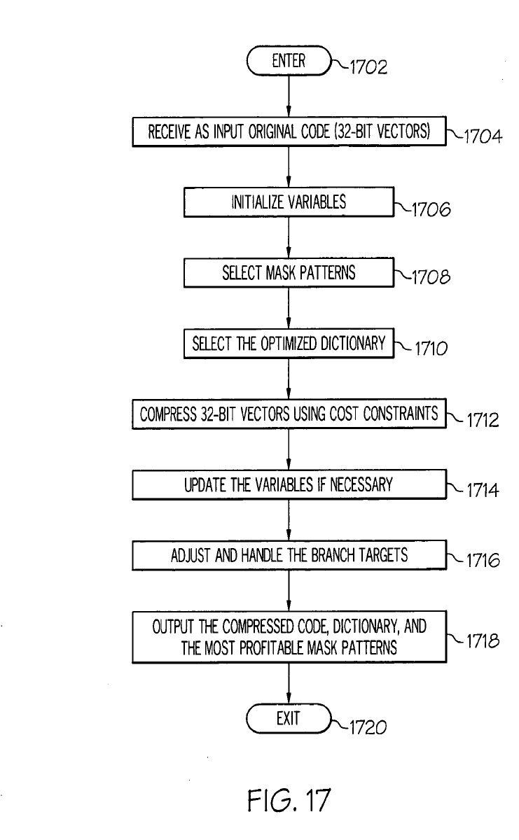

FIG. 17 is an operational flow diagram illustrating a general process for performing the bit-mask based code compression technique according to one embodiment of the present invention. The operational flow begins at step 1702 and flows directly into step 1704. The code compression engine 110, at step 1704, receives an input original code in a binary format and divides the original code into 32-bit vectors. The code compression engine 110, at step 1706, creates the frequency distribution of the vectors. The code compression engine 110 considers two types of information to compute the frequency: repeating sequences and possible repeating sequences by bitmasks. First, the code compression engine 110 finds the repeating 32-bit sequences and the number of repetition determines the frequency.

The code compression engine 110, at step 1708, selects the smallest possible dictionary size without significantly affecting the compression ratio. The code compression engine 110, at step 1710, converts each 32-bit vector into compressed code (when possible) using the format shown in FIG. 6. The code compression engine 110, at step 1712, adjusts branch targets. The code compression engine 110, at step 1714, the outputs the compressed code and dictionary. The control flow e17its at step 1716.

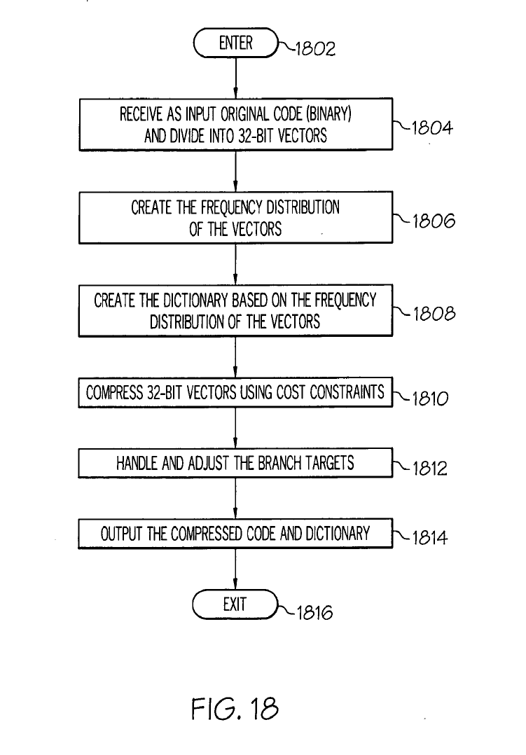

FIG. 18 is an operational flow diagram illustrating one process for selecting a dictionary based on bit-saving according to one embodiment of the present invention. The operational flow diagram of FIG. 18 beings at step 1802 and continues directly to step 1804. The code compression engine 110, at step 1804, takes 32-bit vectors, mask patterns, and a threshold value as input and The code compression engine 110, at step 1806, creates a graph where the nodes are the unique 32-bit vectors. An edge is created between two nodes if they can be matched using a bit-mask pattern(s), code compression engine 110, at step 1808, allocates bit savings to the nodes and edges. In one embodiment, frequency determines the bit savings of the node and mask is used to determine the bit savings by that edge. Once the bit-savings are assigned to all nodes and edges, the code compression engine 110, at step 1810, computes the overall savings for each node. The overall savings is obtained by adding the savings in each edge (bitmask savings) connected to that node along with the node savings (based on the frequency value).

The code compression engine 110, at step 1812, selects the node with the ma18imum overall savings as an entry for the dictionary. The code compression engine 110, at step 1814, deletes the selected node from the graph. The code compression engine 110, at step 1816, determines for each node connected to the most profitable node if the profit of the connected node is less than a given threshold. If the result of this determination is positive, the code compression engine 110, at step 1818, removes the connected node from the graph. The control then flows to step 1820. If the result of this determination is negative, the control flows to step 1820.

The code compression engine 110, at step 1820, determines if the dictionary is full. If the result of this determination is negative, the control flow returns to step 1810. If the result of this determination is positive, the code compression engine 110, at step 1822, determines if the graph is empty. If the result of this determination is negative, the control flow returns to step 1810. If the result of this determination is positive, the code compression engine 110, at step 1824, outputs the dictionary. The control flow then e18its at step 1826.

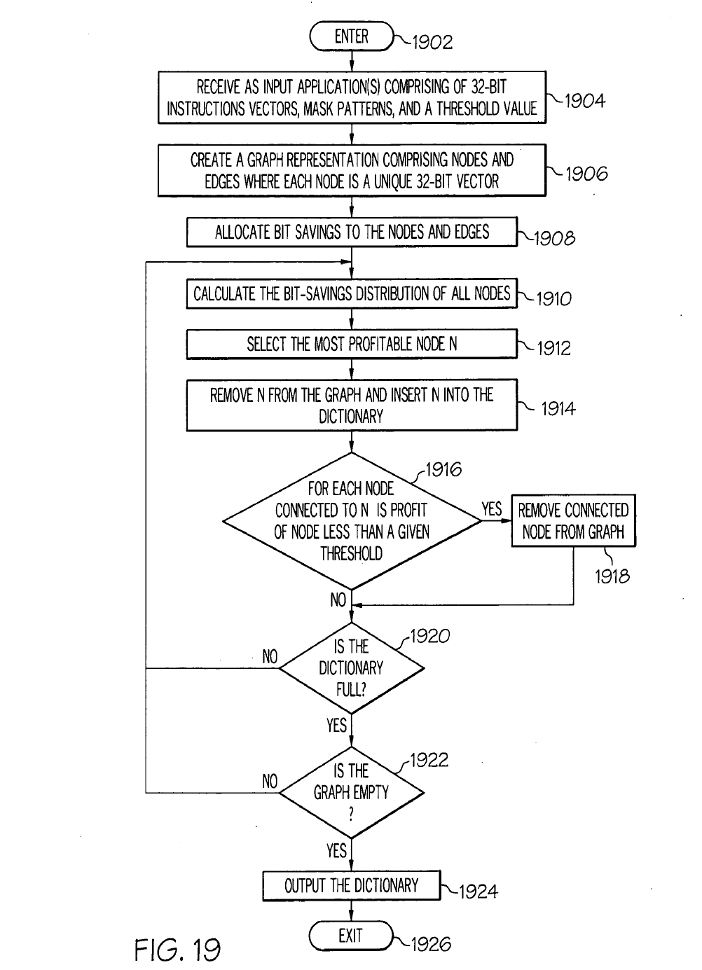

FIG. 19 is an operational flow diagram illustrating one process of the code compression technique of FIG. 17 implementing the bit-saving based dictionary selection process of FIG. 18 according to one embodiment of the present invention. The operational flow diagram of FIG. 19 beings at step 1902 and continues directly to step 1904. The code compression engine 110, at step 1904, receives as input an original code that is divided into 32-bit vectors. The code compression engine 110, at step 1906, initializes three variables: mask₁, mask₂, and CompressionRatio. The code compression engine 110, at step 1908, selects a pair of mask patterns from the reduced set of (1s, 2s, 2f, 4f) from Table IV above. The code compression engine 110, at step 1910, selects the optimized dictionary using the process discussed above with respect to FIGS. 12 and 18. The code compression engine 110, at step 1912, converts each 32-bit vector into compressed code (when possible). The code compression engine 110, at step 1914, updates the variables if necessary if the new compression ratio is better than the current one. The code compression engine 110, at step 1916, resolves the branch instruction problem by adjusting branch targets. The code compression engine 110, at step 1618 outputs the compressed code, optimized dictionary and two profitable mask patterns. The control flow then e19its at step 1920.

### Information Processing System

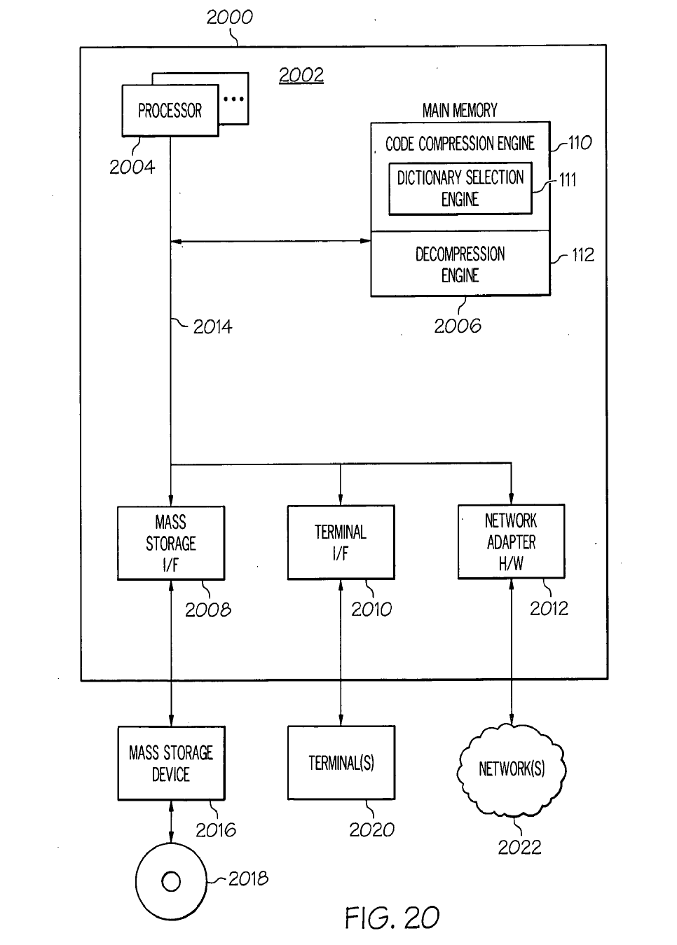

FIG. 20 is a block diagram illustrating a more detailed view of an information processing system 20 such as the information processing system 102 of FIG. 1 according to one embodiment of the present invention. The information processing system 2000 is based upon a suitably configured processing system adapted to implement the various embodiments of the present invention. Any suitably configured processing system is similarly able to be used as the information processing system 2000 by embodiments of the present invention such as an information processing system residing in the computing environment of FIG. 1, a personal computer, workstation, or the like.

The information processing system 2000 includes a computer 2002. The computer 2002 has a processor 2004 that is connected to a main memory 2006, mass storage interface 2008, terminal interface 2010, and network adapter hardware 2012. A system bus 2014 interconnects these system components. The mass storage interface 2008 is used to connect mass storage devices 2016 to the information processing system 2000. One specific type of data storage device is an optical drive such as a CD/DVD drive, which may be used to store data to and read data from a computer readable medium or storage product such as (but not limited to) a CD/DVD 2018. Another type of data storage device is a data storage device configured to support, for example, NTFS type file system operations.

The main memory 2006, in one embodiment, comprises the code compression engine 110 and dictionary selection engine 111, which can reside within the code compression engine 110 or outside thereof, and the decompression engine. Also, the code compression engine 110, the dictionary selection engine 111, and the decompression engine 112 can each be implemented as hardware as well. Although illustrated as concurrently resident in the main memory 2006, it is clear that respective components of the main memory 2006 are not required to be completely resident in the main memory 2006 at all times or even at the same time. In one embodiment, the information processing system 2000 utilizes conventional virtual addressing mechanisms to allow programs to behave as if they have access to a large, single storage entity, referred to herein as a computer system memory, instead of access to multiple, smaller storage entities such as the main memory 2006 and data storage 2016. Note that the term “computer system memory” is used herein to generically refer to the entire virtual memory of the information processing system 2000.

Although only one CPU 2004 is illustrated for computer 2002, computer systems with multiple CPUs can be used equally effectively. Embodiments of the present invention further incorporate interfaces that each includes separate, fully programmed microprocessors that are used to off-load processing from the CPU 2004. Terminal interface 2010 is used to directly connect one or more terminals 2020 to computer 2002 to provide a user interface to the computer 2002. These terminals 2020, which are able to be non-intelligent or fully programmable workstations, are used to allow system administrators and users to communicate with the information processing system 2000. The terminal 2020 is also able to consist of user interface and peripheral devices that are connected to computer 2002 and controlled by terminal interface hardware included in the terminal I/F 2010 that includes video adapters and interfaces for keyboards, pointing devices, and the like.

An operating system (not shown) included in the main memory is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 2000. The network adapter hardware 2012 is used to provide an interface to a network 2022. Embodiments of the present invention are able to be adapted to work with any data communications connections including present day analog and/or digital techniques or via a future networking mechanism.

Although the exemplary embodiments of the present invention are described in the contex0t of a fully functional computer system, those skilled in the art will appreciate that embodiments are capable of being distributed as a program product via CD or DVD, e.g. CD 218, CD ROM, or other form of recordable media, or via any type of electronic transmission mechanism.

### Experimental Data

The following discussion provides experimental results based on extensive code compression experiments that were performed by varying both application domains and target architectures. The benchmarks are collected from TI. Mediabench and MiBench benchmark suites: adpcm_en, adpcm_de, cjpeg, djpeg, gsm_to, gsm_un, hello, modem, mpeg2enc, mpeg2dec, pegwit, and vertibi. The benchmarks for three target architectures: TI TMS320C6x, MIPS, and SPARC were compiled. TI Code Composer Studio was used to generate binary for TI TMS320C6x, gcc was used to generate binary for MIPS and SPARC. The compression ratio was computed using the Equation (1) discussed above. The computation of compressed program size includes the size of the compressed code as well as the dictionary and the small mapping table.

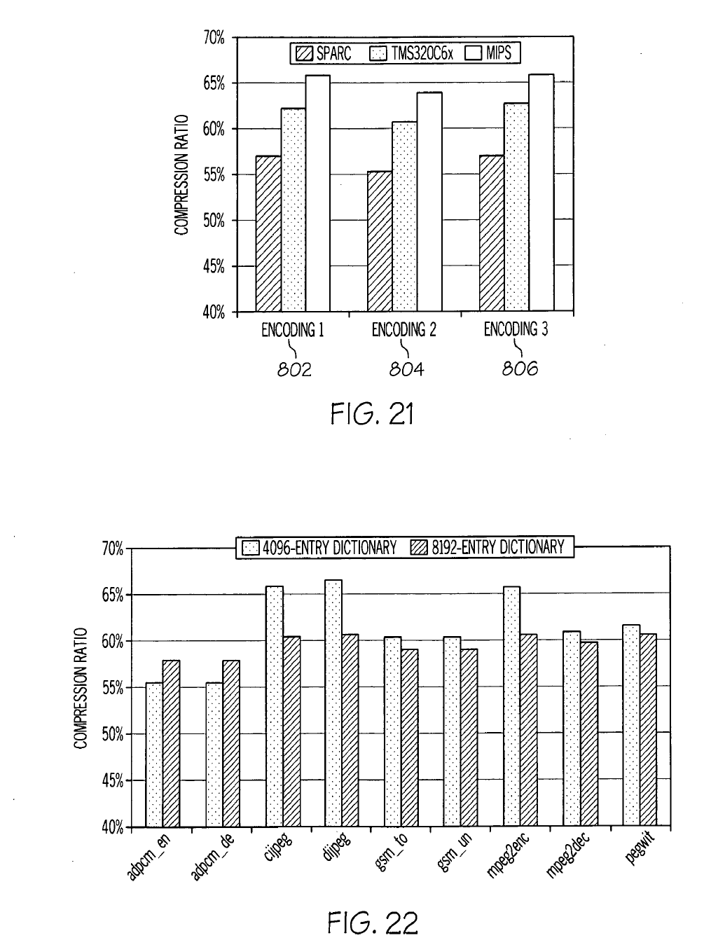

Generic encoding formats as well as three customized formats of the various embodiments of the present invention were discussed above with respect to FIG. 8. Encoding 1 uses one 8-bit mask, Encoding 2 uses up to two 4-bit masks, and Encoding 3 uses 4-bit and 8-bit masks. FIG. 21 shows the performance of each of these encoding formats using adpcm_en benchmark for three target architectures. An 11-bit codeword was used for these experiments. A dictionary with 2000 entries was used for these experiments. Clearly, the second encoding format performs the best by generating a compression ratio of 55-65%.

FIG. 22 shows the efficiency of the code compression technique of the various embodiments of the present invention for all benchmarks compiled for SPARC using dictionary sizes of 4K and 8K entries. Encoding 2 was used to compress the benchmarks. As expected, three scenarios can be observed. The small benchmarks such as adpcm_en and adpcm_de perform better with a small dictionary since a majority of the repeating patterns fits in the 4K dictionary. On the other hand, the large benchmarks such as cjpeg, djpeg, and mpeg2enc benefit the most from the larger dictionary. The medium sized benchmarks such as mpeg2dec and pegwit do not benefit much from the bigger dictionary size.

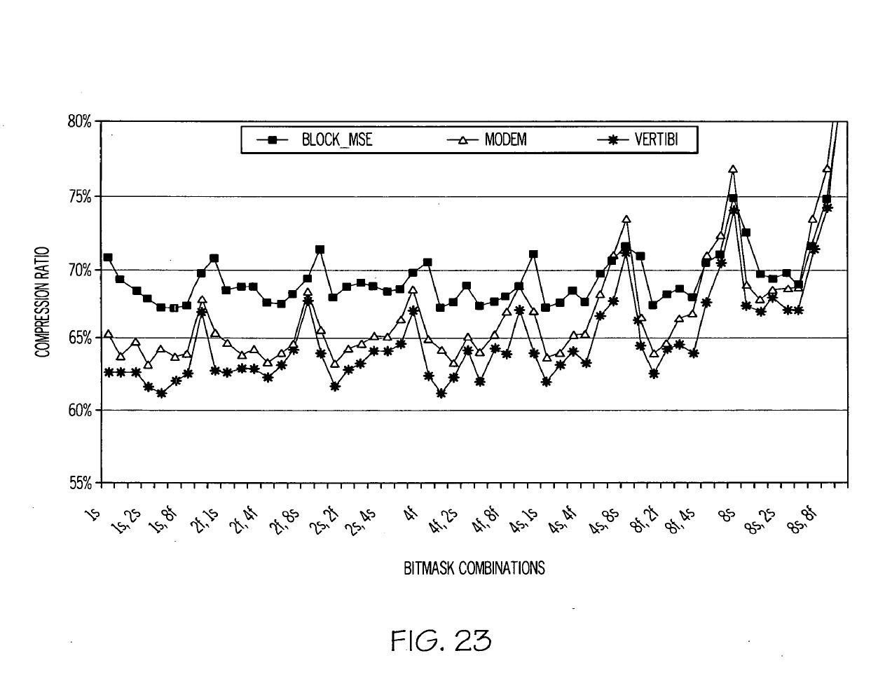

Experiments were performed by varying both mask combinations and dictionary selection methods. FIG. 23 shows compression ratios of three TI benchmarks (blockmse, modem, and vertibi) compressed using all 56 different mask set combinations from {1s, 2f, 2s, 4f, 4s, 8f, 8s}) i.e. in order of (1s), (1s,2f), (1s,2s), (1s,4f), (1s,4s), (1s,8f), (1s,8s), (2s) . . . both one-mask and two-mask combinations. As discussed, 8-bit mask patterns (fixed or sliding) do not provide good compression ratio. In general, compressing with two masks achieves a better compression ratio than using just one. Note that the compression ratios for three benchmarks follow a regular pattern. A similar pattern exists even with other benchmarks. It confirms the analysis given above that a small set of mask patterns is sufficient to achieve good compression. Overall, it was found that the combination of 4-bit fixed and 1-bit sliding or two 2-bit patterns provides the best compression.

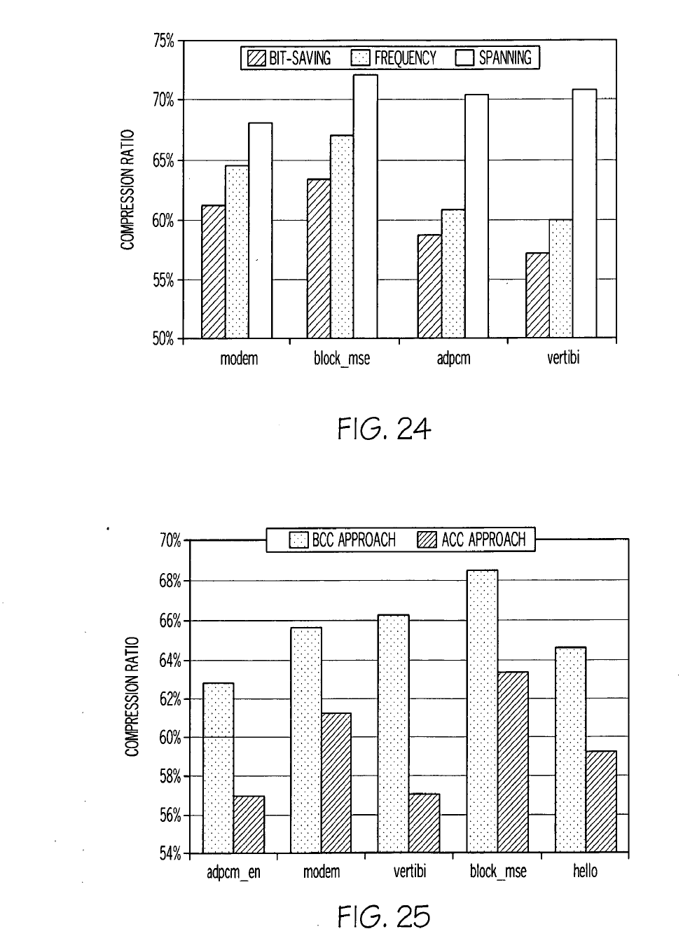

FIG. 24 compares compression ratios achieved by the various dictionary selection methods discussed above. The dictionary size was restricted to increase the distinction among three methods: frequency, spanning, and the BCC technique of the various embodiments of the present invention. As shown in FIG. 24, the spanning-based approach is the worst compared to other dictionary selection methods. The bit-savings based approach of the various embodiments of the present invention outperforms all the existing dictionary selection methods on all benchmarks.

FIG. 25 compares the compression ratios between the bitmask-based code compression (“BCC”) technique and the application-specific code compression framework (“ACC”). In BCC technique (as discussed in S. Seong and P. Mishra, “A bitmask-based code compression technique for embedded systems,” in Proceedings of International Conference on Computer-Aided Design (ICCAD), 2006, which is hereby incorporated by reference in its entirety), experiments were performed with customized encodings of 4-bit and 8-bit mask combinations. In application-specific approach, S. Seong and P. Mishra, “An efficient code compression technique using application-aware bitmark and dictionary selection methods,” in Proceedings of Design Automation and Test in Europe (DATE), 2007, which is hereby incorporated by reference in its entirety, the most profitable mask pairs were computed and the bit-saving based dictionary selection of the various embodiments of the present invention was applied to improve the compression ratio further. For example, a 57% compression ratio for adpcm_en benchmark was obtained using 4-bit fixed and 1-bit sliding patterns that outperforms the BCC approach by 6%. As expected, application-specific approach outperforms the bitmask-based technique by 5-10%.

Table V below compares the code compression technique of the various embodiments of the present invention with the existing code compression techniques. The code compression technique of the various embodiments of the present invention improves the code compression efficiency by 20% compared to the existing dictionary based techniques, J. Prakash, C. Sandeep, P. Shankar and Y. Srikant, “A simple and fast scheme for code compression for VLIW processors,” in Proceedings of Data Compression Conference (DCC), 2003, p. 444, and M. Ros and P. Sutton, “A hamming distance based VLIW/EPIC code compression technique,” in Proceedings of Compliers. Architectures, Synthesis for Embedded Systems (CASES), 2004, pp. 132-139, which is hereby incorporated by reference in its entirety. It is important to note that all the work mentioned in Table V did not use exactly the same setup. In fact, in some of them the detailed setup information is not available except the information regarding the architecture and the average compression ratio. However, majority of them (including all the recent researches in this area) used popular embedded systems benchmark applications from mediabench, mibench and TI benchmark suite compiled for various architectures.

The same application binary was obtained that was used by Lekatsas et al., H. Lekatsas and W. Wolf, “SAMC: A code compression algorithm for embedded processors,” IEEE Transactions on Computer-Aided Design of Integrated Circuits and Systems, vol. 18, no. 12, pp. 1689-1701, December 1999, which is hereby incorporated by reference in its entirety. In other words, a best effort was put forth to obtain a fair comparison. The compression efficiency of the code compression technique of the various embodiments of the present invention is comparable to the state-of-the-art compression techniques (IBM CodePack, CodePack PowerPC Code Compression Utility User's Manual. Version 3.0, http://www.ibm.com, 1998, which is hereby incorporated by reference in its entirety and SAMC, H. Lekatsas and W. Wolf, “SAMC: A code compression algorithm for embedded processors,” IEEE Transactions on Computer-Aided Design of Integrated Circuits and Systems, vol. 18, no. 12, pp. 1689-1701, December 1999, which is hereby incorporated by reference in its entirety). However, due to the encoding complexity, the decompression bandwidth of those techniques are only 6-8 bits. As a result, they cannot support one instruction per cycle decompression and it is not possible to place the DCE between the cache and the processor to take advantage of the post-cache design (FIG. 15.). Moreover, those techniques do not support parallel decompression, therefore are not suitable for VLIW architectures. The DCE 112 of the various embodiments of the present inventions supports one instruction per cycle delivery as well as parallel decompression.

TABLE V
COMPARISON WITH VARIOUS COMPRESSION SCHEMES

| | | | |
|---|---|---|---|
| Compression | Target | Compression | Decompression |
| Method | Architecture | Ratio* | Bandwidth |

| Wolfe [5] | MIPS | 73% | 8 | bits |
|---|---|---|---|---|
| IBM [21] | PowerPC | 60% | 8 | bits |
| CodePack | | | | |
| SAMC [6] | MIPS | 57% | 6-8 | bits |
| V2F [14] | TMS320C6x | 70-82% | 4.9-13 | bits |
| MCSSC [15] | TMS320C6X | 75% | 14.5-64 | bits |
| Prakash [3] | TMS320C6x | 76-80% | N/A | |
| Ros [4] | Itanium | 72-82% | N/A | |
| | TMS320C6x | | | |
| Our | MIPS, SPARC | 55-65% | 32-64 | bits |
| Approach | TMS320C6X | | | |

*Smaller compression ratio implies better compression technique.

This code size reduction can contribute not only to cost, area, and energy savings but also to performance of the embedded system. The application-specific bitmask code compression framework, S. Seong and P. Mishra, “An efficient code compression technique using application-aware bitmark and dictionary selection methods,” in Proceedings of Design Automation and Test in Europe (DATE), 2007, which is hereby incorporated by reference in its entirety, due to the nature of the mask and dictionary selection procedures, incurs higher encoding/compression overhead than the bitmask-based code compression approach (BCC), S. Seong and P. Mishra. “A bitmask-based code compression technique for embedded systems,” in Proceedings of International Conference on Computer-Aided Design (ICCAD), 2006, which is hereby incorporated by reference in its entirety. However, in embedded systems design using code compression, encoding is performed once and millions of copies are manufactured. Any reduction of cost, area, or energy requirements is extremely important. Moreover, the various embodiments of the present invention such as (BCC or ACC) do not introduce any decompression penalty.

As can be seen, embedded systems are constrained by the memory size. Code compression techniques address this problem by reducing the code size of the application programs. Dictionary-based code compression techniques are popular since they generate a good compression ratio by exploiting the code repetitions. Recent techniques uses bit toggle information to create matching patterns and thereby improve the compression ratio. However, due to lack of an efficient matching scheme, the existing techniques can match up to three bit differences.

The various embodiments of the present invention utilize a matching scheme that uses bitmasks that can significantly improve the code compression efficiency. To address the challenges discussed above, the various embodiments of the present invention utilize application-specific bitmask selection and bitmask-aware dictionary selection processes. The efficient code compression technique of the various embodiments of the present invention uses these processes to improve the code compression ratio without introducing any decompression overhead.

The code compression technique of the various embodiments of the present invention reduces the original program size by at least 45%. This technique outperforms all the existing dictionary-based techniques by at least an average of 20%, giving compression ratios of at least 55%-65%. The DCE of the various embodiments of the present invention is capable of decoding an instruction per cycle as well as performing parallel decompression.

There are two alternative ways to employ bitmask-based code compression: i) compressing with the simple frequency-based dictionary selection and pre-customized (selected) encodings, or ii) compressing with the application-specific bitmask and dictionary selections. Clearly, the first approach is faster than the second one but it may not generate the best possible compression. This option is useful for early exploration and prototyping purposes. The second option is time consuming, but is useful for the final system design since encoding (compression) is performed only once and millions of copies are manufactured. Therefore, any reduction in cost, area, or energy requirements is extremely important during embedded systems design.

Currently, the code compression technique of the various embodiments of the present invention can generate up to at least 95% matching sequences. In other embodiments, more matches with fewer bits (cost) can be obtained. One possible direction is to introduce the compiler optimizations that use hamming distance as a cost measure for generating code. The above discussion used bitmask-based compression for reducing the code size in embedded systems. This technique can also be applied in other domains where dictionary-based compression is used. For example, dictionary-based test data compression, L. Li and K. Chakrabarty and N. Touba, “Test data compression using dictionaries with selective entries and fixed-length indices,” ACM Transactions on Design Automation of Electronic Systems (TODAES), vol. 8(4), pp. 470-490, October 2003, which is hereby incorporated by reference in its entirety, is used in manufacturing test domain for reducing the test data volume in System-on-Chip (SOC) designs. This method is based on the use of a small number of channels to deliver compressed test patterns from the tester to the chip and to drive a large number of internal scan chains in the circuit under test. Therefore, it is especially suitable for a reduced pin-count and low cost test environment, where a narrow interface between the tester and the SOC is desirable. The dictionary-based approach not only reduces test data volume but it also eliminates the need for additional synchronization and handshaking between the SOC and the ATE (automatic test equipment). The required pin count and overall cost can be further reduced by employing the bitmask-based compression technique. Additional applications include bitmask-based technique for test data compression.

### Other Embodiments

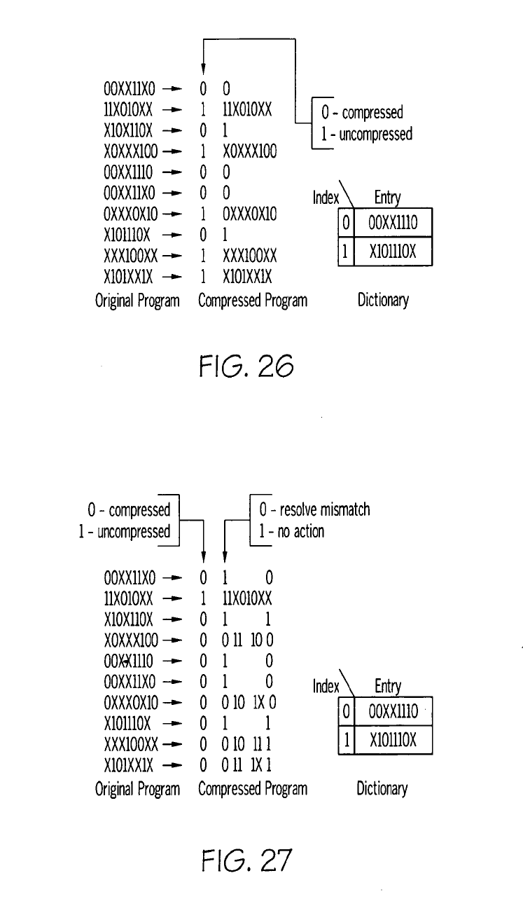

The bitmask-based code compression (“BCC”) technique of the various embodiments of the present invention can also be used to efficiently compress test data. Consider a test data set of 8-bit entries. The total number of entries is 10. Therefore, the total test set is of 80 bits. FIG. 26 shows the data set as well as the compressed data set under the application of dictionary based compression. In this case, the dictionary has 2 entries, each of 8-bits length. Each repeating pattern is replaced with a dictionary index, (In this example, an index of 0 refers to the first dictionary entry and an index of 1 refers to the second one.) The final compressed test data set is reduced to 55 bits and the dictionary requires 16 bits. Thus, the compression ratio obtained is 68.75%. FIG. 27 shows an example of compressing the data used in FIG. 26 using an application of the BCC technique discussed above. A 2-bit mask was used only on quarter-byte boundaries. It is seen that such a mask is able to create 90% matching patterns. The compression ratio is found to be 65%, which is better than the dictionary based compression method shown with respect to FIG. 26.

Once the total test data is obtained, the test data is divided into scan chains of pre-determined length. This is dividing process is performed accordance with the method prescribed by Li et al in L. Li, K. Chakrabarty and N. Touba. Test data compression using dictionaries with selective entries and fixed-length indices. ACM Transactions on Design Automation of Electronic Systems (TODAES), 8(4): 470-490, October 2003, which is hereby incorporated by reference in its entirety. Assume that the test data T_{D} consists of n test patterns. In one embodiment, the uncompressed data is chosen to be a group of m-bit words. In this embodiment, the scan elements are divided into m-scan chains in the best balanced manner possible. This results in each vector being divided into m sub-vectors. Dissimilarity in the lengths of the sub-vectors are resolved by padding “don't cares” to the end of the shorter sub-vectors. Thus, all the sub-vectors are of equal length, which is denoted by l. The m-bit data which is present at the same position of each sub-vector constitute an m-bit word. Thus, a total of n×l m-bit words is obtained, which is the uncompressed data set that needs to be compressed.

The following shows how two 4-bit words are obtained from a 8-bit long test pattern:

$$\begin{matrix}01 \; 1 X X 0 \; 11 \to & 01 X 1 \to Word 1 \\ & 1 X 01 \to Word 2\end{matrix} \qquad \{ \qquad$$

In this example, m=4 and l=2. It is to be noted that since the words were balanced, padding of “don't cares” was not necessary here.

With respect to mask selection, a compressed code stores information regarding the mask type, mask location and the mask pattern itself. The mask can be applied on different places on a vector and the number of bits required for indicating the position varies depending on the mask type. For instance, consider a 32-bit vector, an 8-bit mask applied on only byte boundaries requires 2-bits, since it can be applied on four locations. If the placement of the mask is not restricted, the mask will require 5 bits to indicate any starting position on a 32-bit vector.

Bitmasks may be sliding or fixed. A fixed bit mask always operates on half-byte boundaries while a sliding bitmask can operate anywhere in the data. It is obvious that generally sliding bitmasks require more bits to represent themselves compared to fixed bitmasks. The notation ‘s’ and ‘f’ is used to represent sliding and fixed bitmasks, respectively. As shown by Seong et al. in Seok-Won Seong and Prabhat Mishra. An Efficient code compression technique using application aware bitmask and dictionary selection methods. In Proceedings of Design, Automation and Test in Europe (DATE), 2007, which is hereby incorporated by reference in its entirety, the optimum bitmasks to be selected for code compression are 2s, 2f, 4s and 4f. However, in the case of test data compression, the last two need not be considered. This is because as per Lemma 1 shown below, the probability that 4 corresponding contiguous bits will differ in a set of test data is only 0.02%, which can easily be neglected. Thus, the BCC compression is performed by using only 2s and 2f bitmasks. The number of masks selected depends on the word length and the dictionary entries and is found out using Lemma 2, which is also shown below.

Lemma 1: The probability that 4 corresponding contiguous bits differ in two test data is 0.2%.

Proof: For two corresponding bits to differ in a set of test data, none of the bits should be “don't cares”. Consider the scenario in which bits really differ and the probability of such an event. One can see that any position in a test data can be occupied by 3 different symbols, 0, 1 and X. However, as already mentioned, to differ, the positions should be filled up with 0 or 1. Hence, the probability that a certain portion is occupied by either 0 or 1 is ⅔=0.67. Therefore, the probability that all the four positions have either 0 or 1 is P1=(0.67)⁴=0.20.

For the other vector, the same rule applies. The additional constraint here is that the bits in the corresponding positions are fixed due to difference in the two vectors, that is, the bits in the second vector has to be exact complement of those of the first vector. Therefore, the probability of occupancy of a single position is ⅓=0.33. Therefore, the probability of 4 mismatches in the second vector=P₂=(0.33)⁴=0.01. The cumulative probability of the 4-bit mismatch is a product of the two probabilities P₁ and P₂ and is given by: P=P₁×P₂=0.2%

Lemma 2: The number of masks used is dependent on the word length and dictionary entries.

Proof: Let L be the number of dictionary entries and N be the word length. If y is the number of masks allowed, then in the worst case (when all the masks are 2s), the number of bits required is,

$$no\_bits = 2 + log ( L ) + \frac{log ( y )}{log ( 2 )} + yX ( 2 + ( \frac{log ( N )}{log ( 2 )} ) )$$

and this should be less than N. The first two bits are required to check whether the data is compressed or not, and if compressed, mask is used or not. So, the maximum number of bitmasks allowed is

$$y = \frac{N - 2 - log ( L )}{2 + \frac{log ( N )}{log ( 2 )}} - \frac{\frac{log ( y )}{log ( 2 )}}{2 + \frac{log ( N )}{log ( 2 )}}$$

One can see that it is not easy to compute y from here since both sides of the equation contain y related terms. To ease the calculation, the y-related term on the right hand side of the equation can be replaced with a constant. It is to be noted that since y<N, a safe measure is to use 1 as this constant. Therefore, the final equation for y is:

$$y = ( \frac{N - 2 - log ( L )}{2 + \frac{log ( N )}{log ( 2 )}} - 1 ) ,$$

floored to the nearest integer.

The dictionary selection algorithm is a critical part in bitmask based code compression. The dictionary selection algorithm for compressing test data, in one embodiment, is a two-step process. The first step is similar to that discussed in L. Li, K. Chakrabarty and N. Touba. Test data compression using dictionaries with selective entries and fixed-length indices. ACM Transactions on Design Automation of Electronic Systems (TODAES), 8(4): 470-490, October 2003, which is hereby incorporated by reference in its entirety. The dictionary selection method used for compressing test data uses, in one embodiment, the classical clique partitioning algorithm of graph theory. A graph G is drawn with n×l nodes, where each node signifies a m-bit test word. Compatibility between the words is then determined. Two words are said to be compatible if for a particular position, the corresponding characters in the two words are either equal or one of them is a “don't care”. If two nodes are mutually compatible, an edge is drawn between them. Cliques are now selected from this set. The clique-partitioning algorithm according to one embodiment of the present invention is as follows:
1. Copy the graph G to a temporary data structure G′.
2. The vertex in G′ which has the maximum number of edges is selected. The vertex is denoted by v.
3. A subgraph is created that contains all the vertices connected to v.
4. This subgraph is copied to G′ and v is added to a set C.
5. If (G′==NULL), the clique C has been formed, else go to step 2.
6. G=G−C
7. If (G==0) STOP, else go to Step 1.

At this point, two possibilities may arise. (1) there is a predefined number as to the count of the dictionary entries; and (2) the number of cliques selected may be greater than that or vice versa. In the latter case, the dictionary entries just need to be filled in with those obtained from clique partitioning.

However, if the number of cliques is larger, the best dictionary entries are selected out of them. To accomplish this, the following steps, in one embodiment, are performed:
1. For each entry, calculate the number of bits saved over the entire data set by compression if that entry was present in the dictionary. The number of bits saved should account those due to bitmask based compression as well.
2. For each entry in the dataset, choose the dictionary entry which gives the maximum compression. If two entries give the same compression, the one which has the maximum saved bits over the entire dataset is given preference. For all the other dictionary entries, the bit savings are deducted. This step is used to prevent aliasing.
3. Sort the dictionary entries in descending order of bits saved.
4. If the dictionary was predefined to have L entries, choose the best L dictionary entries.

The following example shows the dictionary selection algorithm discussed above. Table VI below shows the different data sets that were taken into consideration. As seen, there are 16 sets of data, each of 8-bits.

TABLE VI

| Data Set | Entry |
|---|---|
| 1 | 11X001XX |
| 2 | 01X00X1X |
| 3 | 1101XXX1 |
| 4 | 01X01X1X |
| 5 | XX10001X |
| 6 | X110X0XX |
| 7 | 0101XX1X |
| 8 | 0X00X110 |
| 9 | 0XX0X10X |
| 10 | 1X11X01X |
| 11 | 1XX10001 |
| 12 | X1X0XX11 |
| 13 | 11X000XX |
| 14 | 01XX0110 |
| 15 | 010X0X01 |
| 16 | 1XXX0011 |

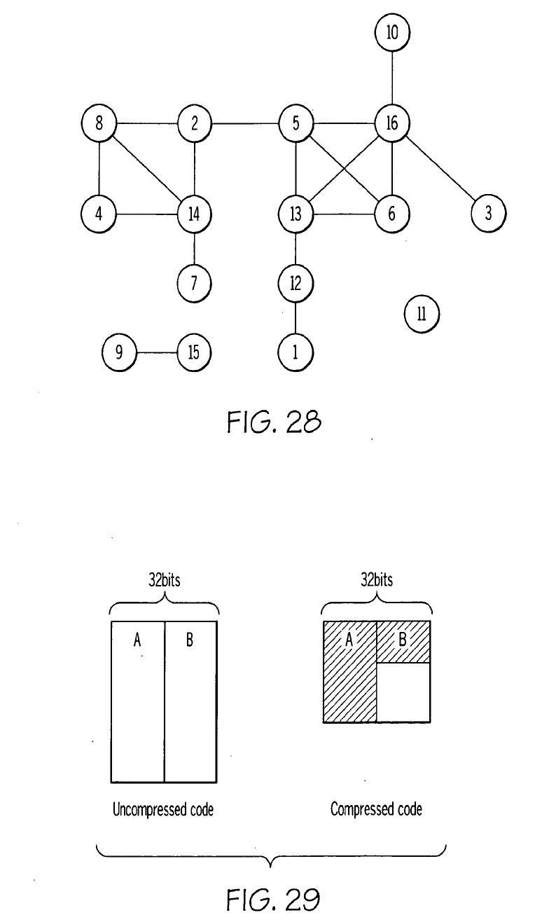

The dictionary is determined by performing the clique partitioning algorithm. The graph drawn for this purpose is shown in FIG. 28. The cliques selected in this case are {5, 6, 13, 16} and {2, 8, 14}. The dictionary entries obtained are {11100011, 01000110}. The original data was of 128 bits. The data when compressed using ordinary dictionary selection algorithm as proposed by Li et al in L. Li, K. Chakrabarty and N. Touba. Test data compression using dictionaries with selective entries and fixed-length indices. ACM Transactions on Design Automation of Electronic Systems (TODAES), 8(4): 470-490, October 2003, which is hereby incorporated by reference in its entirety, was of 95 bits, which corresponds to a compression ratio of 74.21%. However, when it is compressed using bitmask based compression, using 2-bit fixed bitmask, the compressed data obtained is of 86 bits, which corresponds to a compression ratio of 67.19%, thus providing a significant advantage in compression.

As can be seen, the code compression technique using dictionary and bitmask based code compression discussed above can reduce the memory and time requirements experienced with respect to test data. The various embodiments of the present invention provide an efficient bitmask selection technique for test data in order to create maximum matching patterns. The various embodiments of the present invention also provide efficient dictionary selection method which takes into account the speculated results of compressed codes.

The various embodiments of the present invention are also applicable to efficient placement of compressed code for parallel decompression. Code compression is important in embedded systems design since it reduces the code size (memory requirement) and thereby improves overall area, power and performance. Existing researches in this field have explored two directions: efficient compression with slow decompression, or fast decompression at the cost of compression efficiency. The following embodiment(s) combines the advantages of both approaches by introducing a novel bitstream placement method. The following embodiment is a novel code placement technique to enable parallel decompression without sacrificing the compression efficiency. The proposed technique splits a single bitstream (instruction binary) fetched from memory into multiple bitstreams, which are then fed into different decoders. As a result, multiple slow-decoders can work simultaneously to produce the effect of high decode bandwidth. Experimental results demonstrate that this approach can improve decode bandwidth up to four times with minor impact (less than 1%) on compression efficiency.

Memory is one of the most constrained resources in an embedded system, because a larger memory implies increased area (cost) and higher power/energy requirements. Due to dramatic complexity growth of embedded applications, it is necessary to use larger memories in today's embedded systems to store application binaries. Code compression techniques address this problem by reducing the storage requirement of applications by compressing the application binaries. The compressed binaries are loaded into the main memory, then decoded by a decompression hardware before its execution in a processor. Compression ratio is widely used as a metric of the efficiency of code compression. It is defined as the ratio (CR) between the compressed program size (CS) and the original program size (OS) i.e., CR=CS/OS. Therefore, a smaller compression ratio implies a better compression technique. There are two major challenges in code compression: i) how to compress the code as much as possible; and ii) how to efficiently decompress the code without affecting the processor performance.

The research in this area can be divided into two categories based on whether it primarily addresses the compression or decompression challenges. The first category tries to improve code compression efficiency using the state-of-the-art coding methods such as Huffman coding (See A. Wolfe and A. Chanin, “Executing compressed programs on an embedded RISC architecture,” MICRO 81-91, 1992, which is hereby incorporated by reference in its entirety) and arithmetic coding (See H. Lekatsas and Wayne Wolf, “SAMC: A code compression algorithm for embedded processors,” IEEE Trans. on CAD, 18(12), 1689-1701, 1999, which is hereby incorporated by reference in its entirety). Theoretically, they can decrease the compression ratio to its lower bound governed by the intrinsic entropy of code, although their decode bandwidth usually is limited to 6-8 bits per cycle. These sophisticated methods are suitable when the decompression unit is placed between the main memory and cache (pre-cache). However, recent research such as H. Lekatsas, J. Henkel and W. Wolf, “Code compression for low power embedded system design,” DAC, 294-299, 2000, which is hereby incorporated by reference in its entirety, suggests that it is more profitable to place the decompression unit between the cache and the processor (post-cache). In this way the cache retains data still in a compressed form, increasing cache hits, therefore achieving potential performance gain. Unfortunately, this post-cache decompression unit actually demands much more decode bandwidth than what the first category of techniques can offer. This leads to the second category of research that focuses on higher decompression bandwidth by using relatively simple coding methods to ensure fast decoding. However, the efficiency of the compression result is compromised. The variable-to-fixed coding techniques (See, for example. Y. Xie, W. Wolf, H. Lekatsas, “Code compression for embedded VLIW processors using variable-to-fixed coding,” IEEE Trans. on VLSI, 14(5), 525-536, 2006, which is hereby incorporated by reference in its entirety) are suitable for parallel decompression but it sacrifices the compression efficiency due to fixed encoding.

The following embodiment combines the advantages of both approaches by developing a novel bitstream placement technique which enables parallel decompression without sacrificing the compression efficiency. The following embodiment is capable of increasing the decode bandwidth by using multiple decoders to work simultaneously to decode a single/adjacent instruction(s) and allows designers to use any existing compression algorithms including variable-length encodings with little or no impact on compression efficiency.

The basic idea of code compression for embedded systems is to take one or more instruction as a symbol and use common coding methods to compress the code. Wolfe and Chanin (A. Wolfe and A. Chanin, “Executing compressed programs on an embedded RISC architecture,” MICRO 81-91, 1992, which is hereby incorporated by reference in its entirety) first proposed the Huffman-coding based code compression approach. A Line Address Table (LAT) is used to handle the addressing of branching within compressed code. Lin et al. (C. Lin, Y. Xie, and W. Wolf, “LZW-based code compression for VLIW embedded systems,” DATE, 76-81, 2004, which is hereby incorporated by reference in its entirety) uses LZW-based code compression by applying it to variable-sized blocks of VLIW codes. Liao (S. Liao, S. Devadas, and K. Keutzer, “Code density optimization for embedded DSP processors using data compression techniques,” IEEE Trans. on CAD, 17(7), 601-608, 1998, which is hereby incorporated by reference in its entirety) explored dictionary-based compression techniques. Lekatsas et al. (H. Lekatsas and Wayne Wolf, “SAMC: A code compression algorithm for embedded processors,” IEEE Trans. on CAD, 18(12), 1689-1701, 1999, which is hereby incorporated by reference in its entirety) constructed SAMC using arithmetic coding based compression. These approaches significantly reduce the code size but their decode (decompression) bandwidth is limited.

To speed up the decode process, Prakash et al. (Prakash et al., “A simple and fast scheme for code compression for VLIW processors,” DCC, pp 444, 2003, which is hereby incorporated by reference in its entirety) and Ros et al. (M. Ros and P. Sutton, “A hamming distance based VLIW/EPIC code compression technique,” CASES, 132-139, 2004, which is hereby incorporated by reference in its entirety) improved conventional dictionary based techniques by considering bit changes of a 16-bit or 32-bit vectors. Seong et al. (S. Seong and P. Mishra, “Bitmask-based code compression for embedded systems,” IEEE Trans. on CAD, 27(4), 673-685, April 2008, which is hereby incorporated by reference in its entirety) further improved these approaches using bitmask based code compression. These techniques enable fast decompression but they achieve inferior compression efficiency compared to those based on well established coding theory. Instead of treating each instruction as a single symbol, some researchers observed that the number of different opcodes and operands are quite smaller than that of entire instructions.

Therefore, a division of a single instruction into different parts may lead to more effective compression. Nam et al. (Sang-Joon Nam, In-Cheol Park, and Chong-Min Kyung, “Improving dictionary-based code compression in VLIW architectures,” IEICE Trans. on FECCS, E82-A(11), 2318-2324, 1999, which is hereby incorporated by reference in its entirety) and Lekatsas et al. (H. Lekatsas and W. Wolf, “Code compression for embedded systems,” DAC, 516-521, 1998, which is hereby incorporated by reference in its entirety) broke instructions into several fields then employed different dictionary to encode them. CodePack (C. Lefurgy, Efficient Execution of Compressed Programs, Ph.D. Thesis, University of Michigan, 2000, which is hereby incorporated by reference in its entirety) divided each MIPS instruction at the center, applied two prefix dictionary to each of them, then combined the encoding results together to create the finial result. However, in their compressed code, all these fields are simply stored one after another (in a serial fashion). The variable-to-fixed coding technique (Y. Xie, W. Wolf, H. Lekatsas, “Code compression for embedded VLIW processors using variable-to-fixed coding,” IEEE Trans. on VLSI, 14(5), 525-536, 2006, which is hereby incorporated by reference in its entirety) is suitable for parallel decompression but it sacrifices the compression efficiency due to fixed encoding. The variable size encodings (fixed-to-variable and variable-to-variable) can achieve the best possible compression. However, it is impossible to use multiple decoders to decode each part of the same instruction simultaneously, when variable length coding is used. The reason is that the beginning of next field is unknown until the decode of the current field ends. As a result, the decode bandwidth cannot benefit very much from such an instruction division. The various embodiments of the present invention allows variable length encoding for efficient compression and proposes a novel placement of compressed code to enable parallel decompression.

The efficient placement of compressed code for parallel decompression embodiment is motivated by previous variable length coding approaches based on instruction partitioning (See, for example, Sang-Joon Nam, In-Cheol Park, and Chong-Min Kyung, “Improving dictionary-based code compression in VLIW architectures,” IEICE Trans. on FECCS, E82-A(11), 2318-2324, 1999; H. Lekatsas and W. Wolf, “Code compression for embedded systems,” DAC, 516-521, 1998; and C. Lefurgy, Efficient Execution of Compressed Programs, Ph.D. Thesis, University of Michigan, 2000, which are hereby incorporated by reference in their entireties) to enable parallel compression of the same instruction. The only obstacle preventing us from decoding all fields of the same instruction simultaneously is that the beginning of each compressed field is unknown unless all previous fields are decompressed.

One intuitive way to solve this problem, as shown in FIG. 29, is to separate the entire code into two parts, compress each of them separately, then place them separately. Using such a placement, the different parts of the same instruction can be decoded simultaneously using two pointers. However, if one part of the code (part B) is more effectively compressed than the other one (part A), the remaining unused space for part B is wasted. Therefore, the overall compression ratio will be hampered remarkably. Furthermore, the identification of branch targets will also be a problem due to the unequal compression. As mentioned earlier, fixed length encoding methods are suitable for parallel decompression but it sacrifices the compression efficiency due to fixed encoding. The focus of the present embodiment is to enable parallel decompression for binaries compressed with variable length encoding methods. One way the present embodiment handles this problem is to develop an efficient bitstream placement method. This embodiment enables the compression algorithm to make maximum usage of the space automatically. At the same time, the decompression mechanism is able to determine which part of the newly fetched 32 bits should be sent to which decoder. In this way, the benefits of instruction division can be exploited in both compression efficiency and decode bandwidth.

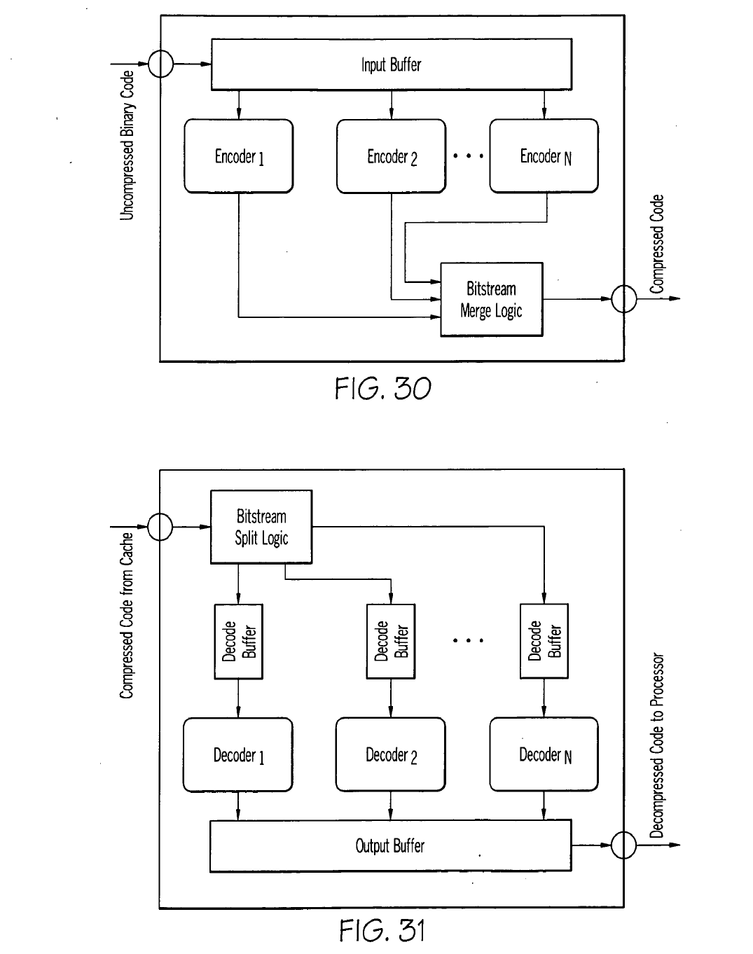

In one embodiment, branch blocks (See, for example, C. Lin, Y. Xie, and W. Wolf, “LZW-based code compression for VLIW embedded systems,” DATE, 76-81, 2004, which is hereby incorporated by reference in its entirety) are used as the basic unit of compression. In other words, the placement technique of the present embodiment is applied to each branch blocks in the application. FIGS. 30 and 31 show the block diagram of the compression framework according to one embodiment. The compression framework comprises four main stages: compression (encode), bitstream merge, bitstream split, and decompression (decode). During compression (FIG. 30), every input storage block (containing one or more instructions) is broken into several fields and then specific encoders are applied to each one of them. The resultant compressed streams are combined together by a bitstream merge logic based on a carefully designed bitstream placement algorithm. Note that the bitstream placement, in one embodiment, does not rely on any information invisible to the decompression unit. In other words, the bitstream merge logic merge streams based on only the binary code itself and the intermediate results produced during the encoding process.

During decompression, as shown in FIG. 31, the scenario is the opposite of compression. Every word fetched from the cache is first split into several parts, each of which belongs to a compressed bitstream produced by some encoder. Then the split logic dispatches them to the buffers of correct decoders, according to the bitstream placement algorithm. These decoders decode each bitstream and generate the uncompressed instruction fields. After combining these fields together, the final decompression result is obtained, which should be identical to the corresponding original input storage block (containing one or more instructions). From the viewpoint of overall performance, the compression algorithm affects the compression ratio and decompression speed in an obvious way. Nevertheless, the bitstream placement actually governs whether multiple decoders are capable to work in parallel. In previous works, researchers tend to use a very simple placement technique: they appended the compressed code for each symbol one after the other. When variable length coding is used, symbols must be decoded in order.

In one embodiment, Huffman coding is used for the compression algorithm of each single encoder (Encoder1-EncoderN in FIG. 30), because Huffman coding is optimal for a symbol-by-symbol coding with a known input probability distribution. To improve its performance on code compression, the basic Huffman coding method (See, for example, A. Wolfe and A. Chanin, “Executing compressed programs on an embedded RISC architecture,” MICRO 81-91, 1992, which is hereby incorporated by reference in its entirety) is modified in two ways: i) instruction division and ii) selective compression. As mentioned earlier, any compression technique can be used for the various embodiments of the present invention. As supported by previous works See, for example, Sang-Joon Nam, In-Cheol Park, and Chong-Min Kyung, “Improving dictionary-based code compression in VLIW architectures,” IEICE Trans. on FECCS, E82-A(11), 2318-2324, 1999; H. Lekatsas and W. Wolf, “Code compression for embedded systems,” DAC, 516-521.1998; and C. Lefurgy, Efficient Execution of Compressed Programs, Ph.D. Thesis, University of Michigan, 2000, which are hereby incorporated by reference in their entireties, compressing different parts of a single instruction separately is profitable, because the number of distinct opcodes and operands is far less than the number of different instructions. An observation has been made that for most applications it is profitable to divide the instruction at the center. Throughout the following discussion, this division pattern is used, if not stated otherwise.

Selective compression is a common choice in many compression techniques (See, for example, S. Seong and P. Mishra, “Bitmask-based code compression for embedded systems,” IEEE Trans. on CAD, 27(4), 673-685, April 2008, which is hereby incorporated by reference in its entirety). Since the alphabet for binary code compression is usually very large, Huffman coding may produce many dictionary entries with quite long keywords. This is harmful to the overall compression ratio, because the size of the dictionary entry must also be taken into account. Instead of using bounded Huffman coding, the current embodiment addresses this problem using selective compression. First, the current embodiment creates the conventional Huffman coding table. Then any entry e which does not satisfy (Length(Symbolₑ)−Length(Keyₑ))*Timeₑ>Sizeₑ.

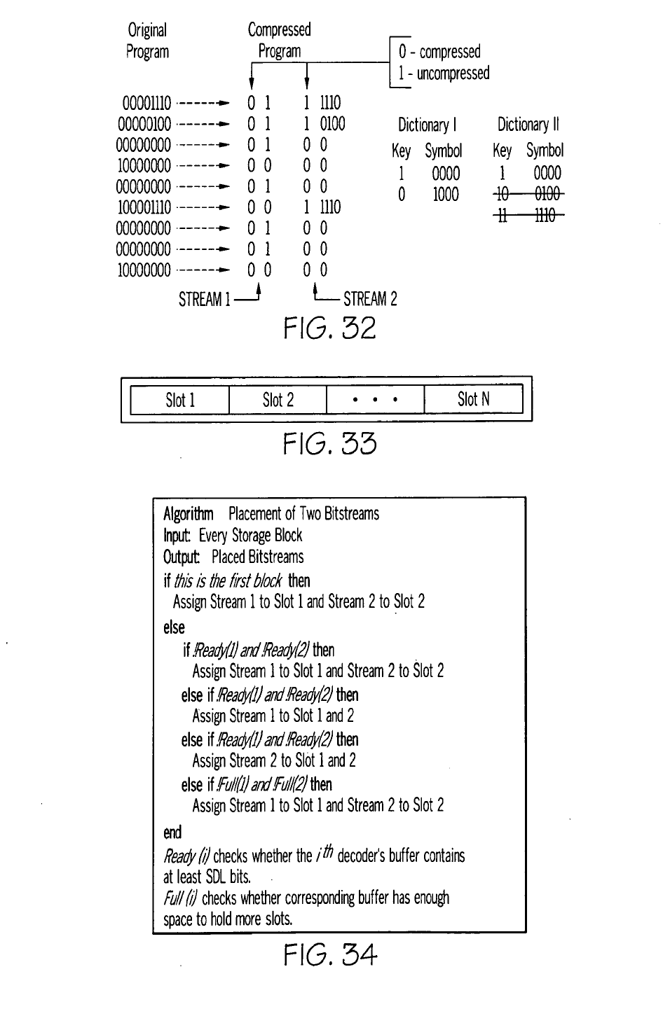

Here, Symbolₑ is the uncompressed symbol (one part of an instruction), Keyₑ is the key of Symbolₑ created by Huffman coding, Time, is the total time for which Symbolₑ occurs in the uncompressed code, and Sizeₑ is the space required to store this entry. For example, two unprofitable entries from Dictionary II, as shown in FIG. 32 by the strikethroughs, are removed. Once the unprofitable entries are removed, remaining entries are used as the dictionary for both compression and decompression entries as the dictionary for both compression and decompression. FIG. 32 shows an illustrative example this compression technique. For the simplicity of illustration, 8-bit binaries are used instead of 32 bits used in real applications. Each instruction is divided in half and two dictionaries are used, one for each part. The final compressed program is reduced from 72 bits to 45 bits. The dictionary requires 15 bits. The compression ratio for this example is 83.3%. The two compressed bitstreams (Stream1 and Stream2) are also shown in Table VII below.

TABLE VII

| | |
|---|---|
| Stream1 | Stream2 |

| Symbol | Value | Symbol | Value |
|---|---|---|---|
| A₁ | 01 | B₁ | 11110 |
| A₂ | 01 | B₂ | 10100 |
| A₃ | 01 | B₃ | 00 |
| A₄ | 00 | B₄ | 00 |
| A₅ | 01 | B₅ | 00 |
| A₆ | 00 | B₆ | 11110 |
| A₇ | 01 | B₇ | 00 |
| A₈ | 01 | B₈ | 00 |
| A₉ | 00 | B₉ | 00 |

The bitstream merge logic merges multiple compressed bitstreams into a single bitstream for storage. Definition 1: Storage block is a block of memory space, which is used as the basic input and output unit of the merge and split logic. Informally, a storage block contains one or more consecutive instructions in a branch block. FIG. 33 illustrates the structure of a storage block. The storage block shown in FIG. 33 is divided into several slots. Each of slot includes adjacent bits extracted from the same compressed bitstream. In one embodiment, all slots within a storage block have the same size. Definition 2: Sufficient decode length (SDL) is the minimum number of bits required to ensure that at least one compressed symbol is in the decode buffer. In one embodiment, this number equals one plus the length of an uncompressed instruction field.

The bitstream merge logic of the various embodiments of the present invention performs two tasks to produce each output storage block filled with compressed bits from multiple bitstreams: i) use the given bitstream placement algorithm (BPA) to determine the bitstream placement within current storage block; ii) count the numbers of bits left in each buffer as if they finish decoding current storage block. Extra bits are padded after the code at the end of the stream to align on a storage block boundary. FIG. 34 shows pseudo code that supports parallel decompression of two bitstreams. The goal is to guarantee that each decoder has enough bits to decode in the next cycle after they receive the current storage block.

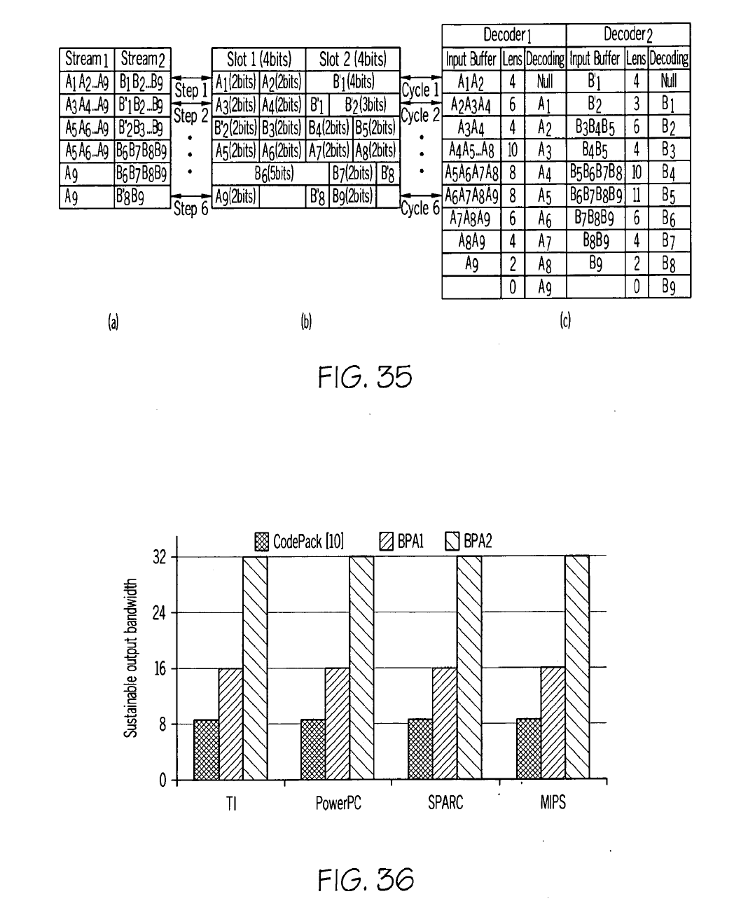

FIG. 35 illustrates the bitstream merge procedure using previous code compression example in FIG. 32. In particular, FIG. 35 shows (a) Unplaced data remaining in the input buffer of merge logic, (b) Bitstream placement result, (c) Data within Decoder₁ and Decoder₂ when current storage block is decompressed, where ′ and ′ are used to indicate the first and second parts of the same compressed instruction in case it does not fit in the same storage block. The size of storage blocks and slots are 8 bits and 4 bits respectively. In other words, each storage block has two slots. The SDL is 5. When the merge process begins (translates section (a) of FIG. 35 to section (b) of FIG. 35, the merge logic gets A₁, A, and B′₁, then assigns them to the first and second slots. Similarly, A₃, A₄, B″₁, and B′₂ are placed in the second iteration (step 2). When it comes to the third output block, the merge logic finds that after Decoder₂ receives and processes the first two slots, there are only 3 bits left in its buffer, while Decoder₁ still has enough bits to decode in the next cycle. So it assigns both slots in the third output block from Stream₂. This process repeats until both input (compressed) bitstreams are placed. The “Full( )” checks are necessary to prevent the overflow of decoders' input buffers. The merge logic automatically adjusts the number of slots assigned to each bitstream, depending on whether they are effectively compressed.

The bitstream split logic uses the reverse procedure of the bitstream merge logic. The bitstream split logic divides the single compressed bitstream into multiple streams using the following guidelines:
Use the given BPA to determine the bitstream placement within current compressed storage block, then dispatch different slots to the corresponding decoder's buffer.
If all the decoders are ready to decode the next instruction, start the decoding.
If the end of current branch block is encountered, force all decoders to start.

The example in FIG. 35 is used to illustrate the bitstream split logic. When the placed data in section (b) of FIG. 35 is fed to the bitstream split logic (translates section (b) of FIG. 35 to section (c) of FIG. 35, the length of the input buffers for both streams are less than SDL. So the split logic determines the first and the second slot must belong to Stream₁ and Stream₂ respectively in the first two cycles. At the end of the second cycle, the number of bits in the Decoder₁ buffer, Len₁ (i.e., 6), is greater than SDL (i.e., 5), but Len₂ (i.e., 3) is smaller than SDL. This indicates that both slots must be assigned to the second bitstream in the next cycle. Therefore, the split logic dispatches both slots to the input buffer of Decoder₂. This process repeats until all placed data are split.

A decoder design, according to one embodiment, of the present invention is based on the Huffman decoder hardware proposed by Wolfe et al. (See A. Wolfe and A. Chanin, “Executing compressed programs on an embedded RISC architecture,” MICRO 81-91, 1992, which is hereby incorporated by reference in its entirety). The only additional operation is to check the first bit of an incoming code, in order to determine whether it is compressed using Huffman coding or not. If it is, decode it using the Huffman decoder; otherwise send the rest of the code directly to the output buffer. Therefore, the decode bandwidth of each single decoder (Decoder₁ to Decoder_{N} in FIG. 31 should be similar to the one given in A. Wolfe and A. Chanin, “Executing compressed programs on an embedded RISC architecture,” MICRO 81-91, 1992, which is hereby incorporated by reference in its entirety. Since each decoder can decode 8 bits per cycle, two parallel decoders can produce 16 bits per cycle. Decoders are allowed to begin decoding only when i) all decoders' decoder buffers contains more bits than SDL; or ii) bitstream split logic forces it to begin decoding. After combining the outputs of these parallel decoders together, the final decompression result is obtained.

In order to further boost the output bandwidth, a bitstream placement algorithm, in one embodiment, enables four Huffman decoders to work in parallel. During compression, every two adjacent instructions are taken as a single input storage block. Four compressed bitstreams are generated by high 16 bits and low 16 bits of all odd instructions, as well as high 16 bits and low 16 bits of all even instructions. The slot size is also changed within each output storage block to 8 bits, so that there are 4 slots in each storage block. The complete description of this algorithm is not discussed in detail for the sake of brevity. However, the basic idea remains the same and it is a direct extension of the algorithm shown in FIG. 34. The goal is to provide each decoder with sufficient number of bits so that none of them are idle at any point. Since each decoder can decode 8 bits per cycle, four parallel decoders can produce 32 bits per cycle. Although more decoders can be employed, the overall increase of output bandwidth slows down by more start up stalls. For example, a wait time of 2 cycles is needed to decompress the first instruction using four decoders in the worst case. As a result, high sustainable output bandwidth using too many parallel decoders may not be feasible, if its start up stall time is comparable with the execution time of the code block itself.

The code compression and parallel decompression experiments of the framework discussed above are carried out using different application benchmarks compiled using a wide variety of target architectures. Benchmarks from MediaBench and MiBench benchmark suites: adpcm en, adpcm de, cjpeg, djpeg, gsm to, gsm un, mpeg2enc, mpeg2dec and pegwit were used. These benchmarks are compiled for four target architectures: TI TMS320C6x, PowerPC, SPARC and MIPS. The TI Code Composer Studio is used to generate the binary for TI TMS320C6x. GCC is used to generate the binary for the rest of them. The computation of compressed program size includes the size of the compressed code as well as the dictionary and all other data required by the decompression unit discussed above. An evaluation was performed on the relationship between the division position and the compression ratio on different target architectures.

An observed was made that for most architectures, the middle of each instruction is usually the best partition position. An analysis was performed on the impact of dictionary size on compression efficiency using different benchmarks and architectures. Although larger dictionaries produce better compression, the approach taken by the various embodiments of the present invention produces reasonable compression using only 4096 bytes for all the architectures.

Based on these observations, each 32-bit instruction was divided from the middle to create two bitstreams. The maximum dictionary size is set to 4096 bytes. The output bandwidth of the Huffman decoder is computed as 8 bits per cycle (See A. Wolfe and A. Chanin, “Executing compressed programs on an embedded RISC architecture,” MICRO 81-91, 1992, which is hereby incorporated by reference in its entirety) in these experiments. Based on available information, there does not seem to have been performed work on bitstream placement for enabling parallel decompression of variable length coding. So the various embodiments (BPA1 and BPA2) were compared with CodePack (See C. Lefurgy, Efficient Execution of Compressed Programs, Ph.D. Thesis, University of Michigan, 2000, which is hereby incorporated by reference in its entirety), which uses a conventional bitstream placement method. Here, BPA1 is the bitstream placement algorithm in FIG. 34 discussed above, which enables two decoders to work in parallel, and BPA2 represents the bitstream placement for four streams discussed above, which supports four parallel decoders.

FIG. 36 shows the efficiency of the different bitstream placement methods of the various embodiments of the present invention. Here, “decode bandwidth” means the sustainable output bits per cycle after initial stalls. The number shown in the figure is the average decode bandwidth over all benchmarks. It is important to note that the decode bandwidth for each benchmark also shows the same trend. As expected, the sustainable decode bandwidth increases as the number of decoder grows. The bitstream placement approach of the various embodiments of the present invention improves the decode bandwidth up to four times. As discussed earlier, it is not profitable to use more than four decoders since it will introduce more start up stalls.

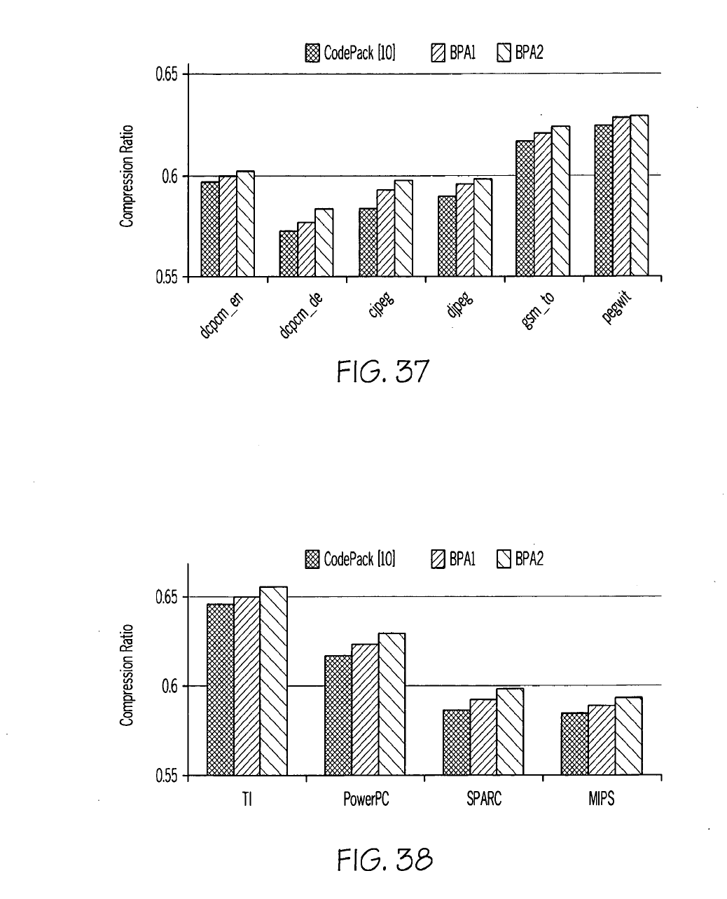

The impact of bitstream placement on compression efficiency was also studied. FIG. 37 compares the compression ratios between the three techniques on various benchmarks on MIPS architecture. The results show that the bitstream placement embodiment has less than 1% penalty on compression efficiency. This result is consistent across different benchmarks and target architectures as demonstrated in FIG. 38, which compares the average compression ratio of all benchmarks on different architectures.

The decompression unit was implemented using Verilog HDL. The decompression hardware is synthesized using Synopsis Design Compiler and TSMC 0.18 cell library. Table VIII below shows the reported results for area, power, and critical path length. It can be seen that “BPA1” (uses 2 16-bit decoders) and Code-Pack have similar area/power consumption. On the other hand, “BPA2” (uses 4 16-bit decoders) requires almost double the area/power compared to “BPA1” to achieve higher decode bandwidth, because it has two more parallel decoders. The decompression overhead in area and power is negligible (100 to 1000 times smaller) compared to typical reduction in overall area and energy requirements due to code compression.

TABLE VIII

| | CodePack [11] | BPA1 | BPA2 |
|---|---|---|---|
| Area/μm² | 122263 | 137529 | 253586 |
| Power/mW | 7.5 | 9.8 | 14.6 |
| Critical path length/ns | 6.91 | 5.76 | 5.94 |

Memory is one of the key driving factors in embedded system design since a larger memory indicates an increased chip area, more power dissipation, and higher cost. As a result, memory imposes constraints on the size of the application programs. Code compression techniques address the problem by reducing the program size. Existing researches have explored two directions: efficient compression with slow decompression, or fast decompression at the cost of the compression efficiency. This paper combines the advantages of both approaches by introducing a novel bitstream placement technique for parallel decompression.

The various embodiments of the present invention address the four challenges discussed above to enable parallel decompression using efficient bitstream placement: instruction compression, bitstream merge, bitstream split and decompression. Efficient placement of bitstreams allows the use of multiple decoders to decode different parts of the same/adjacent instruction(s) to enable the increase of decode bandwidth. The experimental results using different benchmarks and architectures demonstrated that the various embodiments of the present invention improved the decompression bandwidth up to four times with less than 1% penalty in compression efficiency.

The various embodiments of the present invention are also applicable to decoding-aware bitmask based compression bitstreams. The following discussion beings with a technique to choose efficient parameters for generic dictionary based compression. Next a decoding-aware bitmask based compression technique for selecting efficient parameters is discussed. An efficient parameter based dictionary selection is illustrated to obtain better dictionary coverage. Later a run length encoding scheme for intelligently encoding repetitive compressed words to improve compression and decompression performance is also discussed. Finally an illustration on how compressed bits are transformed to fixed length encoded bytes for faster decompression is given.

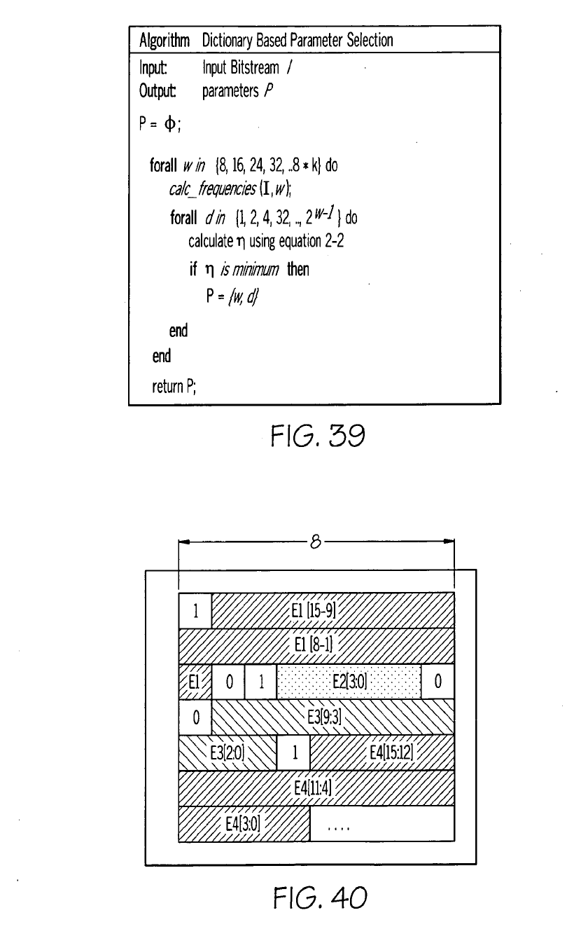

To improve compression ratio using partial or full dictionary suitable parameters (P): word length (w), and number of dictionary entries (d) are chosen. FIG. 39 shows pseudo code for selecting parameters that yield efficient compression ratio. Since memory and communication bus are designed in multiple of byte size (8 bits), storing dictionaries or transmitting data other than multiple of byte size results in under utilization of memory and communication bus lines. This limits the search space for word length (w) within multiples of 8 up to k iterations. Now with this selected word length, the dictionary sizes can be easily evaluated to determine which yields the best compression ratio. Dictionary size dictates the size of the index bits. For the word to be compressed, it is evident that these index bits have to be at least one bit less than the word length (w) itself. Thus, the efficient dictionary size for a given word length (w) can be found by incrementally changing the index bits from 1 to (w−1). In other words dictionary size ranges from 1, 2, 4 up to 2^{w-1}. With these parameters the algorithm now calculates the compression ratio by using the Equation

$${η}_{partial} = \frac{( w * d ) + ( 1 + ⌈ {log}_{2} ( d ) ⌉ ) * {n}_{m} + ( 1 + w ) * ( n - {n}_{m} )}{n * w} .$$

The number of matched words (nₘ) can be determined by sorting the unique words in descending order of their occurrences. The cumulative sum i^{th} word provides the number of matched words till 1 to i entries in the dictionary.

In bitmask based compression method, efficiency is not only determined by word length (w) and dictionary size (d), but also by the number of bitmasks (b) and type of each bitmask tᵢ used. From Equation

$$η = \frac{{dict}_{size} + {match}_{size} + {bitmasked}_{size} + {Uncompressed}_{size}}{n * w}$$

it is evident that more the number of bitmasks used smaller dictionary size is sufficient. This requires less bits to index the dictionary but to store these bitmasks a large offset and difference bits are needed. The entries in the dictionary selected determines the effectiveness of matching uncompressed words with less differences based on proximity of the bit differences that an entry in the dictionary can match. The application specific bitmask compression method proposed in S. W. Seong and P. Mishra, “An efficient code compression technique using application-aware bitmask and dictionary selection methods,” IEEE Trans. Comput.-Aided Design Of Integr. Circuits And Syst., vol. 27, no. 4, pp. 673-685, April 2008, which is hereby incorporated by reference in its entirety, suggests feasible bitmasks and type of bitmask and graph based dictionary selection algorithm for better compression ratio. The direct application of this algorithm results in compressed code which is complex and variable length as illustrated in FIG. 40. The type of bitmasks that can be used such that compressed code can be smartly converted to fixed code compressed words without sacrificing the compression efficiency is discussed further below.

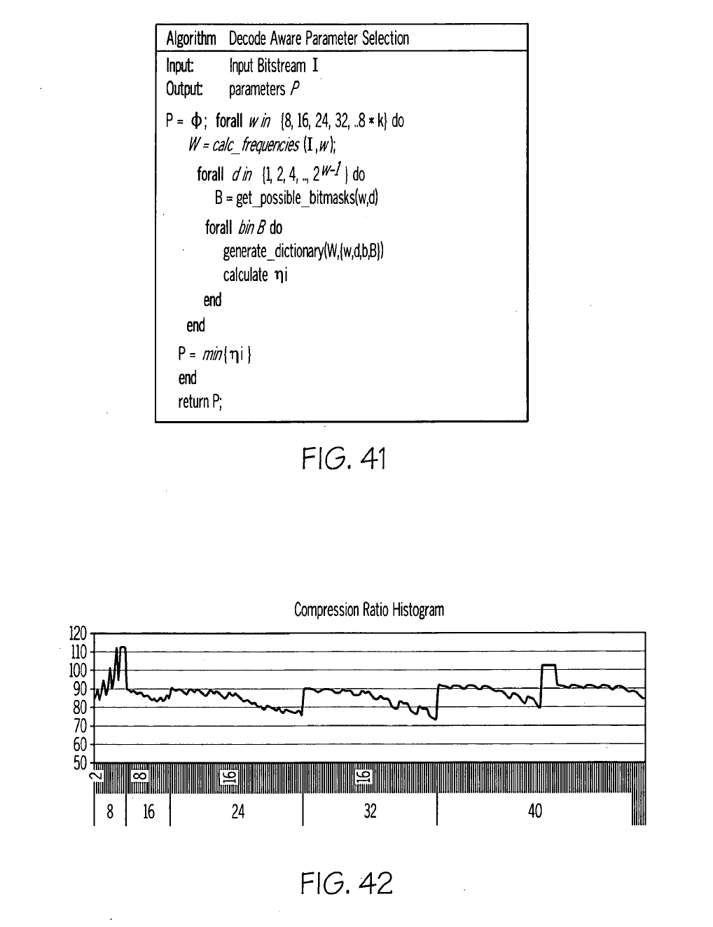

FIG. 41 illustrates pseudo code for the decode aware parameter (word length w, dictionary size d, number of bitmasks b, size and type of each bitmask {sᵢ,tᵢ} selection. The range of word length (w) and dictionary size (d) remains the same as in FIG. 39. A list of bitmask combination is proposed based on its feasibility to align in a fixed byte boundary is discussed below. An optimized dictionary selection discussed below is used to select dictionary which covers most of the words using minimal bitmasks. The compression ratio is calculated using

$${η}_{partial} = \frac{( w * d ) + ( 1 + ⌈ {log}_{2} ( d ) ⌉ ) * {n}_{m} + ( 1 + w ) * ( n - {n}_{m} )}{n * w} .$$

The parameter combination which results in minimal compression ratio is used during compression.

FIG. 42 shows the compression ratio obtained by applying the above algorithm on RSAXCV 100 benchmark. The compression ratio obtained is dependent on the input data's entropy. A high entropy input requires large dictionary and wider bitmasks to obtain better compression efficiency. It can be noted that as word length increases the compression ratio reaches 100% (higher the value lesser the bitstream is compressed). This is because wider words results in less redundancy and dictionary chosen covers less number of words. The effect of increasing dictionary size also improves the compression ratio only to a certain point. Any increase in dictionary size after this points worsens the compression ratio because of the larger index bits used to access the dictionary. An increase in the number and type of bitmask for a given word length and dictionary size improves with lesser number of bitmasks depending on word length selected (one bitmask 16 bit words, two bitmasks for 32 bit words). To obtain the range of parameters for a new benchmark the various embodiments of the present invention are considered with all possible values (with word length ranging up to 64 bits).

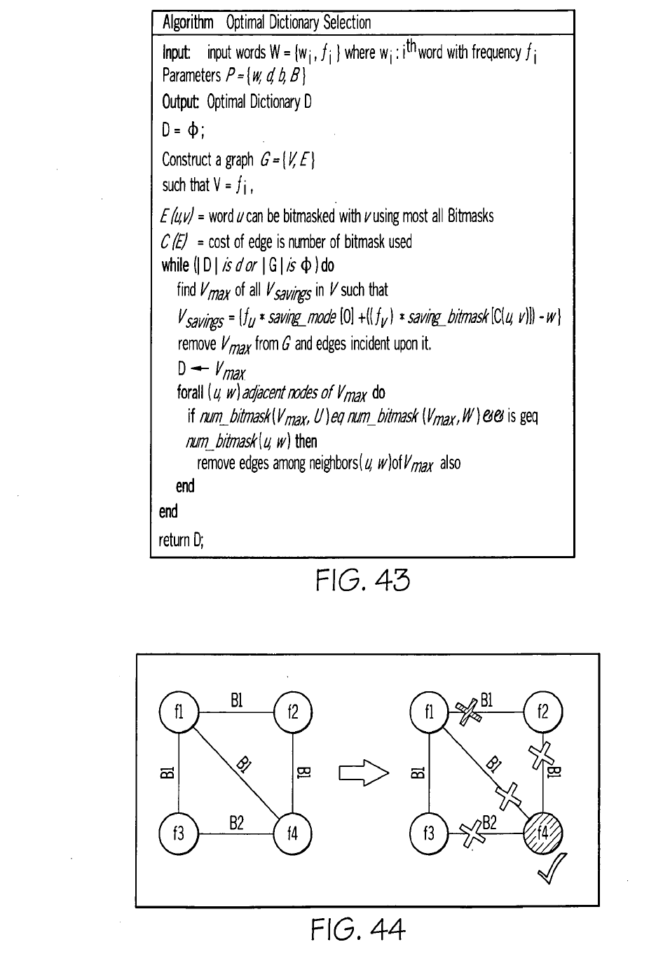

The dictionary selection method of one embodiment is motivated by application specific bitmask based code compression proposed in S. W. Seong and P. Mishra, “An efficient code compression technique using application-aware bitmask and dictionary selection methods,” IEEE Trans. Comput.-Aided Design Of Integr. Circuits And Syst., vol. 27, no. 4, pp. 673-685, April 2008, which is hereby incorporated by reference in its entirety. The dictionary is selected for given parameters (P): word length (w), dictionary size (d), number of bitmasks (b) and size and type of each bitmask (B). FIG. 43 shows pseudo code for dictionary selection based on the savings made by each uniquely occurring word. The dictionary selection is majorally governed by a words capability to match other words using minimal number of bit masks and covers as most of the input words. The input is divided into unique words with each word associated with frequency (fᵢ). A graph (G) is created in which each vertex represents word with frequencies as its weight. Two vertices are connected via an edge if the two words represented by them can be bitmasked with using at most all the bitmasks in B. Each edge (u, v) has the number of bitmasks used to match vertex u and vertex v as its weight. The savings made for each vertex is calculated based on the sum of savings made by itself in the dictionary and savings made by bitmask matching with other vertices indicated by the incident edges on it.

Equation

$$savings\_made [ i ] = ( 1 + w ) - ⌈ {log}_{2} ( d ) ⌉ - {\sum }_{j = 0}^{i} ( {s}_{j} + {l}_{j} )$$

is used to calculate the savings made (savings_made) by each vertex u using i bitmasks. The savings made is an array which holds the savings for different number of bitmasks (from 0, 1, 2, to b). This array is then used to calculate the total savings of vertex u. The final savings of a vertex is simply the product of all the frequencies of incident vertices including itself, with savings_made array calculated using Equation

$$savings\_made [ i ] = ( 1 + w ) - ⌈ {log}_{2} ( d ) ⌉ - {\sum }_{j = 0}^{i} ( {s}_{j} + {l}_{j} )$$

indexed by weight on each edge. Note that savings_made[0] indicates using no bitmask or direct indexing. A winner vertex with maximal savings is selected and inserted in the dictionary. All incident edges are removed from the graph (G). To avoid savings conflict among multiple vertices, edges between the adjacent vertices of winner vertex are also removed if the current saving with winner is more beneficial than the edge between them. The following example dictionary selection illustrates the optimized dictionary selection.

FIG. 44 demonstrates an iteration of dictionary selection. Let f1, f2, f3, and f4 be the frequencies of the four most frequently occurring elements and B1 (Bitmask 1) and B2 (Bitmask 2) be the number of bitmasks used for matching. The total savings made by each vertex (u) is calculated by the product of frequency and savings made by each edge (fᵤ*savings_madeᵤ). Then a winner with highest savings is selected. Suppose f₄ is the winner then all the incident edges are removed from the graph. Note that once the winner f₄ is selected the incident edge between vertex f₁ and f₂ is also removed because f1 is already covered by f4 using B1 bits. This ensures that savings are not claimed by multiple vertices which are already in the dictionary. Thus maximizing the total savings made by the selected dictionary

$$savings\_made [ i ] = ( 1 + w ) - ⌈ {log}_{2} ( d ) ⌉ - {\sum }_{j = 0}^{i} ( {s}_{j} + {l}_{j} )$$

The dictionary selection technique proposed in Seong et al. (See S. W. Seong and P. Mishra, “An efficient code compression technique using application-aware bitmask and dictionary selection methods,” IEEE Trans. Comput.-Aided Design Of Integr. Circuits And Syst., vol. 27, no. 4, pp. 673-685, April 2008, which is hereby incorporated by reference in its entirety) heuristically removes adjacent vertices that have arbitrary threshold incident edges on it along with the winner vertex. This idea behind this is to reduce the dictionary size selected (thus index bits). The various embodiments of the present invention eliminate this heuristics by providing a fixed dictionary size. The dictionary selected covers maximum words directly or using minimal bitmasks thus ensuring better dictionary coverage.

Careful analysis of the bitstream pattern revealed that the input bitstream contained consecutive repeating patterns of words. The algorithm proposed in previous section encodes such patterns using same repeated compressed words. Instead a method in which repetition of such words are run length encoded (RLE) is used. Such repetition encoding will result in an improvement in compression performance by around 10-15% on Koch et al. (See Bitstream Compression Benchmark, Dept. of Computer Science 12. [Online]. Available: [(http://www.reconets.de/bitstreamcompression/]), which is hereby incorporated by reference in its entirety) benchmarks. To represent such encoding no extra bits are needed; another interesting observation leads to the conclusion that bitmask 0 is never used, because this value means that it was an exact match and would have encoded using zero bitmasks. Using this as a special marker, these repetitions can be encoded. This smart encoding will reduce the extra bit that is required to indicate on all the compressed words otherwise.

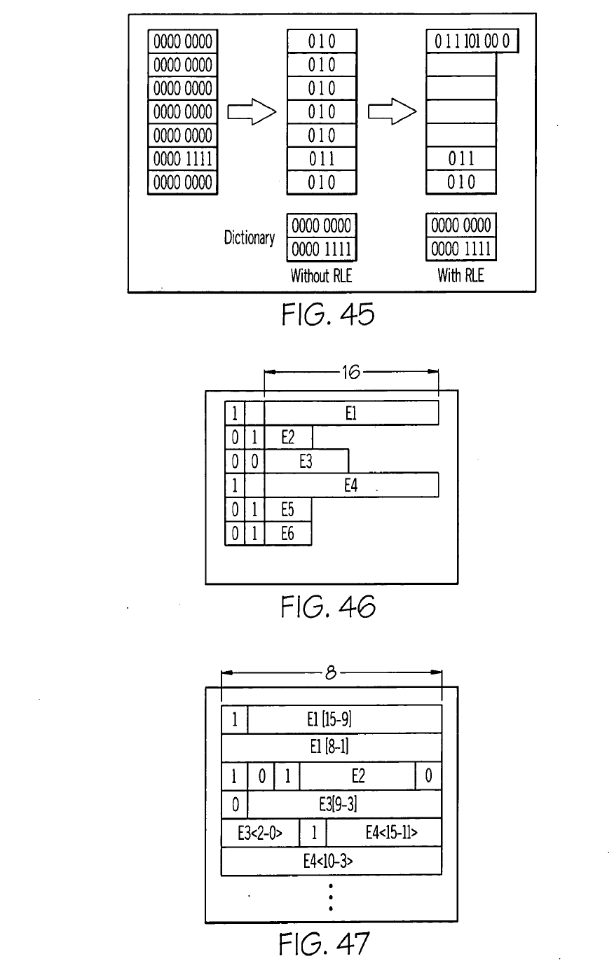

Another advantage of such run length encoding is that it alleviates the decompression overhead by providing the decompressed word instantaneously to the decoder to send it to the configuration hardware in the same cycle. This ensures the full utilization of the configuration hardware bandwidth and reduces the bottleneck on communication channel between memory and decoder. FIG. 45 illustrates the RLE bitmask in use. The compressed words are run length encoded only if the savings made by RLE word encoding is greater than the actual encoding. That is if there are r repetition of compressed words and cost of representing each word is x bits and the number of bits required to encode run length is y bits then RLE is used only if x*r<y bits.

The various embodiments of the present invention in this direction are motivated by previous bitstream compression framework for high speed FPGA (See D. Koch, C. Beckhoff, and J. Teich., “Bitstream decompression for high speed fpga configuration from slow memories,” in Proc. ICFPT, pp. 161-168, 2007; and Y. Xie. W. Wolf, and H. variable-to-fixed coding,” 2002. Lekatsas, “Code compression for vliw processors using In Proc. of Intl. Symposium on System Synthesis (ISSS), 2002, which are hereby incorporated by reference in their entireties). Generally, when variable length coding approaches are used to improve the compression ratio, they also set two obstacles for the design of high speed decompression engines. For example, FIG. 46 gives a sample output of the bitstream compression algorithm. FIG. 47 is its placement in an 8 bit-width memory using a naive placement method. It can be easily seen that: i) the start position of the next compressed entry usually cannot be determined unless the previous entry is decoded; ii) the input buffer within the decompression engine must be shifted for a variable length within each cycle. Both of them have a negative impact on the length of the critical path within the decompression engine, and therefore limit the maximum operational speed. The LZSS decompress technique in Koch et al. (See D. Koch, C. Beckhoff, and J. Teich., “Bitstream decompression for high speed fpga configuration from slow memories,” in Proc. ICFPT, pp. 161-168, 2007, which is hereby incorporated by reference in its entirety) uses one interesting way to attack this problem: place the encoded bits in a way that they can be treated as fixed length encoding. In other words, the encoded bits should have two properties: i) the start position of each compressed entry should be easily identifiable. ii) the number of possible shift length of input buffer should be as small as possible. These lead to at least one embodiment of the present invention for high speed decompression of variable length coding. The following discussion gives a detailed description on parameters selection which leads to smart rearrangement and how such variable length compressed words are transformed to fixed length compressed bitstreams.

The three different types of compressed words (uncompressed, compressed with exact match and compressed with bitmask) can be converted to fixed length encoded words by following these steps. i) The compressed and bitmasked flags are stripped from compressed words. ii) These flags are then arranged together to form byte aligned word. iii) The remaining content of the compressed words are arranged only if they satisfy the following conditions. Each of the uncompressed words needs to be multiple of 8 as discussed above. The dictionary index of compressed words or the sum with either of the flags should be equal to power of 2. This condition ensures that the dictionary index bits can be aligned to byte boundary. The bitmask information (offset and bit changes) of a bitmask compressed word is also subjected to similar condition.

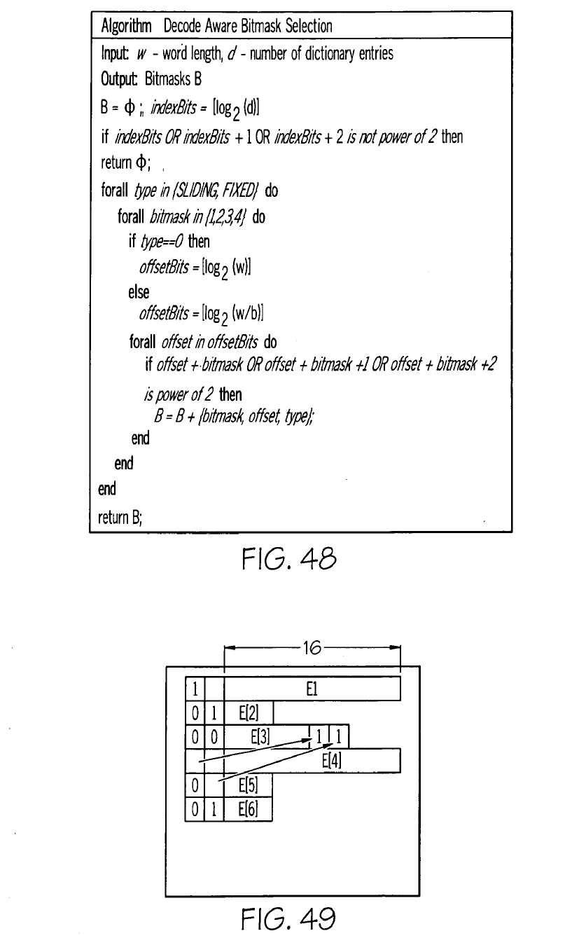

FIG. 48 shows pseudo code for a bitmask suggestion technique before compressing the bitstream such that they meet the above constraints. The bitmasks and type of bitmask explored are limited by the study described in Seong et al. (See S. W. Seong and P. Mishra, “An efficient code compression technique using application-aware bitmask and dictionary selection methods,” IEEE Trans. Comput.-Aided Design Of Integr. Circuits And Syst., vol. 27, no. 4, pp. 673-685, April 2008, which is hereby incorporated by reference in its entirety) (1, 2, 3, 4 bits). Both SLIDING and FIXED bitmask types are suggested for these possible bitmask sizes.

FIGS. 46, 47, 49, and 50 illustrate a bitstream compressed with parameters word length w=16, dictionary size d=16, number of bitmask b=1 and bitmask used B={s₀=2, t₀=SLIDING, l₀=4}. Here two dictionary indices (4+4 bits) are combined to encode as a single byte. The two dictionary indices can belong to a fully matched compressed word or to a bitmask compressed word. The offset and mask (4+2) of bitmask compressed word are then encoded with next words compressed flag (1 bit) and bitmask flag (1 bit) making the total number of bits aligned to a byte boundary. These extra bits serves two purposes; i) one padding the holes caused by misaligned offset bits and, ii) refills the flag bits that were used to decode this bitmask compressed word. Note that adding these extra flag bits refill the used flag bits but never overflow the flag register. A detailed strategic placement algorithm is discussed in the next subsection.

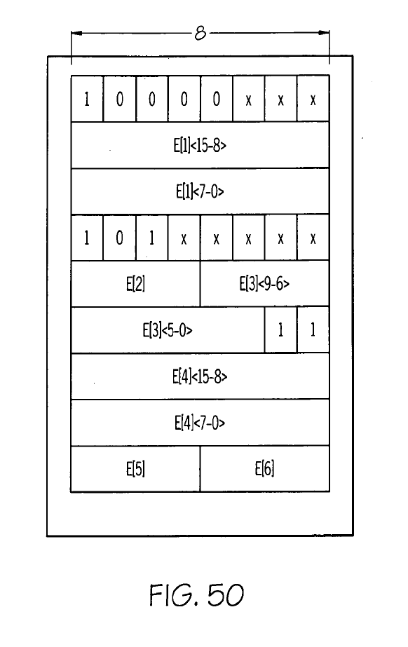

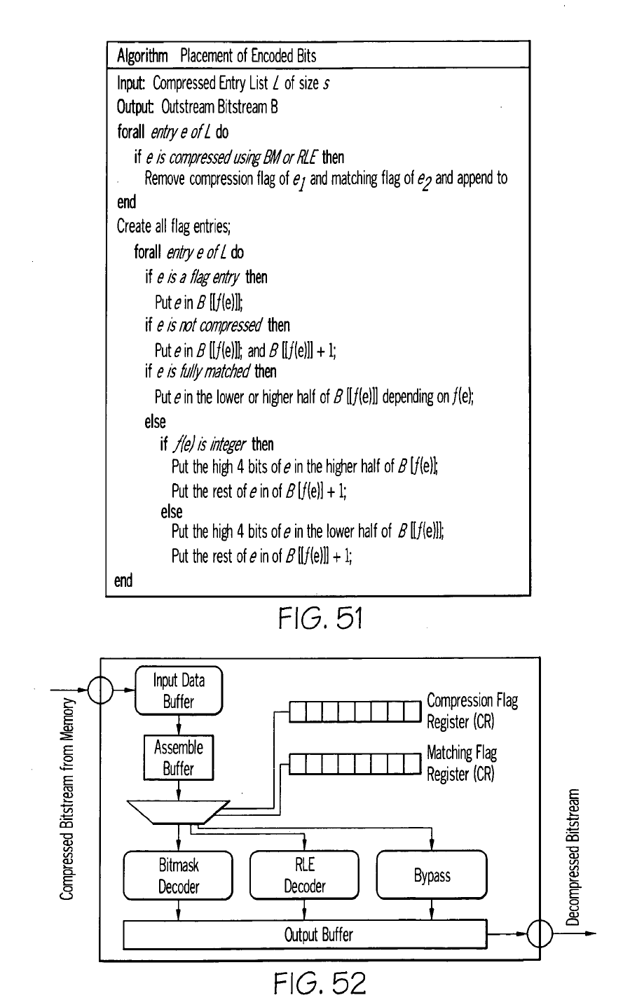

The placement algorithm merges all compressed entries into a single bitstream for storage. Given any input entry list with format described in previous section, the algorithm passes through the entire list three times to generate the final bitstream. In the first pass, the technique tries to attach two bits to each entry which is compressed with bitmask or RLE, so that the length of all entries (neglect flag bits) are either 4, 12 or 16. In the second pass, the flags of each 8 successive entries are extracted out, then store them as a separate “flag entry” in front of these 8 entries. Finally, all the entries are rearranged so that all of them fit into 8 bit slots. The entire algorithm is shown in FIG. 51 as pseudo code. FIGS. 49-50 illustrate the bitstream merge embodiment using FIG. 47 as input. In the first pass, the compression flag of entry E4 and matching flag of E5 are attached to the end of E3 (FIG. 49). Each entry now has a length of 4, 8 or 12. Then the remaining compression flags and matching flags are extracted as flag entries (line 1 and 4 in FIG. 49) in the second pass. After that, all the bits can easily be rearranged and make them fit into the 8 bit-wide memory, as shown in FIG. 50. With respect to FIG. 52, CFlag(e) is the compression flag of entry e, MFlag(e) is the matching flag of entry e, and f(e)=2nᵤ+0.5nₘ+1.5n_{b}, where nᵤ, nₘ, and n_{b} are the number of not compressed, fully matched and other entries before e respectively.

The structure of the decompression engine of one embodiment of the present invention is shown in FIG. 52. The compression flags and the matching flags are stored in corresponding shift registers CR and MR. CR[0] and MR[0] indicate the flags for next compressed entry. In each cycle, the new incoming data is first classified using their flags, assembled into a complete compressed entry, then decoded by BM, RLE or output directly. The implementation of the BM and RLE decoder, according to one embodiment, is based on the proposed design in Seong et al. (See S. W. Seong and P. Mishra, “An efficient code compression technique using application-aware bitmask and dictionary selection methods,” IEEE Trans. Comput.-Aided Design Of Integr. Circuits And Syst., vol. 27, no. 4, pp. 673-685, April 2008, which is hereby incorporated by reference in its entirety) and Koch et al. (See D. Koch, C. Beckhoff, and J. Teich., “Bitstream decompression for high speed fpga configuration from slow memories,” in Proc. ICFPT, pp. 161-168, 2007, which is hereby incorporated by reference in its entirety). If current entry is compressed with Bitmask or RLE, the last two bits of this entry is directly sent to CR[0] and MR[0] (these two bits are indeed the flags of next compressed entry, which are rearranged to their current position by the placement algorithm). Otherwise, CR and MR are shifted. When CR or MR is empty, they are reloaded immediately using next incoming data, which exactly corresponds to the flags of next 8 compressed entries (this is guaranteed by the placement algorithm). Since all encoded bits are carefully placed, the shift operation of the input buffer is completely avoided. Besides, the boundary between different compressed entries can be easily identified. Therefore, the maximum operational speed of the corresponding hardware is not hampered by the variable length coding embodiment. The detailed experimental results are discussed in greater detail below.

The following is a discussion on various experiments performed with respect to the decoding aware embodiments discussed above. Two sets of hard to compress IP core bitstreams chosen from image processing and encryption domain derived from Bitstream Compression Benchmark, Dept. of Computer Science 12. [Online]. Available: [(http://www.reconets.de/bitstreamcompression/]); and J. H. Pan, T. Mitra, and W. F. Wong, “Configuration bitstream compression for dynamically reconfigurable fpgas,” in Proc. ICCAD, pp. 766-773, 2004, which are hereby incorporated by reference in their entireties, were used to compare the compression and decompression efficiencies of the various embodiments of the present invention. All the benchmarks are in readable binary format (.rbt) each word length of 32 bit binary ASCII representation, or binary (.bin) format later converted to rbt format. All rbt files are then converted to specified word lengths discussed later below. Xilinx Virtex-II family IP core benchmarks were used to analyze the results, the same results were found applicable to other families and vendors too.

Table IX below summarizes the different parameter values used by the algorithm discussed above with respect to FIG. 41 to evaluate the best possible compression ratio. Each column value is permutated with every other column.

TABLE IX

| word | | number of | | |
|---|---|---|---|---|
| len | table size | BitMask | Bitmask 1 (s-sliding) | Bitmask 2 (s-sliding) |
| [symbol] | 1, 2, 4, 8, 16, [symbol] 64, 128, 256, 512 | [symbol] 2 | 1s, [symbol] 3s, 4s, 1f, 2f, 3f, 4f | 1s, 2s, 3s, 4s, 1f, 2f, 3f, 4f |
| 16 | 1, 2, 4, 8, 16, 32, 64, 128, 256, 512 | 16 | 1s, 2s, 3s, 4s, 1f, 2f, 3f, 4f | 1s, 2s, 3s, 4s, 1f, 2f, 3f, 4f |
| 32 | 1, 2, 4, 8, 16, 32, 64, 128, 256, 512 | 32 | 1s, 2s, 3s, 4s, 1f, 2f, 3f, 4f | 1s, 2s, 3s, 4s, 1f, 2f, 3f, 4f |
| [symbol] | 1, 2, 4, 8, 16, 32, 64, 128, 256, [symbol] | 1, [symbol] | 1s, 2s, 3s, 4s, 1f, 2f, 3f, 4f | 1s, 2s, [symbol] 4s, 1f, 2f, 3f, 4f |
| 64 | 1, 2, 4, 8, 16, 32, 64, 128, 256, 512 | 64 | 1s, 2s, 3s, 4s, 1f, 2f, 3f, 4f | 1s, 2s, 3s, 4s, 1f, 2f, 3f, 4f |
| 64 | 1, 2, 4, 8, 16, 32, 64, 128, 256, 512 | 64 | 1s, 2s, 3s, 4s, 1f, 2f, 3f, 4f | 1s, 2s, 3s, 4s, 1f, 2f, 3f, 4f |

The parameters with best compression ratio are chosen for the final compression. The values highlighted are the final selected values for Koch et al. and Pan et al. compression techniques. The benchmark in Koch et al. can be efficiently compressed using 16 bit words, with 16 entry dictionary and a 2 bit sliding mask for storing bitmask differences. The benchmark in Pan et al. can be efficiently compressed with 32 bit words, 512 entry dictionary entries and two bitmasks with a 2 bit and 3 bit sliding bitmasks. Note that if two bitmasks are used in order to reorganize the compressed bits. The bits indicating the number of bitmasks are stripped to form another 8 bit vector similar to compress and bitmask flags discussed above. This facilitates other fields to be arranged on a byte boundary.

The compression efficiency of the various embodiments of the present invention are analyzed with respect to bitmask based compression technique proposed in Seong et al. with respect to improved dictionary selection, decoding aware parameter selection and run length encoding of repetitive pattern techniques proposed in this thesis. The optimized dictionary selection is found to select dictionary entries improving the bitmask coverage by at least 5% for benchmarks which requires big dictionary. It is observed that in benchmarks that have high consecutive redundancy run length encoding out performs other techniques by at least 10-15%. The compression ratio is also evaluated with existing compression techniques proposed by Koch et al. and Pan et al. The various embodiments of the present invention is found to outperform Koch et al. by around 5\% on (See Pan et al.) benchmarks and around 15% on benchmarks (see Pan et al.). The decode aware compression technique of the various embodiments of the present invention is able to compress 5-10% closer to Pan et al. compression technique.

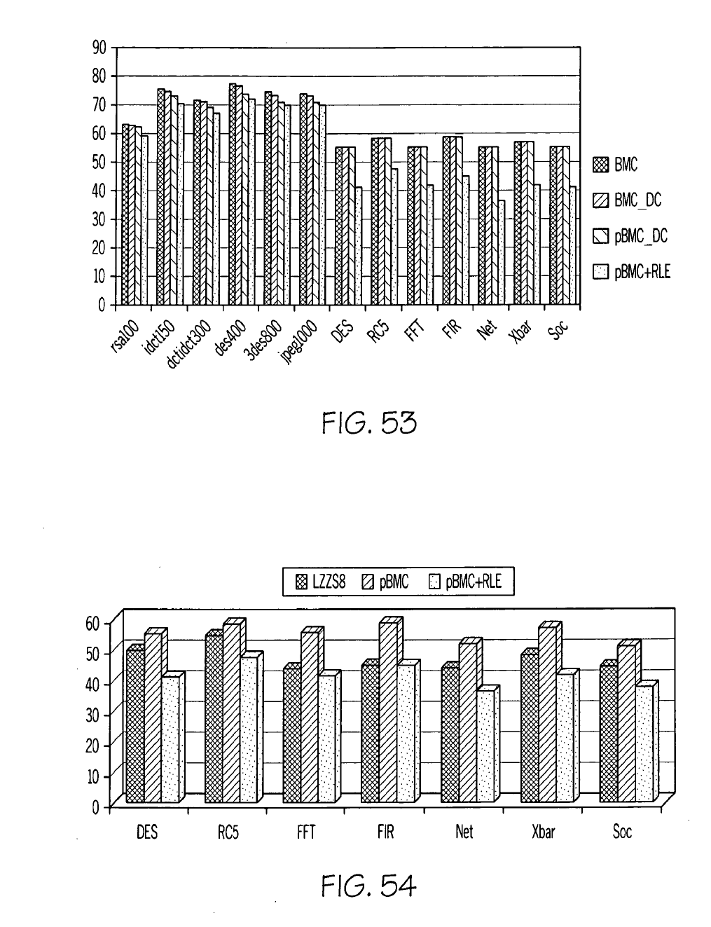

Bitmask based compression technique proposed in Seong et al. is compared with enabling all three main techniques proposed in this thesis. FIG. 53 shows the compression ratio for all the benchmarks. These are the four different type of compression techniques that are compared; i) BMC—bit mask compression technique proposed in Seong et al. [12], ii) BMC_DC—bit mask compression along with new dictionary selection technique, iii) pBMC_DC—the decode aware bit mask compression embodiment discussed above and iv) pBMC+RLE—the decode aware bitmask compression embodiment combined with run length encoding. The following are the observations and results for each of the techniques proposed.

1) Optimized dictionary selection—This compares the dictionary selection algorithm over the technique proposed in Seong et al. From FIG. 53, one can notice that for smaller benchmark, dictionary selection algorithm has little effect on improving compression ratio, the reason being that, dictionary size is very small to reflect the optimization made for arbitrary threshold vertices removal once a dictionary entry is selected. This optimization becomes significant as the dictionary sizes increase. This can be noted from the compression ratio of benchmarks in Pan et al. These benchmark requires large dictionaries for better compression ratio (size up to 1K entries). The main advantages of the various embodiments of the present invention is that for any generic benchmark the threshold value does not have to be found manually. Another advantage is that the optimization adds no additional decoding overhead or degrades the compression ratio. The optimized dictionary selection generates dictionary which improves the compression ratio by around 4-5% on benchmarks that uses large dictionaries.

2) Decode aware parameter selection—This compares the decode aware bitmask based compression with optimized dictionary selection against bitmask based compression. FIG. 53 column pBMC illustrates the behavior of decode aware parameter selection over the Seong et al. method. Since decode aware compression technique explores more word lengths and dictionary size the various embodiments of the present invention are found to choose parameters which gives best compression ratio and at the same time produces decode friendly compressed bitstreams. It is found the various embodiments of the present invention improves the compression ratio by at least 7-9% over bitmask based compression (BMC).

3) Run length encoding—This compares the run length encoding improvement along with other techniques to illustrate the improvement of the various embodiments of the present invention. The column pBMC+RLE in FIG. 53 shows an improvement on all the benchmarks. This technique has the most improvement of all the embodiments on improving the compression ratio. Most of the repetitive pattern is smartly encoded without adding any overhead in compression or during decoding the compressed bits. On an average it a 5-7% improvement over bitmask based compression for Pan et al. benchmarks and 15% improvement on Koch et al. benchmarks was found.

Now the compression efficiency is compared with existing bitstream compression techniques: LZSS technique proposed by Koch et al. and distant vector based compression technique proposed by Pan et al. The distant vector compression technique uses format specific features to exploit redundancy thus benchmarks used in Koch et al. cannot be used. 1) LZSS—FIG. 54 shows the comparison of compression ratio obtained by applying LZSS and two variants of decoding aware bitmask compression; a) pBMC: decode aware bitmask compression with optimized dictionary selection, and b) pBMC+RLE: pBMC combined with run length encoding. From FIG. 54 it is clear that pBMC+RLE technique achieves best compression ratio over all the other compression techniques. The pBMC+RLE technique compresses on an average 12% better than LZSS technique for these benchmarks in Koch et al. The approach proposed in Seong et al. fails to compress any of the benchmark below 50%. This is partly because the parameters selected does not yield better compression ratio and also because these benchmarks have a substantial amount of words repeating consecutively. The bitmask based compression proposed by Seong et al. fails to capitalize this observation. The decode friendly compression embodiment chooses efficient parameters to compresses the bitstreams combining with smart run length encoding of such repetitive words.

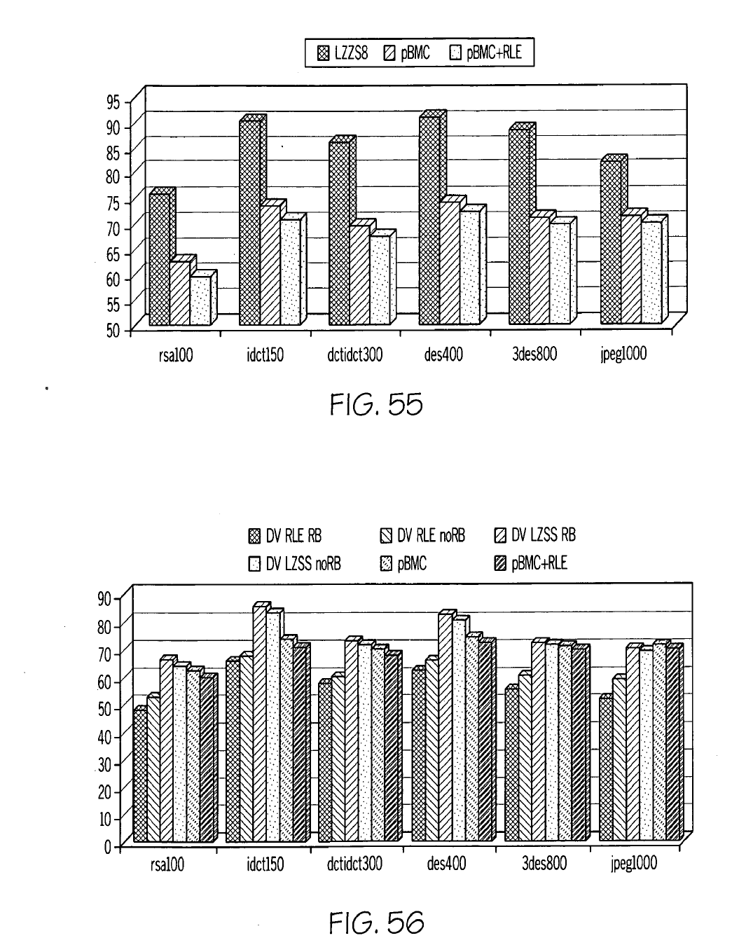

FIG. 55 shows the compression ratio for Pan et al. benchmarks. The various embodiments of the present invention compress these benchmarks with better compression ratio (20% better) than LZSS technique. The LZSS compression technique fails to compress these benchmarks substantially because these benchmarks are much larger and harder to compress than previous benchmarks. The LZSS technique uses smaller window size and smaller word length that inhibits exploiting matching patterns. This results in an overall unacceptable compression ratio. Another observation is that run length encoding improves the compression ratio by only around 3-4% unlike the huge improvement over Koch et al. benchmarks. This is because these benchmark do not have considerable repetitive patterns to have significant improvement in compression ratio.

2) Difference vector—FIG. 56 lists the compression ratio of the compression embodiments compared to that of difference vector applied to single IP cores. The difference vectors are encoded using Huffman based RLE with readback (DV RLE RB) and without readback (DV RLE noRB), and different vector encoded with LZSS with readback (DV LZS RB) and without readback (DV LZSS noRB). The compression technique proposed by Pan et al. uses format specific characteristics of Virtex FPGA family. The technique parses all the CLB frames and rearranges the frames such that the difference between the frames are minimal. To get the best compression ratio these difference vector are then encoded using variable length Huffman based run length encoding. From the implementation of the various embodiments of the present invention and the study conducted in Koch et al., such complex encoding needs humongous amount of hardware to handle variable length Huffman codes and operates at very low speed. The compression technique of the various embodiments of the present invention achieves around 5-10% closer to compression ratio achieved by best difference vector algorithm. By considering the decompression overhead imposed by Huffman based decoder. The compression ratio efficiency can be easily downsized by faster decompression time.

The decompression efficiency can be defined as the total number of cycles idle on the decoder output ports to the total number of cycles needed to decompress an uncompressed code. Lesser the number of idle cycles higher the performance because with less data being transferred a constant output is produced at a sustainable rate. The final efficiency is defined by the product of idle cycle time and the frequency at which the decoder can operate. The variable length bitmask based decoder, decode aware bitmask based decoder and LZSS (8 bit symbols and 16 bit symbols) based decoder were synthesized on Xilinx Virtex II family XC2v40 device FG356 package using ISE 9.2.04i.

1) Fixed length vs. variable length bitmask decoder—both fixed length bitmask based and LZSS decoder can operate at a much higher frequencies. Converting variable length encoded words to fixed length has multiple advantages; i) has better operational speed and, ii) scope of parallelizing the decoding process based on the current knowledge of at least 8 compressed words. Table X below lists all the operating speeds of the three decoders.

TABLE X
Table 3-1. Operating speed and look up table usage of decoders

| Type | Speed (MHZ) | LUT Usage |
|---|---|---|
| Variable length bitmask decoder | 130 | 445 |
| Decode aware bitmask decoder | 195 | 241 |
| LZSS-8 | 198 | 83 |
| LZSS-16 | 200 | 120 |

The various embodiments of the present invention achieve almost the same operational speed as that of LZSS based accelerator. Considering the results from the previous section since the data is better compressed in the various embodiments of the present invention, the decoder has less data to fetch and more data to output. Table XI, below, lists the number of cycles which are required to decode with and without compression.

TABLE XI
Table 3-1. Decompression cycles for fixed length decoder

| Benchmark | Decompression Cycles | Raw Cycles |
|---|---|---|
| des | 255628 | 511256 |
| RC5 | 331752 | 663504 |
| fft | 255628 | 511256 |
| simpleFIR | 255631 | 511262 |
| ReCoLink | 255632 | 511264 |
| crossbar | 255630 | 511260 |
| ReCoNode | 331752 | 663504 |

From the table one can see that it takes roughly half the number of cycles to that of uncompressed cycles. An important thing to note is that uncompressed reconfiguration process requires the configuration hardware to run at memory's slower operational speed. Further run length encoding of the compressed streams allow the decoder to accumulate the input bits for future decoding, while transmitting the data instantaneously for reconfiguration.

2) Look up table usage—now the overhead with which decode aware compression achieves better compression and better decompression efficiency is discussed. The number of look up table (LUT) on FPGA was used to measure the amount of resources utilized by each technique. Table X lists all the decoders and column 3 lists the number of LUTs used. The fixed length decoder embodiment takes lesser LUT than variable length bitmask decoder and LZSS based decoder takes much lesser LUT. The decompression engine embodiment can be further improved using optimized one bit adders proposed in S. Bi, W. Wang, and A. A. Khalili, “Multiplexer-based binary incrementer/decrementers,” in proc. IEEE-NEWCAS, pp. 219-222, 2005, which is hereby incorporated by reference in its entirety, by another 10% to 20%.

3) Decompression Time—lastly the actual decompression time required to decode a FFT benchmark for Spartan III is analyzed. A cycle accurate simulator which simulates the decompression is used to estimate the decompression time. The memory operating was simulated at different speeds (2, 3 and 4 times slower) than FPGA operating speed. FPGA is simulated to operate at 100 MHZ. For an uncompressed word FPGA should operate at memory speed thus increasing the reconfiguration time. In an optimal scenario the decompression time should be the product of compression ratio and uncompressed reconfiguration time. Table XII lists the required decompression time with different input buffer sizes.

TABLE XII

| | (Memory:FPGA) cycles | | | | | |
|---|---|---|---|---|---|---|
| | 1:2 | | 1:3 | | 1:4 | |
| FIFO Size | LZSS | BMC | LZSS | BMC | LZSS | BMC |
| 1 | 1.78 | 1.36 | 2.3 | 1.9 | 2.84 | 2.45 |
| 4 | 1.76 | 1.34 | 2.27 | 1.89 | 2.82 | 2.44 |
| 8 | 1.74 | 1.34 | 2.25 | 1.88 | 2.8 | 2.43 |
| 16 | 1.72 | 133 | 2.23 | 1.88 | 2.78 | 2.43 |
| 32 | 1.7 | 133 | 2.22 | 1.88 | 2.78 | 2.43 |
| 64 | 1.69 | 133 | 2.2 | 1.87 | 2.77 | 2.42 |
| Optimal | 1.15 | 1.11 | 1.72 | 1.67 | 2.30 | 2.22 |
| No Compression | 2.62 | 2.62 | 3.93 | 3.93 | 5.24 | 5.24 |

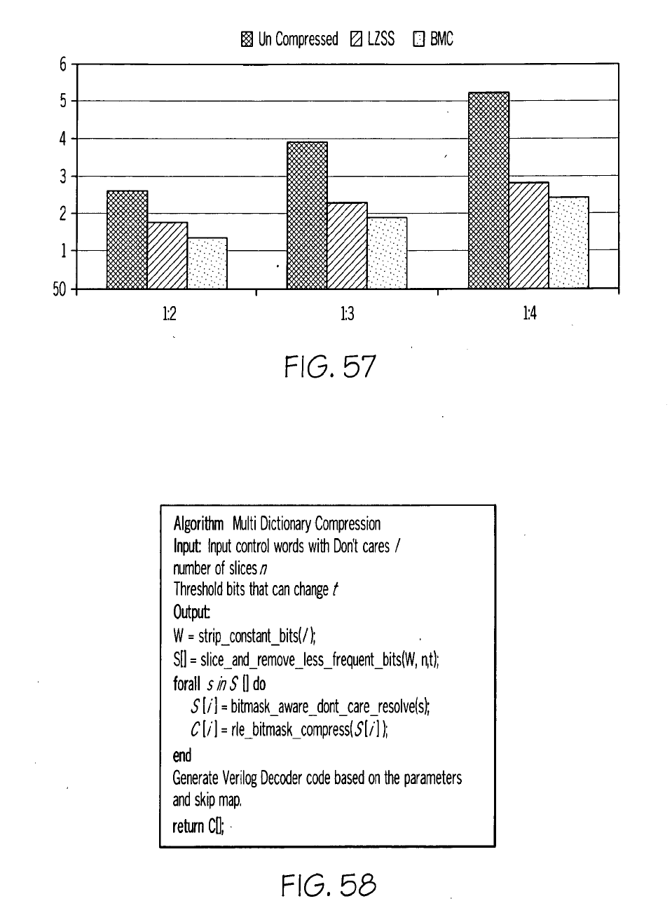

It was noticed that the buffer size does not affect the configuration time significantly. FIG. 57 illustrates the improvement in decompression time over LZSS (See Koch et al.) technique by at least 15-20%. The various embodiments of the present invention produce better compression ratio demonstrating better decompression efficiency closer to optimal decompression time.

The various embodiments of the present invention are also applicable to bitmask-based control word compression for NISC architectures. It is not always efficient to run an application on a generic processor, whereas implementing a custom hardware is not always feasible due to cost and time considerations. One of the promising directions is to design a custom data path for each application using its execution characteristics. The abstraction of instruction set in generic processors limits from choosing such custom data path. No Instruction Set Architecture (See NISC ([http://www.cecs.uci.edu/nisc]), which is hereby incorporated by reference in its entirety) alleviates this problem by removing abstraction of instruction and controls optimal data path selection. The use of control words achieves faster and efficient application execution. One major issue with NISC control words is that they tend to be at least 4 to 5 times larger than regular instruction size bloating the code size of the application. One approach is to compress these control words to reduce the size of the application. The various embodiments of the present invention provide an efficient bitmask based compression technique optimally combining with run length encoding to reduce the code size drastically while keeping the decompression overhead minimal. Some advantages of this bitmask-based control word compression embodiment is i) optimal don't care resolution for maximum bitmask coverage using limited dictionary entries; ii) run length encoding to reduce repetitive portions of control words; and iii) smart encoding of constant bits in control words.

This embodiment includes an efficient bitstream compression technique to improve compression ratio by splitting control words and compressing them using multiple dictionaries. Bitmask aware don't care resolution to decrease dictionary size and improve dictionary coverage. Smart encoding of constant and least frequently changing bits to further reduce the control word size and run length encoding of repetitive sequences to decrease decompression overhead by providing the uncompressed words instantaneously. Experimental results illustrate that this embodiment improves compression ratio by 20-30% than that of existing bitstream compression techniques and decompression hardware capable of running at 130 MHZ.

In one embodiment, a technique is used to split the input control words and compress them using bitmask algorithm proposed in (See Seok-Won Seong, Prabhat Mishra. An efficient code compression technique using application-aware bitmask and dictionary selection methods. DATE, 2007, which is hereby incorporated by reference in its entirety) combining with optimizations discussed further below. Discussed later below are the optimizations and novel encoding techniques to decrease compressed size by: bitmask aware don't care resolution, smart encoding of constant and less frequent bits in control words, and run length encoding of repeating patterns.

The input control words as discussed usually run close to 100 bits in length or even more. To achieve better redundancy and to reduce code size, control words are split in to two or more slices depending on the width of the control word. Each of these slices are then compressed using the algorithm described in (Seok-Won Seong, Prabhat Mishra. An efficient code compression technique using application-aware bitmask and dictionary selection methods. DATE, 2007, which is hereby incorporated by reference in its entirety). To achieve further code reduction one or more embodiments provide improvement without adding any significant overhead on the decoder. FIG. 58 is pseudo code that lists the steps in compressing the control words. Initially all constant bits are removed to get reduced control words along with initial skip map. In next step input is split into required slices. These slices are analyzed and least occurring bits are then removed updating the skip map, refer the pseudo code discussed with respect to FIG. 63. Each slice still contains don't care bits which is resolved using the algorithm pseudo code discussed with respect to FIG. 59. This results in merged control words which are bitmask friendly with minimal dictionary size. In final step merged control words are compression using the algorithm described in Seok-Won Seong, Prabhat Mishra. An efficient code compression technique using application-aware bitmask and dictionary selection methods. DATE, 2007, which is hereby incorporated by reference in its entirety, combined with a run length encoding scheme embodiment discussed later below.

In a generic NISC implementation not all functional units are involved in a given datapath, such functional units can be either enabled or disabled. This leaves the compiler to insert don't cares bits in such control words. Any compression algorithm to get maximal compression can utilize these don't care values efficiently. One such algorithm presented in B. Gorjiara, D. Gajski FPGA-friendly Code Compression for Horizontal Microcoded Custom IPs. FPGA, 2007, which is hereby incorporated by reference in its entirety, creates a conflict graph with nodes representing unique control words and edges between them represents that these words cannot be merged (or conflict). Applying minimal k colors to these nodes result in k merged words. It is a well known fact that graph coloring is a NP Hard problem. Hence a heuristic based algorithm proposed by Welsh and Powell is used to color the vertices and obtain optimal merged dictionary. This algorithm is well suited in reducing the dictionary size with exact matches. The dictionary chosen by this algorithm might not yield better bitmask coverage.

An intuitive approach is to consider the fact that these dictionary entries will be used for bitmask matching. FIG. 59 shows describes the steps involved in choosing such dictionary which allows certain bits that can be bitmasked while creating a conflict graph thus reducing the dictionary size drastically. The algorithm basically allows certain bits than can be bitmasked to avoid them to be represented as edges in conflict graph, thus allowing the graph to be colored with less number of colors. This results in smaller dictionary size with smaller dictionary index bits thus reducing the final compressed code. It must be noted that while merging the nodes if the bits are already set then bits originating from most frequent word should be retained. This promises reduces size as they will be result in more direct matches. Results indicate that the dictionary chosen using this algorithm produces 3-4% better compression ratio without any additional overhead on decompression.

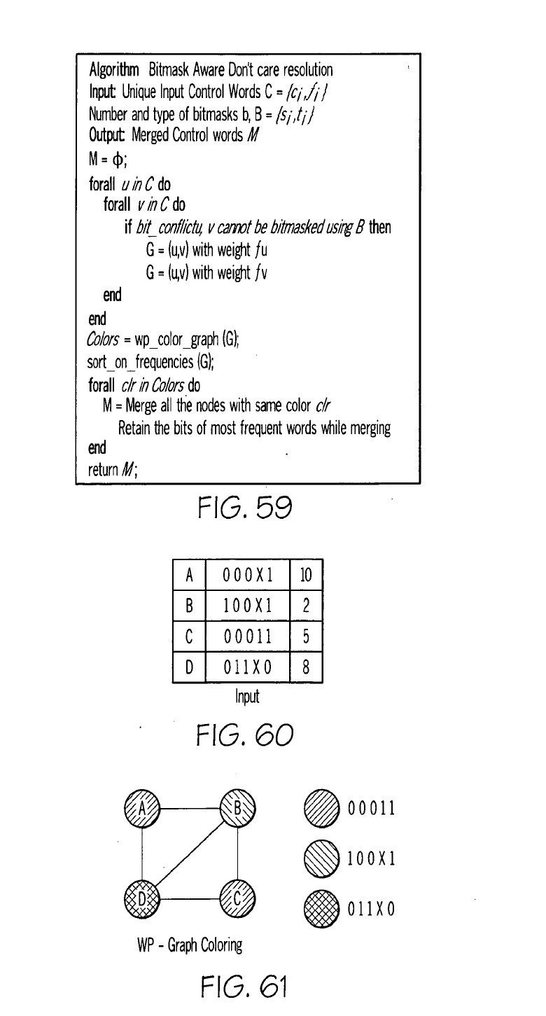

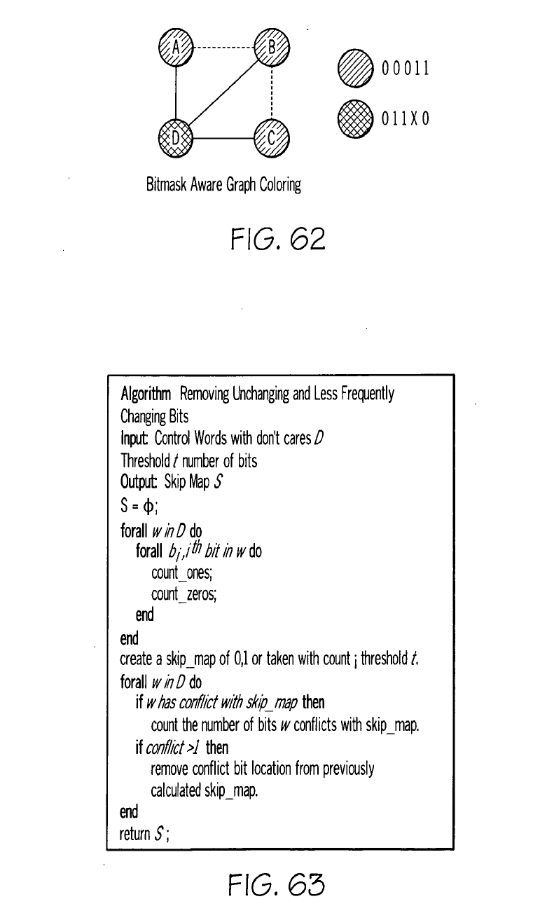

FIG. 60 shows a sample don't care resolution of NISC control words and merging iteration. The input words and their frequencies are provided to the algorithm is shown in FIG. 60 where there are four inputs A, B, C, and D. FIG. 61 represents the graph constructed by original don't care resolution algorithm, the algorithm chooses three color which represents the merged dictionary codes. The new bitmask aware graph creation algorithm skips the edges which can be bit-masked as illustrated in FIG. 62. The example uses one 1 bit bitmask to store the difference. The dotted edges represent the bitmasked edges. The colors indicate the merged dictionary entries, while merging the colored nodes high frequency bits are retained upon conflict.

Upon closer analysis of the control word sequence reveals that some bits are constant or changes less frequently throughout the code segment. Removal of such bits improves compression efficiency and does not affect matches provided by rest of the bits. The least frequent bits are encoded by using the unused bitmask as a magic marker. A threshold number determines the number of times that a bit can change in the given location throughout the code segment. It is found that 10-15 is a good threshold for the benchmarks experimented on. FIG. 63 shows the steps in eliminating non changing bits and less frequently occurring bits. Initially the algorithms calculates the number of ones in each bit position. In next step only those bit positions with count 0 or less than threshold t are considered to be the initial skip map. In case of a less frequent bit positions each of the bit positions can change in the same control word, this leads to multiple encoding for the single bit or bit change conflict. In the last step of the algorithm the skip map is updated by constructing the conflict map for each word and eliminating the bit position which causes the most conflicts thus leaving the new skip map covering only one bit positions in any given word. The following example clarifies the complex process of elimination of bit positions.

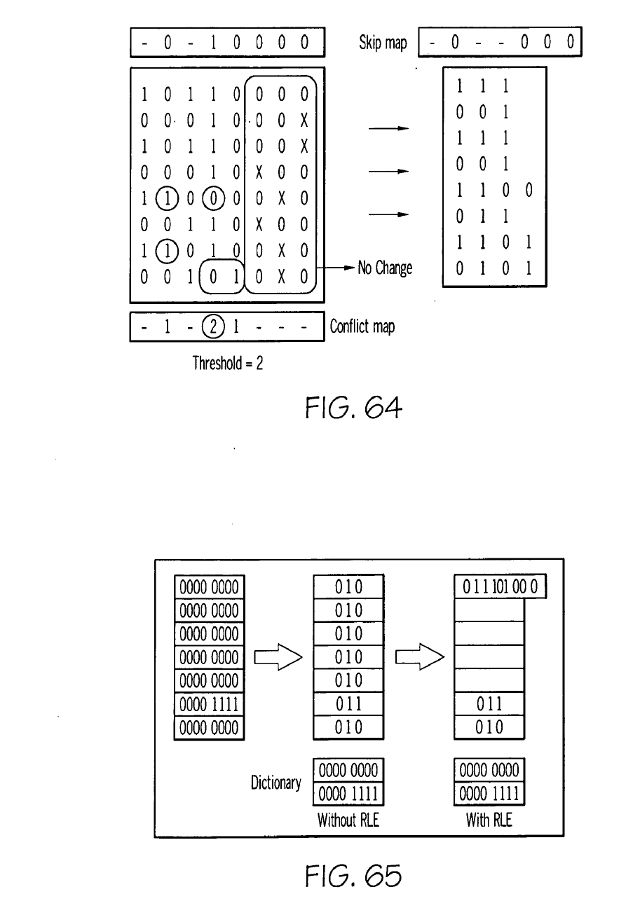

FIG. 64 illustrates a sample control word sequence under going bits reduction. Each control word is scanned for number of ones and zeros. The last three columns do not have words change in bits thus they can be unanimously removed from input, storing the same bit in the skip map. Columns with bit changes less than threshold i.e. column 2, 4, and 5 have bits toggled. In final step conflict map is created, listed at the bottom part of the figure representing the number of collision the same word under goes. The bit positions with collisions1 are taken rest columns (column 4) is excluded from skip map. The skip map and the bits which needs to be encoded are shown on the extreme right hand side of the figure. It can be noted that there is a significant reduction in the code size to compress. The decompression section discusses in detail how these less frequent bits are again reassembled.

With respect to run length encoding, careful analysis of the control words pattern revealed that the input control words contained repeating patterns. The afore mentioned algorithm encodes such patterns using same repeated compressed words. Instead, one embodiment Run Length Encodes (RLE) repetition of such words, such repetition encoding results in an improvement in compression performance by 5-10% on (See MiBench benchmark ([http://www.eecs.umich.edu/mibench/]), which is hereby incorporated by reference in its entirety) benchmark. To represent such encoding no extra bits are needed; another interesting observation leads to the conclusion that bitmask 0 is never used, because this value means that it was an exact match and would have encoded using dictionary entry. Using this as a special marker RLE can be encoded which will reduce the extra bit over head on all the words.

This type of run length encoding also alleviates the decompression overhead by providing the decompressed word instantaneously for the dispatcher to send the control word to control unit in the same cycle, fully utilizing the configuration hardware bandwidth and reducing the bottleneck on communication channel between memory and decoder. FIG. 65 illustrates the RLE bitmask in use. The RLE is used only if the savings made by repetition word encoding is greater then the actual encoding. For example, if there are r repetition and cost representing in normal encoding is x bits and number of bits required to store the RLE encoding is y bits then the RLE encoding is chosen only if x*r<y bits.

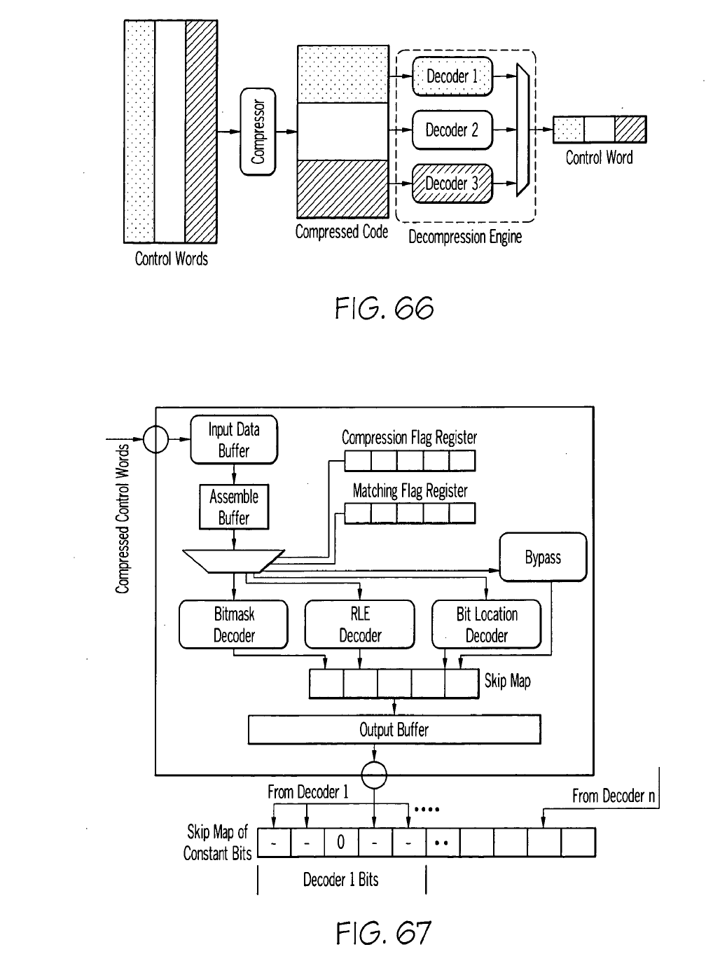

The complete flow of control words, compression and decompressed bits is shown in FIG. 66. The input file containing the control words is passed to the compressor, which applies the algorithm discussed above with respect to FIG. 63 and outputs the compressed file in the order of slices. Later each decoder fetch each compressed control word from memory and then decodes using the dictionary stored within it. After each decompressed code is ready it is assembled before sending it to the control unit.

The following discussion analyzes the modification required for the decompression engine proposed in Seok-Won Seong, Prabhat Mishra. An efficient code compression technique using application-aware bitmask and dictionary selection methods. DATE, 2007, which is hereby incorporated by reference in its entirety, compression technique, and discusses branch lookup table for handling branched instructions.

The decompression comprises of multiple decoding unit for each slice of control word. Each decompression engine contains input buffer where incoming data is buffered from memory. The data from input buffer is then assembled for further processing. Based on the type of compressed word control is passed to corresponding decoder unit. Each decoding engine has a skip map register which inserts extra bits which were removed during least frequently occurring bit optimization. A separate unit to toggle these bits handles insertion of these difference bit. The unit reads in the offset within the skip map register to toggle the bit and outputs to an output buffer. All outputs from decoding engine are then in turn directed to skip map which holds completely skipped bits (bits that never change). FIG. 67 illustrates the structure and components of the decompression engine.

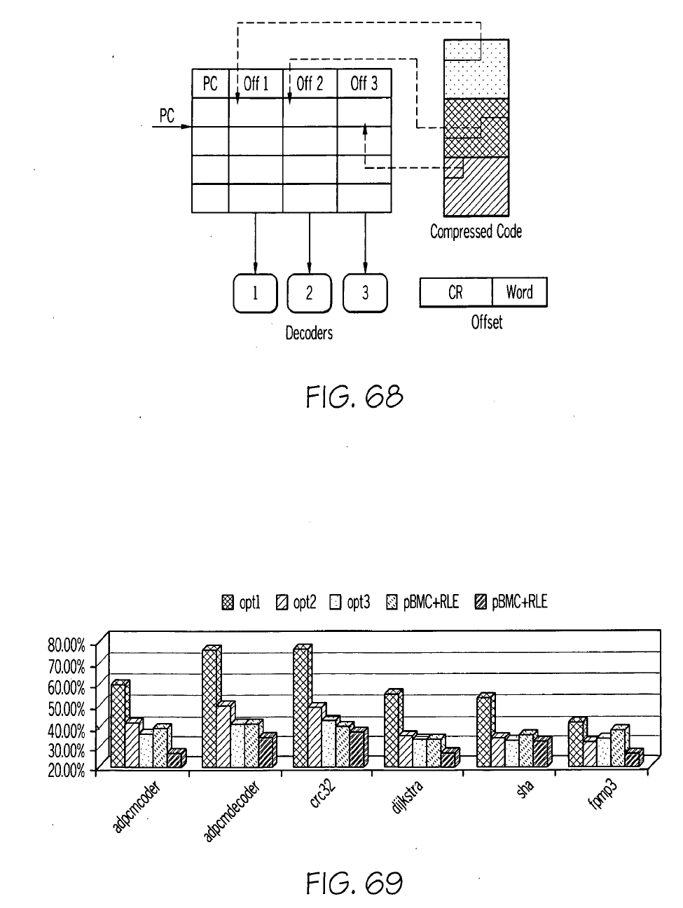

In any program branch control words produces program counter to jump to a different location to load a new control word. The decoder should handle such jumps within a program. A look up table was chosen based branch relocation approach in which static jumps locations are stored in a table (See Seok-Won Seong, Prabhat Mishra. An efficient code compression technique using application-aware bitmask and dictionary selection methods. DATE, 2007, which is hereby incorporated by reference in its entirety). Since the various embodiments of the present invention uses multiple dictionary and multiple decode units to handle decompression of multiple slices. The table also stores offset within all these slices along with new jump location. FIG. 68 illustrates the branch look up table design. The look up table is indexed based on new PC and returns multiple offsets to be used by individual decoders. Each offset stores the compress register (CR) offset within its compressed word. The decoder reads the new compress register from this offset. The offset also contains the word offset from which the decoding resumes.

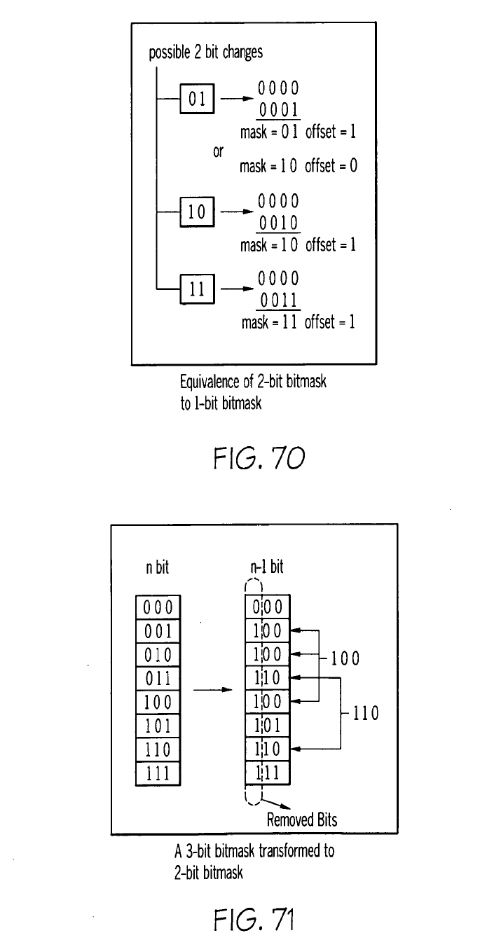

The effectiveness of the bitmask-based control word compress embodiment is applied on benchmarks provided by NISC authors (See B. Gorjiara, D. Gajski FPGA-friendly Code Compression for Horizontal Microcoded Custom IPs. FPGA, 2007, which is hereby incorporated by reference in its entirety). The metrics measured are compression ratio, decompression speed, resources used by decompression engine (LUT and BRAMs). It is found that the compression technique of the various embodiments of the present invention is found to reduce the code size further by 20-30% over the compression technique proposed by NISC authors (See Gorjiara et al.). Decompression speed of the decoding units capable operating at 130 MHZ little faster than NISC processor operating range. BRAM used is fixed for all the benchmarks usually 1 or 2 maximum. FIG. 69 shows the comparison of compression ratio of different benchmarks provided (See MiBench benchmark ([http://www.eecs.umich.edu/mibench/]), which is hereby incorporated by reference in its entirety). These benchmark include numerous code from security algorithms, network and telecom algorithm implementations. Each benchmark is compiled in release mode using NISC compiler (See M. Reshadi No-Instruction-Set-Computer (NISC) Technology Modeling and Compilation. PhD thesis, University of California, Irvine, 2007, which is hereby incorporated by reference in its entirety) with optimization level set to 0. The bitmask-based control word compress embodiment with 3 slice option is found to compress all the benchmark with at least 20-30% better compression relative to nearest 3slice full dictionary algorithm.

The various embodiments of the present invention are also applicable to optimal encoding of n-bit bitmasks. In a bitmask based compression each bitmask is represented as <s₁, tᵢ, lᵢ>, which denotes the size, type and offset within the word. A n-bit bitmask remembers n consecutive bit differences between a matched word and a dictionary entry. To store n bit differences a naive approach is to store all the n bits. But a careful and closer analysis reveals that, to encode the same n bits only n−1 bits are needed.

Starting with a simple example, to encode a single bit difference bits are not needed to indicate the difference. The presence of offset bits indicates that there is a one bit difference, since the XOR operation of two bits differing will be always 1 the bit value stored is always value 1. Hence this bit can be removed to be encoded. Now considering a 2-bit bitmask encoding, there are four possibilities {00, 01, 10, 11}. In these possibilities the first pattern does not occur as this indicates that there are no differences. The second and third bitmasks are both equivalent except that offset of these differs by one. Hence both can be represented using 10 bitmask. Thus there are only two bitmasks (10, 11) that needs to be encoded. Hence a single bit is sufficient to represent these 2-bit bitmasks. In general a n bit bitmask can theoretically cover differences. Out of which the first pattern is not used which leaves 2ⁿ⁻¹ patterns to be encoded. Out of these patterns there are 2ⁿ⁻¹−1 starting with 0 i.e. the first half of truth table. These bitmasks can be rotated such that it starts with 1 as shown in FIG. 70. The rotation of the bitmask leaves the offset to be shifted suitably. FIG. 71 illustrates all possible difference that can be encoded using a 2-bit bitmask. It can be noted that bitmask difference 01 is equivalent to bitmask difference 10. The difference is that the offset gets changed from 1 to 0 as mentioned earlier (the offset is relative from the least significant bit position). Thus, in conclusion, n−1 bits are needed store n differences.

The following is a proof for n−1 bit representation. Definition 1: let two words w₁ and w₂ have n bit consecutive differences then f(n) be the function which represents the number of bit changes that n bits can record. Let o(n) be the function which represents offset of the bit changes recorded from the least significant bit.

Note that f(n)=2ⁿ, out of these 2ⁿ bit changes there are 2ⁿ⁻¹ bit changes have most significant bit (MSB) set to 0 and 2ⁿ⁻¹ bit changes have MSB set to 1.

Lemma 1: Let G be the set that represents the bit changes with MSB set to 1, and H be the set that represents the bit changes with MSB set to 0. Then G is equivalent to H.

Proof: Let G={g₁, g₂, . . . , gₘ}, H={h₁, h₂, . . . , hₘ}, where g₁, g₂, . . . , gₘ are bit changes with MSB set to 1, h₁, h₂, . . . , hₘ are bit changes with MSB set to 0, m=2ⁿ⁻¹, and let i be a bit change element from set H. Then in m possible bit changes with MSB set to 0 for any i^{th} bit change element, let r(i) be the number of bit rotations required such that i^{th} bit change has 1 in its MSB set then the new offset for this bit change will be o′p(i)=o(i)−r(i). Since the number of rotation required is always less than n(r(i)<n) and the previous offset is at least n o(n)>/n the new offset o′(i) is always greater than 0. Thus all the elements in set H can be transformed to bit change element with MSB set to 1. Thus both sets H and G are equivalent, which proves the lemma.

Theorem 1: Let n be the number of consecutive bit changes to encode between two words w₁ and w₂. Then n−1 bits are sufficient to encode n bit changes.

Proof: A n bit change can encode possibly f(n)=2ⁿ bit changes. Out of these $2̂{n−1}$ bit changes have MSB set to $0$. These bit changes can be converted to a bit change with MSB set to 1 (see Lemma 1 above). Thus, there is only 2ⁿ⁻¹ or f(n−1) to encode which requires n−1 bits to encode these changes, which completes the proof.

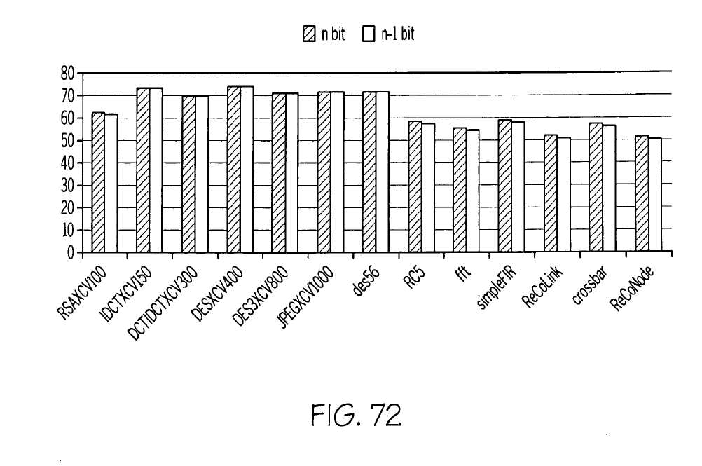

The application of this optimization improves the compression efficiency in cases when bitstreams contains data such that most of them are encoded using one or more bitmasks. FIG. 72 illustrates the comparison of the optimized representation of the bitmask applied on benchmarks used in reconfiguration compression (See Bitstream Compression Benchmark, Dept. of Computer Science 12. [Online]. Available: [(http://www.reconets.de/bitstreamcompression/], which is hereby incorporated by reference in its entirety). It is found that on an average there is an improvement of around 1-3% on overall compression efficiency. An advantage of this optimization is that the improvement is achieved without adding any extra logic or overhead on decompression.

### Non Limiting Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although the exemplary embodiments of the present invention are described in the context of a fully functional computer system, those skilled in the art will appreciate that embodiments are capable of being distributed as a program product via CD or DVD, e.g. CD, CD ROM, or other form of recordable media, or via any type of electronic transmission mechanism.

Further, even though a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method for storing data in an information processing system, the method comprising:
receiving uncompressed data;
dividing the uncompressed data into a series of vectors;
identifying a sequence of profitable bitmask patterns for the vectors that maximizes compression efficiency while minimizes decompression penalty;
creating matching patterns using a plurality of bit masks based on a set of maximum values of a frequency distribution of the vectors;
building a dictionary based upon the set of maximum values in the frequency distribution and a bit mask savings which is a number of bits reduced using each of the plurality of bit masks;
compressing each of the vectors using the dictionary and the matching patterns with having high bit mask savings;
storing the vectors which have been compressed into memory.

2. The method of claim 1, wherein the uncompressed data comprises of instructions including opcodes, operands and immediate values in an information processing system.

3. The method of claim 1, wherein the uncompressed data comprises of data (such as integer value, floating-point value etc.) in an information processing system.

4. The method of claim 1, wherein the series of vectors are n-bit long vectors having equal length, where n is a counting number.

5. The method of claim 1, wherein the uncompressed data represents seismic data.

6. The method of claim 1, wherein the uncompressed data represents electronic test patterns used by test equipment.

7. The method of claim 1, wherein building a dictionary further comprises:
creating a graph comprising a set of nodes corresponding to each vector in the series of vectors, wherein the graph comprises a set of edges, wherein an edge is created between two nodes if the nodes can be matched using at least one bit-mask pattern.

8. The method of claim 7, further comprising:
allocating bit savings to at least one of each node in the set of nodes and each edge in the set of edges; and
determining an overall savings for each node based on the bit savings allocated to the at least one of each node in the set of nodes and each edge in the set of edges.

9. The method of claim 8, further comprising:
selecting at least one node with a maximum savings associated therewith; and
adding the at least one node that has been selected to the dictionary.

10. The method of claim 9, further comprising:
deleting the at least one node that has been selected from the graph.

11. The method of claim 9, further comprising:
setting a node deletion threshold; and
deleting at least one node connected to the at least one node that has been selected if a frequency value associated with the at least one node is less than the given threshold.

12. The method of claim 1, wherein the frequency distribution is determined by:
identifying repeating 32-bit sequences; and
determining a total number of repetitions for the repeating 32-bit sequences that have been determined.

13. The method of claim 1, further comprising:
adjusting branch targets by patching branch targets into new offsets in the vectors that have been compressed.

14. The method of claim 13, further comprising:
padding extra bits at an end portion of code preceding the branch targets to align on a byte boundary.

15. The method of claim 13, further comprising:
storing a minimal mapping table comprising new address for addresses that have failed to be patched.

16. An information processing system for storing data, the information processing system comprising:
a memory;
a processor;
a code compression engine adapted to:
receive uncompressed data;
divide the uncompressed data into a series of vectors;
identify a sequence of profitable bitmask patterns for the vectors that maximizes compression efficiency while minimizes decompression penalty;
create matching patterns using a plurality of bit masks based on a set of maximum values of a frequency distribution of the vectors; and
a dictionary selection engine adapted to:
build a dictionary based upon the set of maximum values in the frequency distribution and a bit mask savings which is a number of bits reduced using each of the plurality of bit masks;
wherein the code compression engine is further adapted to:
compress each of the vectors using the dictionary and the matching patterns with having high bit mask savings;
store the vectors which have been compressed into memory.

17. The information processing system of claim 16, wherein the dictionary selection engine is further adapted to build a dictionary by:
creating a graph comprising a set of nodes corresponding to each vector in the series of vectors, wherein the graph comprises a set of edges, wherein an edge is created between two nodes if the nodes can be matched using at least one bit-mask pattern.

18. The information processing system of claim 17, wherein the dictionary selection engine is further adapted to build a dictionary by:
allocating bit savings to at least one of each node in the set of nodes and each edge in the set of edges; and
determining an overall savings for each node based on the bit savings allocated to the at least one of each node in the set of nodes and each edge in the set of edges.

19. The information processing system of claim 18, wherein the dictionary selection engine is further adapted to build a dictionary by:
selecting at least one node with a maximum savings associated therewith; and
adding the at least one node that has been selected to the dictionary.

20. A method for decompressing compressed data, the method comprising:
receiving a set of bitmask-based compressed data;
generating an instruction-length mask based on the compressed data;
retrieving at least one dictionary entry corresponding to the compressed data, wherein
generating the instruction-length mask is performed substantially parallel to retrieving the at least one dictionary entry; and
performing a logical XOR operating on the instruction-length mask and a dictionary entry corresponding to the compressed data.
